(19) United States
(12) Patent Application Publication
(10) Pub. No.: US 2014/0047413 A1
(43) Pub. Date: Feb. 13, 2014

(54) Developing, Modifying, and Using Applications

(71) Applicant: Modit, Inc., Cambridge, MA (US)

(72) Inventors: Alexander Richard Sheive, Cambridge, MA (US); Alexander James Sutherland, Nashua, NH (US); Shantanu Dhaka, Cambridge, MA (US); John Samuel Workman, Seattle, WA (US)

(73) Assignee: Modit, Inc., Cambridge, MA (US)

(21) Appl. No.: 13/949,670

(22) Filed: Jul. 24, 2013

Related U.S. Application Data
(60) Provisional application No. 61/681,352, filed on Aug. 9, 2012.

(51) Int. Cl. H04L 29/06; G06F 9/44

(52) U.S. Cl. CPC H04L 65/403; G06F 8/30
USPC 717/110; 715/753

(57) ABSTRACT

Among other things, a continuous framework is provided with which users can interact, on one or more platforms that support web standards, and which supports: (a) the hosting of applications, (b) the publication of hosted applications to a portal within the framework, and (c) the creation and direct editing of files, including text files, that embody those applications and conform to web standards.

### CROSS REFERENCE TO RELATED APPLICATIONS

This application claims priority from U.S. provisional application 61/681,352, filed on Aug. 9, 2012, which is incorporated by reference.

### BACKGROUND

This description relates to developing, modifying, and using applications, among other things.

### SUMMARY

In general, in an aspect, a continuous framework is provided with which users can interact, on one or more platforms that support web standards, and which supports: (a) the hosting of applications (b) the publication of hosted applications to a portal within the framework, and (c) the creation and direct editing of files, including text files, that embody those applications and conform to web standards.

Implementations may include one or any combination of two or more of the following features. The continuous framework supports (a), (b), and (c) without requiring the platforms on which the user can interact with the framework to be enhanced. The user can edit an application owned by another user. The user editing an application owned by another user includes the creation of a clone of the application. The user can embed one or more applications hosted by the framework within the framework. The embedded application includes application editor functions. The framework includes default component applications hosted by the framework and users can substitute other applications hosted by the framework for the default framework component applications. The hosted application files include files that are run on a server inside an application container. An indication is provided to a user who is observing the behavior of a running application of which portions of code of the application are causing the observed behavior. A sharing of revenue derived from one of the applications is controlled as among two or more users who participated in editing files that embody the application. When a user edits parent content owned by another user to produce child content, revenue derived from the child content is shared with the owner of the parent content. The continuous framework provides Web services including access to a key-value-based data store for each hosted application. The continuous framework provides Web services including a state-chat server for each hosted application. A revision control system is provided for each of the application files. The hosted application files include image files. The directly editable application files include image files that conform to web standards. The one or more applications hosted by the framework can be embedded in another application that conforms to web standards. The one or more applications hosted by the framework can be embedded in another application hosted by the framework. The framework supports importing of an existing application into the framework. The existing application is imported from a URL where the application is hosted on the web. The existing application is imported from a source code repository URL. The existing application is imported from files on a user's hard drive. The framework supports direct editing of source code elements that are less than a whole file. The elements include JavaScript functions. The elements include JavaScript modules. The elements include constants. The user can embed one or more applications hosted by the framework within the framework. The embedded application includes application editor functions. The framework includes default component applications hosted by the framework and users can substitute other applications hosted by the framework for the default framework component applications. An indication is given to users who are observing behavior of a running application which portions of code of the application are causing the observed behavior. The revision control system is provided for each of the application files. The hosted application files include image files. The directly editable application files include image files that conform to web standards. A sharing of revenue derived from one of the applications is controlled as among two or more users who participated in editing files that embody the application. When a user edits parent content owned by another user to produce child content, revenue derived from the child content is shared with the owner of the parent content. The user can edit an application owned by another user. The user can embed one or more applications hosted by the framework within the framework. The user editing an application owned by another user includes the creation of a clone of the application. The text files include JavaScript.

In general, in an aspect, a continuous framework is provided with which users can interact, on one or more platforms that conform to web standards, and which supports (a) the hosting of applications and (b) the creation and direct editing of files, including server-side files that embody the applications and are run inside an application container.

Implementations may include one or any combination of two or more of the following features. The files include client-side text files that conform to web standards. The user can edit an application owned by another user. The user editing an application owned by another user includes the creation of a clone of the application. The user can edit an application owned by another user. The user editing an application owned by another user includes the creation of a clone of the application.

In general, in an aspect, there is a continuous framework in which, when users create parent content and other users duplicate and edit that content to create derivative child content, revenue derived from the child content is shared with the creator of the parent content.

Implementations may include one or any combination of two or more of the following features. The revenue is derived from advertising. The revenue is derived from charges to parent content creators for being able to limit the duplication and editing of their content. The sharing is based on measures of the value of the parent content and child content to the framework. The measures include content views. The measures include content use fees.

In general, an aspect, an online market is hosted for applications or application assets that conform to web standards, are usable within a continuous framework with which users can interact, on one or more platforms that support web standards, and permit the applications or application assets to be edited by parties other than owners of the applications or application assets.

In general, in an aspect, as a running application exhibits behavior that a user can observe, simultaneously, in real time, portions of code of the application that are causing the observed behavior are displayed to the user to the user. In some implementations, the application conforms to web standards.

In general, in an aspect, editing of source code is enabled including enabling editing of some elements of syntax of the source code, and enabling observation but not editing of some elements of the syntax of the source code, in which all of the elements of source code syntax conform to a specification for a language. In some implementations, the language includes JavaScript.

In general, in an aspect, editing of source code is enabled including the insertion of functions whose programmatic scope is based on an existing function that is chosen by the user. Implementations may include one or any combination of two or more of the following features. The inserted function has the same signature as the chosen function. The insertion involves no more than one user action. The source code includes JavaScript. The source code includes JavaScript. The source code includes JavaScript.

In general, in an aspect, a continuous framework is provided with which users can interact, on one or more platforms that support web standards, and which supports, without requiring the platforms to be enhanced: (a) the hosting of applications (b) the creation and direct editing of files, including text files, that embody those applications and conform to web standards, and (c) a user editing an application owned by another user where the editing causes creation of a clone of the application.

Implementations may include one or any combination of two or more of the following features. The user can embed one or more applications hosted by the framework within the framework. The framework includes default component applications hosted by the framework and users can substitute other applications hosted by the framework for the default framework component applications.

Aspects of what we describe here include one or more of the following, alone and in combinations of any two or more of them.

1. Providing a continuous framework with which users can interact, on one or more platforms that conform to a cross-platform standard, and which support features involved in hosting of the applications and editing of files that embody the applications and conform to the cross platform standards. Among the advantages and technical effects of this aspect may be one or more of the following: users are able to develop cross-platform applications easily and quickly, to host them easily and quickly, and to enable others to use them and modify them. Users are not constrained by the limitations of a single platform or a single standard associated with such a platform. Users are not required to purchase or install specialized software to separately edit files of various types or to know how to procure hosting space or maintain a hosting server.
2. Providing a continuous framework with which users can interact, on one or more platforms that conform to a cross-platform standard, and which support features involved in hosting of the applications and editing of files that embody the applications and conform to the cross platform standards, possibly requiring the platforms to be enhanced. Among the advantages and technical effects of this aspect may be one or more of the following: in some cases the features that are supported can be supplemented by features that are supported by enhanced platforms; this makes the continuous framework more universally useful.
3. Providing a continuous framework with which users can interact, on one or more platforms that conform to a cross-platform standard, and which supports, possibly requiring the platforms to be enhanced, (a) the hosting of applications and (b) the direct editing of files, including text files and image files, that embody those applications and conform to the cross-platform standard. Among the advantages and technical effects of this aspect may be one or more of the following: users can host applications that they have created from within the continuous framework and therefore need not look to other sources for the services needed to do the hosting. Text files and image files can be directly edited with in the continuous framework rather than requiring that the user make use of text and image editing applications that do not belong to the continuous framework. This makes the process of developing applications seamless, easy, and fast, among other things.
4. Providing a continuous framework with which users can interact, on one or more platforms that conform to a cross-platform standard, and which supports, without requiring the platforms to be enhanced: (a) the hosting of applications, (b) the publication of hosted applications to a portal within the framework, and (c) the direct editing of files, including text files, that embody those applications. Among the advantages and technical effects of this aspect may be one or more of the following: The user is able to publish applications to other users, for example, through a portal within the continuous framework. This reduces the need to use publication resources outside of the continuous framework and therefore makes the process easier, more seamless, and quicker. The portal enables discovery of applications by other users which is a benefit to the users discovering the applications and those publishing them to the portal.
5. A server to support a continuous framework with which users can interact, on one or more platforms that conform to a cross-platform standard, and which supports, possibly requiring the platforms to be enhanced, (a) the hosting of applications and (b) the direct editing of files, including text files and image files, that embody those applications and conform to the cross-platform standard. Among the advantages and technical effects of this aspect may be one or more of the following: by supporting a continuous framework on such a server, a wide variety of users working on a broad range of platforms can develop and use applications easily, quickly, and seamlessly. The host of the server can manage and maintain components on the server easily and in that way provide high-quality, current, useful features as part of the continuous framework.
6. A continuous framework in which, when users create parent content and other users duplicate and edit that content to create derivative child content, revenue derived from the child content is shared with the creator of the parent content. Among the advantages and technical effects of this aspect may be one or more of the following: users can share the benefits, costs, and value of applications that they work on easily, quickly, and effectively. Developers and potential developers of applications are incentivized to participate in the continuous framework, which benefits all users of the continuous framework. Developers are incentivized to add content to the framework that may not have value alone, but provide a useful starting point for creating derivative content which enables other users to leverage that work to make more valuable derivative content than they could make alone.
7. Hosting an online market for applications or application assets that conform to a cross-platform standard, are usable within a continuous framework with which users can interact, on one or more platforms that conform to the cross-platform standard, and are permitted to be edited by parties other than the owners of the applications or application assets. Among the advantages and technical effects of this aspect may be one or more of the following: people who want to sell applications or application assets that they have developed and people who want to acquire applications and application assets for other uses will have an easy, simple, and fast way to, post, explore, and acquire applications. A revenue stream can be generated from these activities. Because the applications or application assets will be usable within a continuous framework, selling and buying them is particularly useful for developers, for example.
8. As a running application exhibits behavior that a user can observe, simultaneously, in real time, displaying to the user portions of code of the application that are causing the observed behavior. Among the advantages and technical effects of this aspect may be one or more of the following: the user can learn about how the code works, about syntax aspects of the code, and about how the behavior of an application relates to the code. A user can modify code quickly, easily, and effectively by observing which code elements relate to real-time behavior of the application.
9. Editing of source code including enabling editing of some elements of source code syntax and enabling observation but not editing of some elements of source code syntax in which all of the elements of source code syntax conform to a specification for a language. Among the advantages of this aspect may be one or more of the following: by allowing a user to edit some source code syntax but not to edit other source code syntax, the user is protected from making unintended or unfortunate changes in code. The user can learn which aspects of the code syntax are appropriate to change in which are not. The user can more simply, easily, and quickly make changes to code without causing problems. A novice user can learn to make code changes safely and quickly.
10. Enabling editing of source code including the insertion of functions whose programmatic scope is based on an existing function which is chosen by the user. Among the advantages of this aspect may be one or more of the following: a user, including a novice user, can focus on the code at the level of individual functions but still be able to add new functions without knowing the overall structure of the code. The user only needs to know that the new function should operate in the same way and scope as some existing function.

At least the following implementations and features are considered novel and not obvious and each of them may have at least the advantages and technical effects mentioned in conjunction with their recitation.

11. Hosting of applications and direct editing of files, including text files and image files, are supported without requiring the platforms to be enhanced: by not requiring the platforms to be enhanced in order to host applications and directly edit text files and image files, the user can produce applications easily within a single continuous framework.
12. Hosted applications can be published to a portal within the framework: by enabling developers and creators of applications to publish them to a portal within the framework, the effort of publication is reduced, made faster, and is more seamless with the development process. Users who wish to take advantage of applications published by other users can also do so quickly, easily and seamlessly from within the continuous framework.
13. The feature of item 12 can be combined with the feature that does not require the platforms to be enhanced in order to host applications and directly edit text and image files: in this way, the user can perform a full range of development activities from creation, to editing, to hosting, to publish, all within the continuous framework and without requiring an enhancement of the platforms.
14. The feature of item 4 can be combined with the feature that the directly editable application files comprise image files that conform to the cross-platform standard: the user can perform a full range of development activities that involve applications with image files from creation, to editing, to hosting, to publish, all within the continuous framework and without requiring an enhancement of the platforms.
15. Each of the features set forth in items 1 through 14 can be combined with the feature that the cross-platform standard comprises a web standard: users can then perform a wide range of activities with respect to the development and distribution of applications by working through, for example, web browsers on a variety of platforms.
16. Each of the combinations of features set forth in item 15 can be combined with the feature in which at least some text files that embody the applications do not conform to the web standard but can be compiled into text files that conform to the web standard: users can then more easily, if they wish, using languages that are not, for example, executable code, but are able to be compiled and executable code. This makes development easier, simpler, and sometimes more effective.
17. Each of the combinations of features set forth in item 16 can be combined with the feature in which users can edit applications owned by another user and the editing causes creation of a clone of the original application: when users edit applications owned by other users, clones of the applications can be automatically created, which adds to the wealth of applications being handled within the framework, while providing a clear distinction between applications and their state prior to cloning and their state after climbing. Maintaining the distinction enables attribution, revenue-sharing, privacy, and a variety of other benefits. Creating applications based on existing applications allows users to leverage the work of others to make something larger, or to customize an application for a more specific use or target audience.
18. Each of the features of items 1 through 9 above combined with a feature in which at least some text files that embody the applications do not conform to the cross-platform standard and the method comprises compiling those text files into text files that conform to the cross-platform standard: by compiling text files in the text files that conform to the cross-platform standard, users can incorporate into a single continuous framework application files, including code, images, and text, and then use them, modify them, develop them, and publish them to others easily, quickly, and seamlessly.
19. Each of the features and combinations of features of items 1 through 18 combined with a feature in which the user can publish the applications to the portal by no more than a single user action: publication of applications to a portal by no more than a single-user action enables the user to publish quickly, easily, and seamlessly from within the continuous framework. The user is not required to seek other external approaches to publication.
20. Each of the features and combinations of features of item 19 combined with a feature in which the single user action comprises one click: one click triggering of actions by an application is the epitome of simplicity and speed.
21. Each of the features and combinations of features of items 1 through 18 combined with a feature in which the applications comprises a game: developing, publishing, modifying, and using develop games benefits from the quick, easy, and seamless and two and possibilities offered by the continuous framework.
22. Each of the features and combinations of features of items 1 through 9 combined with a feature in which the hosted application files comprise image files.
23. Each of the features and combinations of features of items 1 through 18 combined with a feature in which the continuous framework supports the creation of new application files.
24. Each of the features and combinations of features of items 1 through 18 combined with a feature in which the continuous framework supports the deletion of application files.
25. Each of the features and combinations of features of items 1 through 18 combined with a feature in which the continuous framework supports users uploading application files from local file systems: users can incorporate into the process of developing and distributing applications the step of uploading application files from local file system and thereby expand the capabilities of the continuous framework, the speed of its use, and its efficiency.
26. Each of the features and combinations of features of items 1 through 18 combined with a feature in which the continuous framework supports importing applications files from a URL: users can incorporate into the process of developing and distributing applications the step of importing application assets from locations on the web and thereby expand the capabilities of the continuous framework, the speed of its use, and its efficiency.
27. Each of the features and combinations of features of items 1 through 18 combined with a feature in which the continuous framework supports the capture of audio: users can record their own audio files for use in applications seamlessly without finding and using some other piece of software.
28. Each of the features of items 1 through 18 in which the continuous framework supports the capture of video.
29. Each of the features of items 1 through 18 in which the continuous framework supports the capture of images.
30. Each of the features of items 1 through 18 in which the hosted application files comprise objects that do not conform to the cross-platform standard: users can make use of the continuous framework with objects that do not conform to the cross-platform standard and in that way make allow their applications to incorporate more general content not limited by the cross-platform standard.
31. Each of the features of items 1 through 18 in which the applications comprise server side applications: users can create applications that rely on a server-side component to provide centralized services and data for many client instances.
32. The feature of items 31 combined with a feature in which the server comprises an application container: users can write server side code that is executed and hosted without maintaining or configuring a server.
33. The feature of each of items 1 through 9 in which the application source code comprises JavaScript: users can make use of one of the most well-known, widely used, and effective coding languages in developing their applications. Users can have their client side code and server side code comprise the same language which facilitates communication between the client and server side.
34. Each combination of features in items 17 through 33 combined with a feature in which applications can be edited and an interactive control enables a user of the application to change to an editing mode: using a feature that is available through the continuous framework, users can also control the editing mode in which they are editing the applications. This permits efficient, quick, and seamless approaches to editing.
35. Each combination of features in item 34 combined with a feature in which, when a user invokes the interactive control, a clone of the application is made: users can edit applications in a way that creates a new instance of that application rather than replacing some other user's existing application.
36. Each combination of features and items 1 through 33 combined with a feature in which the framework enables a user to publish or host an edited version of the application from within the framework: users can publish the new applications that are created by editing existing applications so that they are accessible to other users.
37. Each combination of features and items 17 through 33 combined with a feature in which the framework maintains a tree structure to record a hierarchical relationship between an application and edited versions of the application: the tree structure will provide a mapping of applications to their derivatives which is useful for categorizing applications, displaying the related applications to users of some application, and analyzing and rewarding various behavioral patterns related to editing applications.
38. The feature of item 39 in which the framework displays the tree structure to users: users can see how applications relate to other applications and seek out related applications by traversing the tree.
39. Each combination of features and items 17 through 33 combined with a feature in which any modified application can be modified by users of the framework including users who did not create the modified application: applications modified by one user can be modified again, creating a chain of customization and derivative functionality.
40. Each combination of features and items 17 through 33 combined with a feature in which the modified application comprises part of the framework: modular aspects of the framework can themselves be modifiable applications to showcase the power of using modified applications to users of the framework.
41. Each combination of features and items 1 through 33 combined with a feature comprising indicating to users who are observing behavior of running applications which portions of code of an application are causing the observed behavior: users modifying applications can, without understanding the full structure of the code behind the application, observe behavior they seek to modify and be pointed to the code that needs to be changed to modify that behavior.
42. The feature of item 41 combined with the feature in which the indicating involves displaying both the behavior of a running application and in real time the code that controls that behavior: users observing portions of code that define certain aspects of application behavior can see the full code in real time providing insight as to the structure of the code overall.
43. The feature of item 41 comprising displaying visual indicators of the amount of time that has passed since the code that controlled a behavior was executed: users observing application behavior and the code that defines that behavior can visually link the timing of observed behavior to the indications of the code that controls that behavior.
44. Each combination of features and items 1 through 33 combined with a feature separate editing of individual functions in source code text files: users can focus on code at the function level and change application behavior by changing a single function which may not require knowledge of the rest of the code.
45. Each combination of features and items 1 through 33 combined with a feature in which editing the applications includes using non-text-based user interface elements to modify code indirectly without having to understand proper code syntax: users that do not understand code syntax can still alter application code using familiar visual interfaces while also seeing the changes to the code that these interfaces cause, which will teach the users code syntax through immersion.
46. Each combination of features and items 1 through 33 combined with a feature editing the applications includes being able to edit some elements of source code syntax and being able to observe but not to edit some elements of source code syntax: Users, including novice users, are protected from making unintended or unfortunate changes in code while still seeing the proper syntax of the code as a learning tool.
47. Each combination of features and items 1 through 33 combined with a feature in which source code of the applications is expressed in a programming language that comprises JavaScript: users can write application code in a language that is widely-supported and executable in web browsers.
48. Each combination of features and items 1 through 33 combined with a feature in which source code of the applications is expressed in a language that compiles to JavaScript: users can write applications in a language that is styled more to their liking but still compiles to JavaScript which is widely supported on many platforms.
49. Each combination of features and items 1 through 33 combined with a feature in which direct editing comprises altering the files in any way that is supported by a standard that defines how the application runs a given platform: users can edit files in any way that it is possible for those files to be interpreted as part of running on the platform.
50. Each combination of features and items 1 through 33 combined with a feature in which direct editing comprises making changes to characters that comprise statements in the source code of the application: users are not constrained by intermediary formats or visual tools and can edit source code in the format in which it is executed to take full advantage of the source code specification.
51. Each combination of features and items 1 through 33 combined with a feature in which direct editing comprises making changes to pixels of an image file: users can change the visual aspect of an image at the most fundamental level that can be displayed.
52. Each combination of features and items 1 through 33 combined with a feature in which direct editing comprises making changes to a timeline of a video file: users can alter video files in a fundamental way by adding portions of video, removing portions of video, or rearranging portions of video.
53. Each combination of features and items 1 through 33 combined with a feature in which direct editing comprises making changes to a timeline of an audio file: users can alter audio files in a fundamental way by adding portions of audio, removing portions of audio, or rearranging portions of video.
54. Each of the features of items 1 through 33 combined with a feature in which the web standard comprises HTML5.
55. Each of the features of items 1 through 33 combined with a feature in which the platforms comprise hardware devices, operating systems, or both.
56. Each of the features of items 1 through 33 combined with a feature in which the platforms comprise mobile devices.
57. Each of the features of items 1 through 33 combined with a feature in which the platforms comprise Web browsers.
58. Each of the features of items 1 through 33 combined with a feature in which the applications comprise Web applications.
59. Each of the features of items 1 through 33 combined with a feature in which the provided continuous framework supports users creating applications that conform to the cross-platform standard: users can create applications that have as much cross-platform support as the framework so that on any platform where those applications can be used, they can also be edited by the framework.
60. Each of the features of items 1 through 33 combined with a feature in which the provided continuous framework supports users distributing applications that conform to the cross-platform standard: users can promote and share the applications that are hosted on the framework.
61. Each of the features of items 1 through 33 combined with a feature in which the provided continuous framework supports users hosting on a server side, applications that conform to the cross-platform standard: users can provide server-side applications that are centralized and can communicate with many clients but that conform to the same standard and can thus share code and assets with client side applications.
62. Each of the features of items 1 through 33 combined with a feature in which the provided continuous framework supports users directly editing the files and hosting the applications without requiring a development environment or an editor to be installed on the platforms on which they are editing the files or requiring the user to procure or manage a hosting server: users can seamlessly and easily create, edit, host and publish applications using just the framework with no external tools or services required.
63. Each of the features of items 1 through 33 combined with a feature in which the framework conforms to the same cross-platform standard as the applications: the framework can be used on any platform that the applications created within the framework can be used, allowing those applications to be edited wherever then can be used.
64. Each combination of features and items 1 through 33 combined with a feature in which one or more applications hosted by the framework can be embedded in another application that conforms to the web standard: applications created on the framework can be displayed inside other applications, extending the scope of where they can be published and allowing them to be used as modular pieces of larger applications.
65. The feature of item 64 combined with a feature in which the embedded applications comprise application editor functions: tools within the framework for editing applications are applications themselves and can be embedded by other applications to allow aspects of themselves to be edited by users.
66. The feature of item 64 combined with a feature in which the applications are embedded using IFrame elements.
67. Each combination of features and items 1 through 33 combined with a feature combined with a feature in which one or more applications that conform to the web standard can be embedded in the framework: the framework itself can be enhanced by applications that are created using the framework.
68. The feature of item 67 combined with a feature in which the embedded applications comprise application editor functions: the application editing tools that exist within the framework can themselves be modified enabling users of the framework to extend and customize the ability of the framework to edit applications which creates a feedback loop that increasingly improves and broadens the functionality of the framework for all users and specific niches of users.
69. The feature of item 67 combined with a feature in which the applications are embedded using IFrame elements.
70. The feature of item 68 combined with a feature in which the applications are embedded using IFrame elements.
71. The feature of item 64 combined with a feature in which the embedded applications can communicate with one another: embedded applications can be used as modular components that interact with other modular components to leverage the specialized functionality of each.
72. Each combination of features and items 1 through 33 combined with a feature in which features of the framework that enable the direct editing of files comprise applications that conform to the cross-platform standard and can be edited within the framework: the application file editing tools that exist within the framework can themselves be modified enabling users of the framework to extend and customize the ability of the framework to edit application files which creates a feedback loop that increasingly improves and broadens the functionality of the framework for all users and specific niches of users.
73. Each combination of features and items 17 through 33 combined with a feature in which a user who has edited files or who causes the hosting of an application is enabled to engage in configuring of tools that are used by another user to edit the application: an application can have associated tools that can be specially selected to facilitate the modification of certain aspects of that application which then shapes how derivative applications will be modified.
74. The feature of item 73 combined with a feature in which the configuring includes setting an initial state of the application: application modifiers can be presented with the application in a specific state that presents behavior that might be particularly interesting or advantageous to modify.
75. The feature of item 73 combined with a feature in which the configuring of the tools comprises selecting which tools will be available to the other user.
76. The feature of item 73 combined with a feature in which the configuring of the tools comprises arranging a manner in which the tools are presented to the other user: a specific layout of tools can provide users who modify an application with a workspace that is optimized to facilitate the modification of that specific application.
77. Each of the features of items 1 through 33 comprising controlling a sharing of revenue derived from one of the applications among two or more of the users who participated in editing files that embody the application: the users involved in editing an application can be rewarded for their collaborative efforts.
78. Each of the features of items 1 through 33 combined with a feature in which the framework maintains and gives access through any of the platforms to the applications to the same extent when the applications are in an unpublished development state as when they are in a published state for use by any of the users, and the published or unpublished states correspond to permissions of users to use or constraints on users not to use the applications: users can work on applications without presenting them to the public, or only presenting them to certain other users, but then present them to the public or different sets of users at a certain time.
79. Each of the features of items 1 through 33 combined with a feature in which the users can interact through a development interface Web page that enables the users to edit all functional components of an application: in a single application editing web page users can change all functional components of an application and thus create any possible application.
80. Each of the features of items 17 through 33 combined with a feature in which, when users edit parent content owned by another user, revenue derived from cloned child content is shared with the owner of the parent content: Developers are incentivized to add applications to the framework that may not have value alone, but provide a very useful starting point for creating derivative applications which enable other users to leverage that work to make more valuable and powerful derivative applications than they could make alone.
81. The feature of item 80 combined with a feature in which the revenue is derived from advertising: advertising revenue is typically based on numbers of impressions which allows creators of parent applications to reap value from any uses of derivative applications.
82. The feature of item 80 combined with a feature in which the revenue is derived from charges to parent content creators for being able to limit the duplication and editing of their content: a user can create derivative child content and pay to limit the modification of that content where the revenue from that payment will be shared with the creator of the parent content, incentivizing the creation of content that is valuable when its modification is limited after some initial modification.
83. Each combination of features and items 1 through 33 combined with a feature in which one or more applications hosted on the framework can be embedded in other applications not hosted on the framework that conform to the web standards: applications created in the framework can be presented outside the framework to present the content or provide useful functionality which then promotes the framework and the applications.
84. The feature of item 83 combined with a feature in which the applications hosted on the framework are embedded in other applications using IFrame elements.
85. The feature of item 83 combined with a feature in which the embedded applications can communicate with each other: applications embedded in applications outside of the framework can be modular pieces of a larger functional system made up of embedded applications, thus increasing their power.
86. The feature of item 83 combined with a feature in which the embedded applications can communicate with the application in which they are embedded: applications embedded in applications outside the framework can be modular pieces of the application in which they are embedded, allowing the embedding application to leverage their functionality. In addition this promotes the embedded application to the users of the embedding application.
87. Each of the features of items 1 through 33 combined with a feature in which the framework comprises a web application.
88. Each of the features of items 1 through 33 comprising limiting access to an application that is unpublished: applications that are not yet published can be kept private until those users that need access to the application decide that it is ready for public viewing.
89. Each of the features of items 1 through 33 comprising allowing unconstrained access to an application that is published: published applications can be viewed publicly to maximize their reach and market.
90. Each of the features of items 1 through 33 comprising limiting access to an application that is published to a set of users of the framework: users publishing applications can limit access to their application to a specific set of individuals that they define.
91. The feature of item 90 combined with a feature in which the set of users comprises a club: applications can be published to specific groups that are self-organizing and maintain a specific set of members and rules regarding how applications can be modified and published.
92. Each of the features of items 1 through 33 comprising reconfiguring an interface environment of a user from one in which a user is using an application to one in which the user is modifying the application, by changing user interface elements without navigating to a new web page: the initial experience of editing an application involves a seamless transition from the use of that application.
93. Each of the features of items 1 through 33 combined with a feature in which the framework enables a published application to be embedded in another application so that the published application can be used by and edited by a user of the other application.
94. Each of the features of items 1 through 33 combined with a feature in which the continuous framework enables users to engage in the direct editing within a web page.
95. The feature of item 94 combined with a feature in which the direct editing comprises direct editing of source code which comprises JavaScript.
96. The feature of item 94 combined with a feature in which the platform comprises the Internet Explorer browser.
97. The feature of item 94 combined with a feature in which the platform comprises the Google Chrome browser.
98. The feature of item 94 combined with a feature in which the platform comprises the Firefox browser.
99. The feature of item 94 combined with a feature in which the platform comprises the Safari browser.
100. The feature of item 94 combined with a feature in which the platform comprises the Android browser.
101. The feature of item 94 combined with a feature in which the platform comprises the Safari browser running on the iOS operating system.
102. Each of the features of items 1 through 33 combined with a feature in which the directly edited text files comprise source code elements that are less than a whole file: users can edit application code while focusing on units of code that are less complex than an entire file which takes advantage of the modular structure of source code into various independent and reusable elements.
103. The feature of item 102 combined with a feature in which the element comprises a JavaScript function.
104. The feature of item 102 combined with a feature in which the element comprises a JavaScript module.
105. The feature of item 102 combined with a feature in which the element comprises a constant.
106. The feature of item 6 combined with a feature in which the revenue is derived from advertising.
107. The feature of item 6 combined with a feature in which the revenue is derived from charges to parent content creators for being able to limit the duplication and editing of their content.
108. The feature of item 6 combined with a feature in which sharing is based on measures of the value of the parent content and child content to the framework: tying the sharing of revenue to the value of the content for the framework incentivizes the creation of content that is valuable to the framework.
109. The feature of item 108 combined with a feature in which the measures comprise content views: tying revenue sharing to content views then links the sharing of revenue to a major source of real or potential advertising revenue, ad views.
110. The feature of item 108 combined with a feature in which the measures comprise content use fees: tying the sharing of revenue to content use fees incentivizes the creation of content that generates fee payment for the framework and content creators.
111. The feature of item 8 combined with a feature in which the application conforms to a cross-platform standard.
112. The feature of item 8 combined with a feature in which the cross-platform standard is web standards.
113. Each combination of features and items 1 through 33 combined with a feature in which users can create brand channels: brand owners can present the applications they create on a branded channel interface within the framework that becomes a custom portal for applications that strengthen their brand.
114. The feature of item 113 combined with a feature in which the owner of a brand channel can stipulate that child applications created by editing the applications published to the brand channel must also be published to the brand channel: brand channel owners can ensure that applications that derive from applications hosted on the brand channel remain within the channel in order to further strengthen the brand.
115. The feature of item 113 combined with a feature in which the owner of a brand channel must approve the public publishing of child applications created by editing the applications published to the brand channel: brand channel owners can prevent derivative applications from misrepresenting their brand.
116. The feature of item 9 combined with a feature in which that language comprises JavaScript.
117. Each of the features of items 1 through 33 combined with a feature in which the continuous framework supports the editing of sprite sheets: sprite sheets can be edited with tools designed to take advantage of their sequential animation format.
118. Each of the features of items 1 through 33 combined with a feature in which the continuous framework provides web services comprising access to a separate key-value-based data store for each hosted application: applications can store key-value data centrally on the server side to be accessed by many client side instances of the application without editing any server side code.
119. Each of the features of items 1 through 33 combined with a feature in which the continuous framework provides web services comprising a state-chat server for each hosted application: applications can share state between many client instances of the application without editing any server side code.
120. Each of the features of items 1 through 33 combined with a feature in which the continuous framework provides web services comprising the registration and retrieval of a high score list for each hosted application that comprises a game: game developers can provide users with high score list functionality without editing any server side code.
121. Each of the features of items 1 through 33 combined with a feature in which the continuous framework provides web services comprising a matching service for each hosted application that comprises a multiplayer game: multiplayer game developers can provide users of client instances of the game with automatic matching with other players of similar skill level or preferences without editing server-side code.
122. Each of the features of items 1 through 33 combined with a feature in which the continuous framework portal displays applications and other content to users based on a recommendation engine: users can be presented with content that is selected to be preferred by that user over other content based on the past actions of that user when compared to other users.
123. The feature of item 122 combined with a feature in which the input to the recommendation engine comprises user ratings: ratings of content and application value by users are leveraged to present users with the content that they are most likely to deem valuable.
124. The feature of item 122 combined with a feature in which the input to the recommendation engine comprises text-based tags: text-based tags are used to categorize applications and content and to present content to users that is similar to content they have found valuable in the past.
125. Each combination of features and items 1 through 33 combined with a feature in which a revision control system is provided for the application files: past versions of application files are retained so that the present versions can be reverted to the past, or changes between various versions can be highlighted so that collaborative application editing can be transparent.
126. Each combination of features and items 1 through 33 combined with a feature in which some changes to applications can be previewed in real-time: the effect of code changes can be seen immediately in the application, reducing the time to iterate upon feedback and allowing application editors to explore possible modifications more quickly.
127. Each of the features of items 1 through 33 combined with a feature in which the editing of image files causes the storage of data that comprises the state of the image editor interface objects in addition to the image pixel data: users editing images do not lose the state of their image editor interface when the image is saved to a single file and can thus maintain the separate objects, layers, and groupings of the elements that were rendered to the image file to make later edits or facilitate later edits by other users.
128. The feature of item 10 combined with a feature in which the inserted function has the same signature as the chosen function: the inserted function carries not only the scope but the same argument structure as the existing function allowing a user that understands the existing function but not the overall code structure to make a function that behaves similarly.
129. The feature of item 10 combined with a feature in which the insertion involves no more than one user action: the insertion of a new function that is related to an existing function is made extremely simple and fast.
130. Each of the features of items 10, 128, and 129 combined with a feature in which the source code comprises JavaScript.
131. Each of the features of items 1 through 33 combined with a feature in which the framework supports real-time chat between users: users collaborating on editing a particular application or seeking help from other users editing similar applications can communicate with chat from within the framework.
132. Each of the features of items 1 through 33 combined with a feature in which the framework supports the execution of automated application tests: developers of applications that require automated tests can edit and execute those tests within the framework to ensure that the behavior of their applications conform to expectations defined in the tests.

These and other aspects, features, and implementations, and combinations of them can be expressed as methods, methods of doing business, program products, apparatus, systems, components, and as means or steps for performing functions, and in other ways.

Other aspects, features, and implementations will be apparent from the following description and claims.

### DESCRIPTION

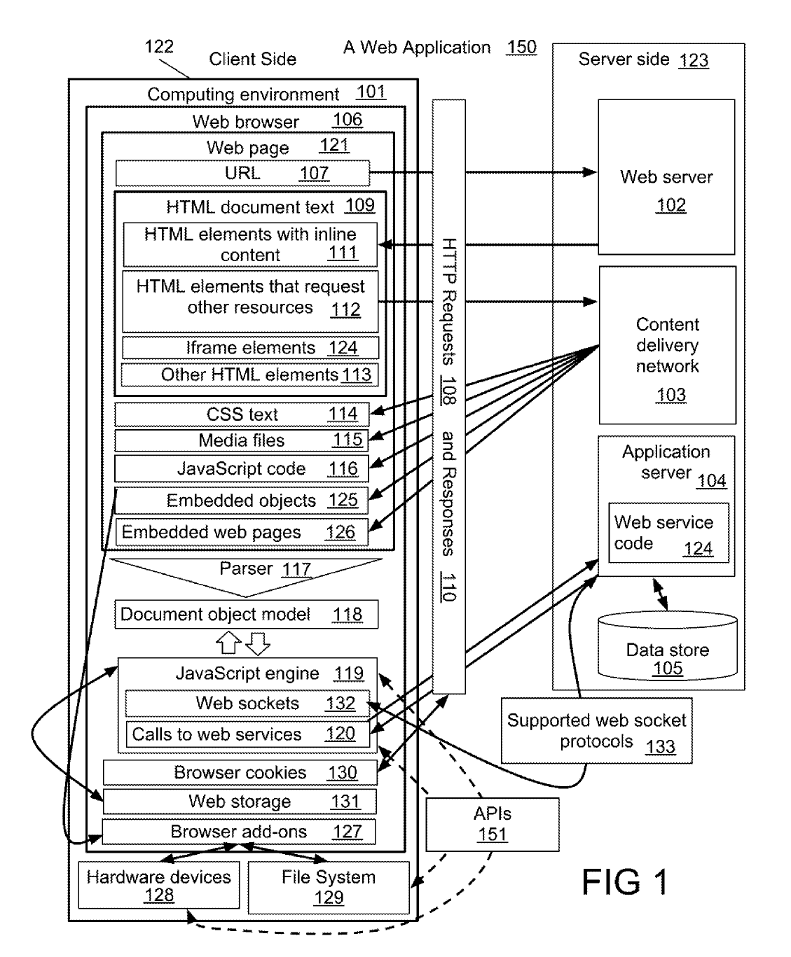

FIGS. 1, 2, and 13 are block diagrams.

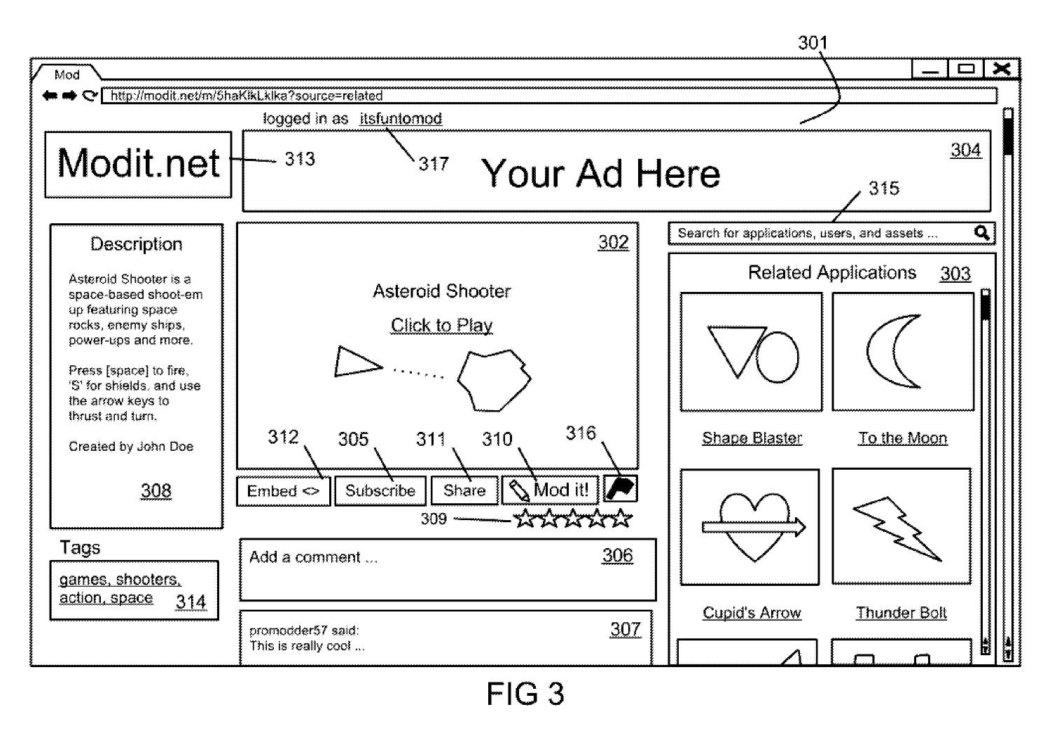

FIGS. 3 through 12 are screen shots.

Here we describe new concepts and techniques for, among other things, designing, modifying, hosting, publishing and using applications, including web applications.

We describe examples of frameworks that are continuous and cloud-based and that enable users (among other things) to create, update, host, and publish applications.

We use the term application broadly to include, for example, any piece of software that can be executed on some device and interacted with by one or more users and or other applications. The device may be any kind of device, including, for example, a personal computer, a mobile device, a remote server, or any other device capable of executing software instructions. In some cases, the user and/or other applications may interact with the application over some network connection, for example, the Internet. The user may also interact with the software through any kind of interface device such as, for example, a keyboard, a mouse, or a touch screen. The application may be written to run directly on the device's processor or may require an operating system or other intermediary software or hardware layers between the application and the processor. In some cases, the application may run as embedded software on special purpose hardware such as custom microcontrollers. The application may be, for example, installed on the device or fully or partially requested over a network connection and stored in temporary files and/or memory. The application may or may not require data from other applications or data stores on the same device or from other devices locally or over a network connection.

Applications include but are not limited to so-called web applications.

FIG. 1 shows the components of a typical, modern web application 150. In the example of FIG. 1, the client side 122 of the web application 150 is a web page or a sequence of web pages 121 that runs within a web browser 106 on some computing environment 101 suitable for running that web browser. Examples include Internet Explorer, FireFox or Google Chrome running on a PC, Safari running on an iPad, or Google Chrome mobile running on an Android device.

The web browser 106 makes an HTTP request 108 to the web page's 121 URL 107 which points to a web server 102 on a server side 123 which is typically accessed through a public network such as the Internet and returns the text of an HTML document 109 in an HTTP response 110.

We use the phrases server side and client side broadly to include, for example, any computing environment that is either on one side or the other side of some communication channel, for example, the Internet. The computing environments on the client side are typically getting service from computing environments on the server side for the benefit of end users, and the computing environments on the server side are typically providing service to computing environments on the client side. We use the term computing environments broadly to include, for example, any computer hardware, software, or firmware, including workstations, mobile computers, and mobile devices.

A web application typically has elements on both the client side and the server side but could have elements on only one side. For example, an application may be downloaded and installed over the Internet but after that time may be used without ever again connecting to a server through the Internet. A web application can also exist as a web service on a server with no client side that is meant to be accessed by other applications over a network connection.

The HTML document text is designed to be compliant with the HTML specification as set forth by the W3C, http://www.w3.org/TR/#tr_HTML, and the WHATWG, http://www.whatwg.org/specs/web-apps/current-work/multipage/. Among other things, the HTML specification tells the developers of web browsers 106 (and other web capable applications) what features should be supported in what way so that web application 150 developers can design their web applications to operate on those browsers and thus be runnable by users.

The HTML specification is based on ongoing work, currently undergoing its fifth revision, known as HTML5. One of the major goals of HTML5 is to extend the power of the web browser to enable web applications to be built that are as powerful and versatile as, for example, applications written to run directly on an operating system. This is a holy grail for software developers who could then write their web applications following the HTML specification and have it run in the same way on any hardware, operating system, or other platform, including a wide variety of otherwise incompatible proprietary hardware devices and operating systems, that support that specification. We sometimes refer to HTML5 and other specifications that can be met on any platform as a cross-platform standard.

HTML5 is often used as a blanket term for a set of web standards that also encompass specifications for JavaScript, the HTML elements, the JavaScript API by which they can be manipulated, and CSS, for which the latest revision of the standard is CSS3. We use the term web standards broadly to include, for example, these specifications, similar specifications, successor specifications, and in general any past or future specification that defines expected behavior of applications based on HTML, JavaScript, and CSS. In the future there may be other application standards that provide specifications for applications to enable them to be used across a wide variety of platforms and that are not built on the World Wide Web. We include such standards in the broad term cross-platform standards, for convenience. And we similarly include applications that comply with such standards within the broad term cross-platform application.

In addition, we use the term web application broadly to include, for example, any application which is accessed by a user over the Internet or within a web browser or other web standards compliant system. We also use the term web browser broadly to include not only conventional applications that are referred to as web browsers, such as Firefox, Opera, Internet Explorer, Chrome, and Safari, for example, but also any other piece of software, hardware, or firmware capable of rendering web standards markup code, such as HTML, and/or running web standards client side code, such as JavaScript.

The HTML document text 111 can contain elements with inline content, such as readable text, CSS within <style> elements, JavaScript inside <script> or other elements, and media elements with data URLs which encode media data into a text string.

The HTML document text can also contain elements 112 which may generate additional HTTP requests 108 for resources not included explicitly in the HTML document text 109 and which are returned from a content delivery network 103 as HTTP responses 110. Media elements such as the <img>, <audio>, and <video> tags may require external media files 115. CSS text 114 can be requested from <link> tags and defines how the page elements are displayed. JavaScript code 116 can be requested from <script> elements and provides the page with interactive functionality. Tags such as <object> and <embed> can embed generic objects 125 in the web page.

For the most part, it is immaterial from the point of view of the user whether separate HTTP requests 108 pull CSS text 114, JavaScript code 115, and media files 116 from the server side or if those elements are explicitly in the document text 109 inline within HTML elements 111. Inline content may be frowned upon from a software design standpoint because it is easier to understand systems when form, style, and functionality are kept separate. On the other hand, from a functionality standpoint it might be desirable to reduce the number of requests required to render the page since each one has a certain amount of overhead in terms of time and server load, especially on mobile devices running on networks with high latency.

The document text 109 may contain iFrame elements which are a way to embed other web pages 126 within the web page 121. Each iFrame element 124 refers to a URL for a web page which can then be fetched (just as with the web page's 121 URL 107) from some server. These new pages 126 inside their iFrame elements 124 then operate almost exactly in the same way as their parent web page 121, except that instead of being directly within the web browser 106, they are children of the web page 121. These embedded web pages 126 need not be part of the same top-level domain (e.g. somecompany.com) as the web application 150 and might be controlled or managed by some completely different company or entity than the web application 150. For example, YouTube encourages users to embed their videos in whatever site they choose, and this is done with an iFrame on the other site which points to a URL on YouTube's servers.

The document text 109, along with any other resources it requested 114, 115, 116, 125, 126 are converted into a document object model 118 by the browser's parser 117. The document object model 118 is a data model for the structure, content, style, and logical function of the web page 121. The display of the web page 121 is continually updated by the browser 106 when the model 118 is changed.

Virtually all web pages are not static and provide interactivity for a user. Nearly all web standards compliant interactivity in the web page 121 requires the JavaScript engine 119 which can alter the document object model's structure and elements in virtually any way. While some of the other HTML elements 113 may be somewhat interactive, such as form fields and buttons, they are static in the sense that they cannot actually change other parts of the document object model 118 without having JavaScript events tied to them in the document object model 118 that are then executed by the JavaScript engine 119. CSS 114 allows for selectors to be defined that cause elements to change their style when in certain states. For example, the “:hover” selector applies a style only when the element in question has the mouse pointer held over it. CSS3 defines transformations, such a rotation and scaling, that can even be animated or applied using keyframes, but these are not interactivity in one sense as they react in the same way each time, and cannot alter anything but the style of an element. We use the term interactivity in a broad sense to include, for example, any adaptation or alteration of a user interface or an external data source triggered by user action or by changes in local or external data sources. For example, clicking a “submit” button on a customer service form in a web page may submit the information entered in that form to the owners of the web page and then display a message thanking the user for her feedback. The JavaScript engine 119 can also run code that performs computations not affecting the document object model 118, or only affecting it on certain intervals irrespective of user interaction. Browser add-ons 127 can create interactive embedded objects 125, such as Adobe Flash movies and applications, but this type of interactivity is not compliant with web standards and often requires the use of JavaScript to alter the document object model 118.

The JavaScript engine 119 can request external content from web services 120. This can be content that is statically hosted at some URL, but more typically data is sent by the engine as an HTTP request 108 to an application server 104 running web service code 124. The application server 104 processes the request and sends a response back to the browser 106 where it is handled by the JavaScript engine 119. As part of this process, the application server 104 will often read and/or write to a data store 105, which is typically some form of SQL or NoSQL database. For example, the web application 150 may allow the user to search for other users by first name, in which case the engine would send a request with the search term to the application server 104. The web service code 124 would run a query on the user data in the data store 105 and return matching results which the JavaScript engine 119 would then display dynamically in the web page 121 by altering the document object model 118.

The latest W3C and WHATWG standards also contain an API for creating web sockets 132 which can be used to open a persistent connection between the JavaScript engine 119 and the application server 104. This means that data can be sent freely over the socket in either direction at any time as opposed to being passed only in distinct HTTP requests 108 and responses 110. This also means that the requests can take place over protocols 133 other than HTTP which allows for more versatility of data exchange.

HTTP responses 110 can store small amounts of text-based information in browser cookies 130. These are linked to the domain from which the HTTP response 110 was sent and are sent along with any later HTTP requests 108 to that same domain. Browser cookies 130 are primarily used to identify requests 108 coming from the web browser 106 as being tied to a specific user of the web application 150, often for authentication purposes.

The HTML5 specification adds another form of persistent data in the browser called web storage 131. This is an area where the JavaScript engine 119 can read and write data in key/value pairs that will be stored persistently in that web browser 106 even when it is restarted. Web storage 131 has several advantages over browser cookies 130 because the data can be much larger and is not included with every HTTP request 108 like cookies 130, which can slow down the application 150.

Users can optionally install browser add-ons 127 which extend the functionality of their web browser 106. Add-ons are sometimes called plug-ins or extensions. These can be virtually any software program but are usually given limited access to things such as the data inside web pages 121 or cookies 130 to reduce security concerns. A plug-in could, for example, check all elements in the web page 121 to see if any are being requested from a list of known advertising servers and, if so, not load those elements. A common use is to support different media types not natively supported by the browser. For example, Adobe's Flash Player plug-in is required to run Adobe Flash embedded objects 125.

Another common use of add-ons 127 is to interface with elements of the computing environment 101 in a way that the web browser 106 does not currently support, such as access to hardware devices 128 or the file system 129. For example, the Google Talk plug-in is currently required to use Google's voice and video chat from within the browser because the major browsers do not provide an API by which web standards code can access video and audio capture devices at this time.

The W3C has working drafts for API specifications 151 that would allow the JavaScript engine 119 to access hardware devices such as the camera or microphones, and to gain deeper access to the file system 129 but there is currently little support for these APIs in the major browsers. In general this will mean that web applications wishing to support features that make use of such access need to temporarily leverage browser add-ons 127. A drawback of this approach is that if a user does not have the required add-on for some feature installed in his web browser 106, that feature will not work. The web application 150 can prompt the user to install the add-on, but in general users are reluctant to do so because of concerns that add-ons 127 expose their web browser 106 to security risks or might slow down their overall browsing experience. Thus, as soon as there is adoption by the major web browsers of a W3C-standardized way to provide some feature, it is vastly preferable over the use of a plug-in. Another option is to test which APIs are supported by the browser accessing the application. Any APIs that are used by the application but not supported by the browser can be listed and the user could be pointed to a browser that does support those APIs.

The web server 102, content delivery network 103, application server 104, and data store 105 need not be on separate physical servers. Two or more of them can run on two or more physical computers or all of them can run on a single physical computer that can serve HTML pages and media files while also holding a database and web service applications. Conversely, or in addition, each component can run on many physical servers. A content delivery network 103 typically contains main end point servers to which the network routes requests in an effort to optimize speed for various geographical locations and to provide redundancy in the event of server or local network failure. Also, the application server 104 could be many real or virtualized servers running behind a load-balancing server which distributes requests amongst the group of servers so that no one server is overloaded. Similarly the data store 105 can be several databases of different varieties for different kinds of data, perhaps divided and replicated across multiple servers. Other components, such as caching servers can also be added to the configuration. A wide variety of combinations of physical devices and services is thus possible.

The HTTP requests 108 and responses 110 can also use HTTPS which is encrypted, if the data needs to be sent securely. Each request can also be compressed or zipped by the server side 123 in a way that the web browser 106 can decompress or unzip the content before processing it to reduce network latency. The whitespace in the CSS text 114 and JavaScript code 116 is helpful for making the code readable during development, but most of it can be removed when publishing to reduce the size of what's sent over the network since end users do not need those items to be readable. This process is called “minification” and one says the code is “minified”. In order to help protect the intellectual property of the developer and further reduce the data size, the JavaScript code can be obfuscated using standard techniques which consistently replace variable names in the code with minimal-length unique names.

FIG. 1 illustrates some examples of the components of a web application 150, but other components not shown may also be part of the web application 150. However, the functional components described are sufficient to provide the functionality of almost any web application. Furthermore, they are illustrated in an architecture that is somewhat standard. Complexity beyond what is shown in FIG. 1, if any, is typically designed to optimize for speed, cost, or fault tolerance and does not change the functional nature of the web application.

The other HTML elements 113 may also include hyperlinks that are interactive in that they can direct the browser 106 to a new web page. This direction can also be done programmatically by the JavaScript engine 119. This can take the user to some other URL that is outside of the web application 150. It can also be used to present a new portion of the current web application 150. In the early days of web applications, any major change to the web page 121 based on communication with the server-side 123 required the browser to load another web page. This has a jarring effect on the user interface and is wasteful because the new web page often had much of the same layout and media as the previous one, but containing different data.

Since the JavaScript engine 119 can communicate with the server side 123 and completely alter the web page 121 as the application developer sees fit, there is almost no functionality that requires loading another web page. Modern web applications have progressively leaned towards avoiding page loads in order to provide a more seamless user experience. In this paradigm the browser 106 is only directed to a new web page when the nature of the web application 150 has changed sufficiently enough to be considered a different sub-application. This much more closely matches the paradigm used by non-browser applications on personal computers and mobile devices. These applications are installed on the computing environment with their full user interface and only interact with the server-side to read and write data, not to request a new user interface.

As described above, a web application 150 has many components. Some are a matter of implementation, such as the physical architecture of the servers that make up the server side 123. Others are left to the choice of the user, such as the computing environment 101 (which is an example of what we sometimes refer to as a platform) or the web browser 106. Any computing environment 101 that can run something like a web browser 106 that can render web-standards compatible web pages 121 can be used to access a web application 150. The functional components, those that determine the functionality and appearance of a web application, are the content files that make up the web pages 121 that the web application 150 serves to the user's client side 122. If there is server side logic in the web application 150, the content of the web service code 124 and how it responds to various requests from web sockets 132 and calls to web services 120 is another functional component.

The computing environment 101 and web browser 106 are designed to render and run web standards (we sometimes use the terms web standard and web standards interchangeably) compliant content according to those standards. The server side 123 is designed to run web service code 124 and send web page 121 content to the client side 122 as it is requested. The functional components of a web application 150 can thus be served by a variety of server side configurations 123 and a primary purpose of the web standards is that they allow those functional components to be rendered and run regardless of the user's choice of web browsers 106 and computing environments 101 or other platforms.

Throughout this document we have and will speak about web-standards-based code and media running in a browser 106 on a computing environment 101. We use the term browser broadly to include, for example, anything that runs and displays, e.g., web-standards-based code and media, including anything that can run JavaScript, and/or render HTML and CSS. For example, Microsoft is touting the ability of Windows 8 (aka Windows Metro) to run apps (applications) based on HTML and JavaScript. Mozilla is also promoting Firefox OS, http://en.wikipedia.org/wiki/Firefox_OS, an open-source operating system designed to give JavaScript access to mobile device hardware directly. There also exist mobile software development frameworks such as PhoneGap, http://en.wikipedia.org/wiki/PhoneGap, that provide a wrapper allowing web-standards-based applications to be installed and run on various mobile devices and operating systems as native apps (applications). Often these platforms are similar to browsers under their hoods, in that they contain WebKit, http://en.wikipedia.org/wiki/Webkit, or something similar. WebKit is used both by major web browsers, such as Apple's Safari and Google Chrome, as well as frameworks like PhoneGap to render HTML 109 and CSS 114 as well as to execute JavaScript using an engine 119. Most of the rest of what makes up literal web-browsers like Google Chrome amounts to the interface around the web pages they display and helpful features such as the ability to save bookmarks. Given the proliferation of wrappers like PhoneGap, it is likely that mobile operating systems such as Apple's iOS and Google's Android will eventually follow FireFox OS and begin to provide a native way for web-standards-based applications to exist both in the browser or as installed applications.

Typically developing applications requires the developer to download and install a development environment in addition to separate media editors as well as to procure and manage server space on which to host the application. Our framework, in contrast, only requires a developer to have the ability and creativity needed to edit the code and media that define the behavior and appearance of her application. Furthermore, our framework is accessible in the same environment (e.g., on the same platforms) as the applications the developer wishes to create. Removing barriers of this sort can be extremely powerful, as exemplified by Github, which made it possible to publish and access the source code of open source projects from a web browser and quickly became a center for open source development.

Our framework is not limited to web standards based applications, but the ubiquity of platforms which can run web standards based applications makes our framework much more powerful in terms of reducing the barriers to someone turning a concept into an application. For example, Xcode is a development environment created by Apple for developing software for OS X and iOS. A developer that owns a computer running OS X can use Xcode to create applications that can run on OS X or iOS. These applications can then be published to the Mac App Store where users with an OS X or iOS device can purchase, download, and install them. Not only does this process involve the developer downloading, installing, and interacting with many disjoint pieces of software, it also does not provide any way to edit the media of the application, nor to host and run a server side for the application. Also, applications created in this way can only be installed and run by users with OS X or iOS devices.

By leveraging web standards to create an end-to-end, cloud-based application development environment, our framework allows any developer with access to a web browser to create almost any web application and instantly put it in the hands of a user with access to a web browser without the developer or user downloading or installing anything. Our framework becomes more powerful by its inclusion of the concept of end-user modification, or modding.

Users of an application created within our framework will be explicitly encouraged to modify that application. Any user can create a clone of the original application which can then be altered by any user who has the creativity and skill to do so into whatever they desire. This modified application is then part of our framework and thus is also accessible by any other user with access to a web browser. This set of features will produce content that is not just viral, but adaptively viral—constantly being altered and customized by those it is shared with in order to make it better to share with some other group.

Through the process of modding a single application can spawn many derivative applications, in one or more chains, each more valuable to its users than any single incarnation of the application ever could be. Furthermore, modding unlocks the creativity and ability of the crowd by lowering the barrier to contribute to applications. A video game enthusiast with an idea for a fun game mechanic can publish an ugly game that will later be visually polished by a designer that could have never conceived of that game mechanic. A student with little software experience can alter a few functions in an application to create something custom or fundamentally better even though he lacks the skills to create the original application on his own.

We also describe an application development feature called Gnosis mode. Modification opens applications up to their end users who are only limited by their ability to alter the code and media of an application. This can be further facilitated by features such as the Gnosis mode, which displays which components of an application are calling which functions in real time as the application runs. This way a user of an application can immediately link observed behavior of the application to the fundamental units of code that need to be edited to alter that behavior.

In addition, we discuss special features for editing application code. These features leverage interface elements that are already known to users of applications in order to enable users unfamiliar with syntax to modify code. Other interfaces can, for example, restrict a user's ability to edit certain portions of the syntax so that users inexperienced with the code syntax are prevented from making accidental mistakes, but are still shown what the proper syntax looks like in order to teach them through immersion.

In addition, we discuss examples of modular applications. Applications conforming to web standards can be easily embedded in other applications conforming to web standards in such a way that they can communicate with the surrounding parent application and any other embedded sibling applications. Our framework leverages this fact to motivate the creation of an Internet driven by modular applications that can be customized and reused by anyone. We envision a paradigm shift where future web applications will increasingly utilize modular, embedded applications of this nature.

The tools within our framework that allow developers to edit code and media can themselves be applications that can be modified within our framework. Furthermore, a developer can specify which tools are packaged with his application and how they are displayed when it is modified by another user. This allows the crowd to improve upon or customize the existing application modification tools as well as to create custom tool interfaces designed to facilitate application modification by users with little or no software development experience. Furthermore, these custom tools can be reused outside our framework, for example, by embedding them in other applications.

Not only could a single, powerful tool then give our framework visibility on thousands of web pages, but use outside of our framework will motivate modification of the tools in new ways that may be brought back into our framework, thus creating a feedback loop that continually enhances the ability of our framework to empower its users to create, modify, and distribute applications.

We also explain examples of new revenue sharing models. The open source movement has proven that large software projects can be created by loose organizations of remote individuals with no promise of any reward save perhaps recognition. The fact that our framework is a single system in which applications are modified and used allows it to provide structured incentives that can more precisely motivate its users to enhance the value of our framework to the world at large. A revenue-sharing model which gives a portion of the revenue generated by applications not only to their creators, but also to the creators of any application from which that application was derived, can motivate the creation of applications that are more modifiable and enable the enhancement of those applications to be more valuable to end users. In an earlier example, both the creator of the fun game mechanic, and the artist that made it look slick would be rewarded for the success of the final game. Developers would be motivated to make better development tools and template applications that did little themselves but provided an excellent starting point for a variety of applications. A developer could label his application's interface in his native language and some other user may create a translated version and promote it in an entirely different culture to the benefit of both the developer and translator.

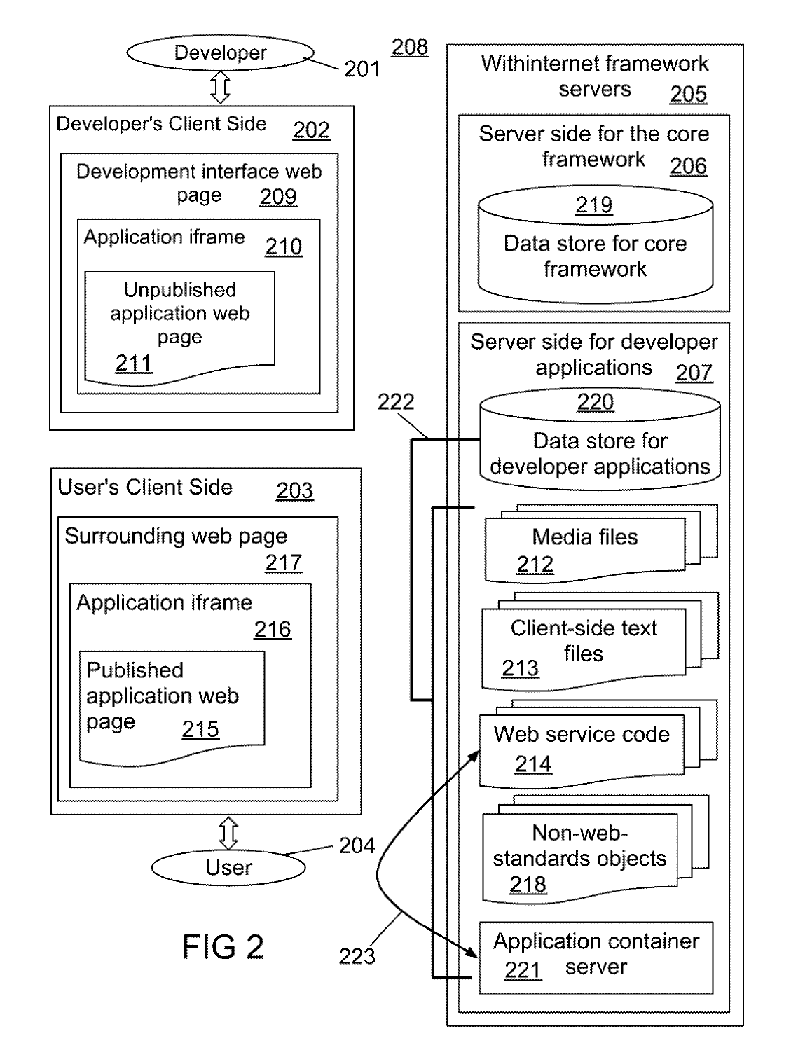

FIG. 2 shows examples of a continuous framework 208 for such web application activities from the points of view of a developer 201 of a web application (that is, an example of the web application illustrated in FIG. 1) and of a user 204 of that web application.

We use the term continuous framework broadly to include, for example, any application or collection of applications running on one or more platforms and, for example, spread across a client side and/or a server side, and which a user interacts with on one or more of the platforms such that the applications with which the user is interacting on those platform(s) as part of the framework are all, for example, controlled by the same entity.

We use the term platform broadly to include, for example, any design of hardware devices, software (e.g., an operating system), or both on which applications can be run and interacted with. The characteristics of applications that are capable of running on a platform can be and sometimes are defined and published as a platform specification. Applications that can run on such a platform are said to be compliant with or conform to the platform or the platform specification. Features of some application which can be used when the application is run on a platform are said to be supported by the application on that platform. A platform can be proprietary (Mac computers and the related operating systems; Microsoft windows as a platform for applications) or open (PC computers, perhaps Android devices). A platform can span millions of instances of actual hardware and software products (your Mac laptop as one instance; my workstation running Windows 7 as another instance) that are compliant with the specification. In our way of defining it, applications that are compliant with a given platform may not be compliant with other platforms, for example, Windows applications do not run on Mac computers. Applications also may only support a subset of their total features on any given platform, for example, web applications for which not all features are supported when that application is not run in the latest version of Internet Explorer.

In some cases, application standards have been defined that span multiple, e.g., incompatible hardware and software platforms. This has been especially true in the realm of applications that run on platforms that communicate through networks like the Internet. HTML, for example, is an application standard for a way to express the content of files so that they can be created and used at web servers and web browsers running on any kind of platform that is web capable (which includes most platforms). Because these application standards span multiple platforms, we can refer to them as cross-platform standards. We sometimes refer to cross-platform application standards that apply to the World Wide Web as web standards or a web standards. We sometimes refer to an application that conforms to a web standard as a web-standard-based application.

We use the term entity broadly to include, for example, an individual, private company, or corporation. We say that some entity controls an application when, broadly, for example, that entity can define the terms of service between the entity and an end user of the application or has the ability to modify the behavior of that application for end users, or that entity charges a fee for the use of that application, or that entity can choose to discontinue the service provided by the application. For example, the web application found at facebook.com is controlled by the entity Facebook, Inc., which can, at any time, alter the appearance or terms of service of that web application.

We say that some set of features is supported by some continuous framework on some platform if a user of the continuous framework only interacts with a single entity during the course of using those features on that platform. (With respect to a continuous framework, a platform, and a feature we use the term support broadly to include, for example, the enabling by the continuous framework of users to use that feature on that platform within the continuous framework. More colloquially, the phrase “supports a feature” includes, for example, the notion of “has a feature” or “provides users with a feature”). As an example, Amazon Web Services is a collection of applications controlled by the entity Amazon.com, Inc. Many applications run by other entities depend on applications that are part of Amazon Web Services. Take some framework F1 which depends on Amazon Web Services, which users interact with on some platform P1, and which is controlled by some entity E1 that is not Amazon.com, Inc. While entity E1 may interact directly with Amazon Web Services in terms of interacting with the interface controlled by Amazon Web Services at http://aws.amazon.com, or opening an account, or paying some fee to Amazon.com, Inc, a user of some set of features of framework F1 on platform P1 may never interact directly with Amazon Web Services or Amazon.com, Inc. in the course of using any feature in that set and, in this case, the set of features is, in our way of expressing it, supported by the continuous framework F1 on platform P1.

Now take also a framework F2 which runs on platform P2 and is controlled by entity E2 that is not Amazon.com, Inc. If a user of framework F2 on platform P2 is required to interact with the interface controlled by Amazon Web Services, or to open an account with Amazon.com, Inc. in the course of using some set of features, then that set of features is not supported by the continuous framework F2 on platform P2 because use of the feature requires direct interaction with Amazon Web Services which is not controlled by entity E2.

The quality of a framework which we describe as continuous is, for example, that which allows its users to interact with a single entity in the course of using the features of that framework on some platform. If some set of features of a framework require a user interacting with the framework on some platform to interact with more than one entity then at least one of those features is not supported by the continuous framework and can be considered not to be part of the continuous framework. In some cases, an entity controls an application and acts as a vendor which sells or licenses instances of that application that are then controlled by the entity acting as a buyer or licensee. For example, some entity E7 may create a chat application that some other entity E8 licenses from entity E7 in order to integrate it into a web application W8 (controlled by E8) so that the users of W8 can chat with each other by typing text. The instance of the chat application inside W8 is controlled by E8 from the perspective of the user because E8 could choose to remove the chat application from W8, and often the license agreement between E7 and E7 would allow E8 to alter the appearance and functionality of the chat application instance inside W8.

We also use the phrase enhanced platform broadly to include, for example, a platform which has been modified by a user of that platform to support additional functionality that the platform did not initially possess. Take some framework F3 which is controlled by entity E3 and which users interact with on platform P3. If some feature of framework F3 requires a user to enhance platform P3 by installing some application A4, which is controlled by entity E4, on platform P3, then we would say that the continuous framework F3 supports that feature on the enhanced platform P3 because the user's direct interaction with application A4 was only required for the initial installation and configuration (and perhaps later updates) of A4 and not during most instances of using that feature. However, the continuous framework F3 does not support that feature on the unenhanced platform P3 because using the feature involves interaction with application A4 which is not controlled by entity E3 that controls F3.

As a more specific example, some web application W5 may require that users running the web application W5 on the Internet Explorer web browser platform who wish to capture audio using the microphone on their device have Adobe's Flash plug-in installed. The first time a user tries to capture audio using web application W5 from within Internet Explorer, they would be told to install the Adobe Flash plug-in if they had not already. Once the user had installed the Adobe Flash plug-in, the feature of capturing audio would be supported by W5 on the enhanced platform of Internet Explorer with the Adobe Flash plug-in. The Flash plug-in may take some initial configuration, or Adobe may release updates to the Flash plug-in, which may be required to be installed for later changes to the audio capture feature of W5 to be supported, but in general the user would be able to run W5 on Internet Explorer to capture audio using the microphone on their device without directly interacting with the Adobe Flash plug-in or Adobe, Inc. Note that the feature of capturing audio would not be supported by W5 on the unenhanced Internet Explorer platform because the user would be required to interact with the flash plug-in which is controlled by Adobe, Inc.

As we will describe in the following section, our framework 208 allows, as core features, users to create, update, and host web applications 150. Our framework also allows, in some implementations, for example, for distribution (giving users a place to put their applications where people will look for them, a la YouTube), and hosting of server-side facilities, among other things. We use the term host with respect to applications broadly to include, for example, the act of providing one or more users with access to an application over a network, typically the Internet. The users may access the application by downloading a hosted executable installer file, that, when run on some platform, installs the application on that platform in a way that it can be run by the user. In the case of web applications, the user is often downloading the hosted application code and media files which are then run directly on a platform such as a web browser. These files may also be downloaded and stored so that the web application can be run “offline” and possibly updated when the hosted files have changed.

We use the term portal broadly to include, for example, a centralized interface which presents a variety of content to consumers of that content. Content consumers then use the portal as a way to discover content through activities like browsing and searching. For example, Yahoo News, http://news.yahoo.com/, is a portal which consumers visit in order to browse and search for new articles and Kongregate, http//www.kongregate.com/, is a portal which consumers visit in order to browse and search for online games.

We use the phrase direct editing with respect to application files broadly to include, for example, the act of changing the data in a file such that any change supported by the format of the file can be made. For example, if some application allows users to directly edit a text file, those users are able to add to, alter, or delete all of the characters that make up that text file. A user directly editing an image file is able to alter the individual pixels that are shown when the image file is viewed. For more continuous formats such as audio and video, direct editing applies more to the timeline of those files. Direct editing of these files involves the ability to delete from, insert into, and move portions of, the timeline with some reasonable limit on precision such as hundredths of a second.

The ability to directly edit an application file is important so as to not limit application developers. If some development environment allows an application developer to alter the files that make up that application in any way that is supported by the standard that defines how that application runs on some given platform, then the developer is unfettered in their ability to use that standard and the features it defines for that platform. If instead a developer is given some tool that alters these files in a manner that is not direct, perhaps as a trade-off for some level of convenience, then they cannot fully utilize the standard and platform which limits the applications they can create.

We use the term compile broadly to include, for example, the act of translating a source file that conforms to some source format into a target file that conforms to some target format. For example, developers writing applications in the C++ language must compile the text files that make up their applications into the machine code that makes up executable binaries that can be run by users of the application on specific hardware or operating system platforms. As another example, languages like CoffeeScript, http://en.wikipedia.org/wiki/CoffeeScript, or Dart, http://en.wikipedia.org/wiki/Dart_(programming_language), use text-based code that can then be compiled to JavaScript so that applications written in those languages can be run on platforms that support web standards after compilation. Dart and CoffeeScript exist in order to fix what many see as problems with the JavaScript language that make it difficult for developers to use, but compile to JavaScript to take advantage of the wide, cross-platform support of that language. We define web applications broadly with respect to our framework. Creation, development, updating, editing, modification, distribution, publishing, and hosting, and other uses of web applications within our framework apply to any application designed based on standards that operate on a layer that is above, and thus applies across, a wide variety of possibly otherwise incompatible operating systems and/or devices or other platforms, such that wide acceptance of such a standard would provide easy access for user to the application from the majority of operating systems, devices, and other platforms. Web standards are a system of standards that are supported in this manner, but more broadly the term web standards as we use it can include, for example, any platform independent standard that is applicable to and usable with respect to a set of otherwise incompatible operating systems and/or devices or other platforms. For example, web browsers are applications that run on operating systems on various devices (that is on various platforms) that implement web standards and thus provide a platform for users to interact with web applications. Certain operating systems, such as Firefox OS, or Windows 8 (aka Metro) support web standards applications directly.

As discussed above, the functionality and appearance of a web application 150 is typically determined by the content of the web pages 121 it serves and, optionally, the web service code 124 that responds to requests from those web pages. Thus if one can create, edit, publish, and host components of the web application, one can create, edit, publish, host, and use in other ways a web application 150. More explicitly, the web application components that examples of our framework create, edit, publish, host and use in other ways 212, 213, 214, 218, 221, 220 are sufficient to create any web application, though some web applications may be architected into different components. The content of the figure is not meant to show all parts of our framework 208, but rather highlight those parts that are especially relevant to this high-level view of how our framework 208 functions. When not explicitly mentioned, the components of FIG. 2 that reference components of the generic web application 150 that are not shown should not be considered to have been omitted, but rather, to have been not distinct enough from their role in the generic web application 150 to be mentioned again here. We use the term functional components of a web application broadly to include, for example, any files or software that can be changed to alter the behavior of an application.

Our framework 208 is itself a web application 150 supported by a server side 206 that is an example of the server side 123 described in FIG. 1. The developer 201 accesses our framework 208 through a client side 202 that is an example of the client side 122 described in FIG. 1. The developer's client side 202 includes, among many of the things described in the generic web application client-side 122, a development interface web page or pages 209 which allows the developer 201 to create and edit all of the functional components of a web application 150. This web page is hosted and served by the server side for our framework 206 just as web pages 121 in the generic web application 150 are implemented using HTTP requests 108 and responses 110. The interface for this process will be discussed in greater detail later; this overview is meant to show how a developer and user interact with the general architecture of our framework. The server side for our framework 206 is a conceptual segregation of the hardware and software needed to support the portions of our framework that are not created by its users. This separation may or may not exist in terms of separate physical or virtual servers. It is also possible that much or all of our framework may be developed using our framework itself in which case our framework itself could be considered a developer application where the developer is the entity that created and manages our framework.

Communication between the client sides 202, 203 and server sides 206, 207 works as in the generic web application 150. Files are served from the server side for our framework 206 and the server side for developer applications 207 to the developer's client side 202 and user's client side 203 using HTTP requests 108 and responses 110. The development interface web page 209 and user's 204 surrounding web page 217 can make HTTP requests 108 to web services running on the server side for our framework 206 or server side for developer applications 207 to store content on those systems or data in their data stores 220, 219. The server side for our framework 206 can similarly communicate with the server side for developer applications 207 using web services to store data and media.

The client-side text files that make up a web application 213 can be typed into a text editor within the development interface web page 209 and saved to the server side for developer applications 207. They can then also be pulled, edited, and saved again. These files can include the HTML document text 109, CSS text 114, JavaScript code 116, and any embedded web pages 126 that are not externally hosted already.

The media files for applications 212 can include the supported media types as described in the media files 115 for the generic web application 150. The development interface web page provides tools to create and capture these media types and save them to the server side for developer applications 207. They can also be pulled, edited, and saved again.

The web service code for applications 214 can be typed into a text editor within the development interface web page 209 and saved to the server side for developer applications 207. They can then also be pulled, edited, and saved again. These files are represented in the generic web application 150 as web service code 124.

The web service code for applications 214 and client-side text files 213 can also be altered by other tools that provide an interface not based on editing text that parse and alter the code in specific ways, examples of which we'll detail later.

Non-web-standards compliant objects 218 include embedded objects 125 that might be supported by some browser add-on 127, for example, Adobe Flash swf files. Since they are not governed by standards, it is not possible for the development interface web page to account for all possible file formats and provide editing capability for them. Regardless, the interface can still upload and save these files to the server side for developer applications 207 and the client side text files for applications 213 can refer to these stored files. Of course, these files can be replaced by newer versions edited or created by some external program.

In order for the development of the components discussed above to take place, the developer 201 must have some way to see and use the application they are developing. The development interface web page 209 contains an application iFrame 210 which displays the unpublished application web page 211 to the developer. This web page 211, like the web page in the generic web application 121, is a rendered view of the developer's application and can be used interactively just as it would be within a browser for an end user. In this sense and in this activity, the developer is a user.

When a developer 201 creates a new web application within our framework 208, the development interface web page 209 calls a web service to create a record for that new application in the data store for developer applications 220 that is tied to the developer's user account in the data store for our framework 219. As elements are added to the application and stored on the server side for developer applications 207, metadata references 222 to those elements are tied to the application's record in the data store for developer applications. This way the developer 201 can log in to our framework 208 and see a list of her applications. The metadata references 222 to the media files 212, client side text files 213, web service code 214, applications and code on the application container server 221, and non-web-standards-compliant objects 218 are maintained by the data store for developer applications 220 as those objects are altered. This way past versions of each object can be stored and reverted to, but the data store 220 retains metadata references 222 to the current versions of these files and their URLs so that those URLs can be inserted in the unpublished application web page 211 which will then pull those files to be shown to the developer 201. Just as it was discussed that in a generic web application 150, the web page 121 can contain links that lead to other web pages, the client side text files 213 can contain multiple, separate web page files (or other files such as CSS 114, JavaScript 116, and media files 115) that the data store 220 links together into the same application for editing and permissions purposes.

Effectively, the data store for developer applications 220 then has a record that ties certain files on the server side for developer applications 207 together into one web application. By keeping records like this, many applications made by many developers can be hosted from the same server side for developer applications for creation, editing, and use.

There may be files, both text and media, that are tied to an application in the data store 220 by metadata references 222 when it is being created or edited, but are not used in that application. For example, a developer might be working on a new character for a game, and want to save that image file with her application for the purposes of organization and later use, but still publish the game as it exists without that image.

While the developer 201 is working on an application it can remain in an unpublished state. By umpublished, we mean, for example, that the data store for developer applications 207 would only serve the unpublished application web page 211 to a user who was authenticated to be the developer 201. The developer 201 can then publish the application, which would allow a user 204 that might have no account, or a user account that is distinct from that of the developer 201 to view the published application web page 215.

Thus, although we have shown a developer's client side and a user's client side separately for convenience in our description, in general, a user can at one time be a user of any web application and at another time be a developer of any web application. We use the term developer broadly to include, for example, anyone who is creating or altering or distributing or publishing some application using our framework and we use the term end user broadly to include, for example, anyone who is using some application but not, at that time, creating a new application or altering, distributing, or publishing an existing application. We use the term user broadly to include, for example, both developers and users and any other individuals, entities, or organizations with accounts on our framework or that are interacting with our framework.

Our framework 208 therefore provides a complete self-sufficient platform on client and server sides that enables the creation, development, editing, updating, distribution, publication, and other uses of a web application.

An example of a typical process of developing a web application involves a developer working on all components of the application on her local machine (computing environment), or on a server she has access to but that is not publicly accessible for development. The developer could then use her software, or some third party tool that she had to configure, to push the application's files, often along with some complex server configuration, to some hosting server that she has access to or owns. Thus the act of publishing within our framework 208 seems comparatively simple as the web applications files are already within our framework 208 and are, in a sense, continually published to the developer 201 until such a time that the developer 201 decides that they should be published to other users 204, which then becomes more of a matter of permissions rather than a complicated cumbersome process of publication. In other words, development, publication, and use can become a seamless set of activities within our framework. A published application may also have some performance-focused enhancements applied to it that make it differ from a unpublished application. For example, the client-side text files 213 may be stored in both their normal format, and also minified to reduce download time and bandwidth costs.

The process of creating and editing a web application within our framework 208 is then largely about creating and editing the files that make up that application which are then stored on the server side for developer applications 207. The process of publishing a web application within our framework 208 is mostly a process of setting the server side for developer applications 207 to give access to users other than the developer themselves 201. In typical web applications hosting involves purchasing and managing servers or space on servers on which to store media files and client-side code and markup in such a way that it can be accessed by client browsers over the Internet. It can also involve purchasing and managing servers or space on servers which is configured to run server-side code and act as a data store for data and web services that support the web application.

Our framework 208 stores all media files 212, client-side text files 213 and non-web-standards compliant objects 218 as part of the development process, for example, by virtue of the fact that the development interface is a web page 209. These files would be stored on a content-delivery network 103 which would respond to requests for the files using URL from the unpublished application web page 211. An example of such a network that is managed and hosted as a service is Amazon's CloudFront, http://aws.amazon.com/cloudfront/ which allows for limiting of access to files using signed URLs. Thus the files are already hosted on the server side in a typical hosting context even during development; exposing them to client browsers in the published application web page 215 is a matter of setting the content delivery network to allow access by a user 204 that is not the developer 201, or perhaps even anyone making a request, even if they are not authenticated in any way.

The data store for developer applications 220 can be used to store not only data that the server side for our framework 219 uses to tie together files for a web application, but also data that the web applications themselves want to store and retrieve. This storage and retrieval may come from the client side using calls to web services provided by the server side for developer applications 207 that would allow key-value storage and retrieval. For example, a contact organizer application would want to store keys that are a combination of a unique contact identifier and various facets of that contact like first and last name, address, and so forth. More specific web services could be provided that would provide a simple interface to address common needs like a high score list for games. (We sometimes refer to games as examples in our discussion. Although games are a good example of the use of the techniques that we describe, they are only one example, and the techniques have broad relevance to a wide variety of applications that can be run on a wide variety of hardware and software platforms.) In this case, the calls to the web services would send a name and a score and the server side for developer applications 207 would sort and store that score into a list of a fixed number of the highest scores to date which could then be pulled via a call to the web service. These web services would allow application developers 201 to store data for their application centrally without writing any specific server-side code.

For more complex or specific server-side functionality and storage, application developers 201 would want custom server-side code 214 to back their custom web services and data storage. There exist services already that allow developers to host and publish server-side code in this way without having to manage the servers that run that code or store that data. These services are called platform-as-a-service or, as we'll be calling them, application containers. Examples include Google's App Engine, or Amazon's Elastic Beanstalk. They provide virtual machines on which developers can place code that is written in a set of supported languages. That code is then run on the server and can be accessed by the web if desired without the developer configuring and managing the operating system, database server, or web server. The server-side for developer applications contains an application container server 221 that provides application containers on which the web service code for applications 214 can be run. This server may be managed by our framework 208 or it could be a third party service like Google App Engine or Amazon's Elastic Beanstalk that our framework partitions and ties to each web application using data in the data store for developer applications 220.

In the case that the application container server 221 is managed by our framework 208, cloudfoundry, http://cloudfoundry.org/, could be used to remove the need for creating custom application container software. Cloudfoundry is an open source application container. The code and instructions on how to install and run it can be found on their github repository https://github.com/cloudfoundry/vcap. Thus providing the application container server is simply a matter of installing and configuring the cloud foundry code, which, since it is open source, could be customized in any way that is necessary. In this case the data store for developer applications 220 would still need to link requests from each application to their specific application container using stored metadata 222. The application container server 221 would have certain limits on how much data could be stored or how much computing could be performed for any given application, these features are already provided by cloudfoundry. The computation and storage limits could be lifted if application developers 201 wanted to pay for that service to support larger applications.

The records in the data store for developer applications 220 that tie together the application's editable files amount to what could be called web application metadata. In addition to keeping track of the locations of the application's files to limit access to editing them to the original developer 201, and keeping track of past versions of the files for reversion, the data store 220 would also contain other application metadata. This metadata could include but is no limited to: source attribution for media files created by someone other than the developer; comments on the files to provide context and direction that the developer wants to remember or to catalog the changes in each version of the file; lists of what resolutions the application prefers to be run at, or the devices on which it expects to be run and thus supports.

As with the generic web application 150, the specific architecture shown in FIG. 2 is largely a matter of choice and partially driven by a need for clarity in the figure. The server side for our framework 206 could be one server or many, and could be intermingled with, or on the same server as the server side for developer applications. The data stores 219, 220 would most likely be sufficiently run on an SQL server but eventually might need to be split among many servers where NOSQL may be advantageous. Both data stores 219, 220 might be on the same database server, or separate ones. Assuming our framework uses other Amazon Web Services products, Amazon RDS is a natural choice for a managed SQL server and Amazon DynamoDB is a natural choice for a managed NOSQL server. The data stores 219, 220 could also be hosted on servers managed by our framework using any of the myriad SQL and NOSQL database servers such as MySQL, PostgreSQL, or MongoDB. Any web service calls between either client side 202, 203 and one of the server sides 205, 207 or between the server sides 205, 207 themselves can also be made using web sockets 132 over supported protocols 133. They could also use SPDY http://en.wikipedia.org/wiki/SPDY, an alternate protocol that is currently non-standard but is being advocated by various organizations in the industry.

So that application developers do not have to start from scratch, our framework 208 might provide a page of application templates for developers 201. These could include generic applications and games that the developer 201 could then customize and build upon. The set of templates provided would seek to provide maximum coverage of the space of applications that developers would seek to create and that users would like to use.

FIG. 3 shows an example of our framework's web page 301 as it would appear, for example, to a user through the user's client side for a published user web application. This is an example of the surrounding web page 217 (FIG. 2) for a published web application. In typical implementations, applications published using our framework will be given a web page 301 hosted within our framework. The published web application web page 215 is displayed within the user web application iFrame 302.

If modification (sometimes called modding) of applications by end users is allowed, then a button enabling and encouraging modification 310 will be displayed. Here we use the term end user to mean the users of some application created on our framework who may not necessarily be users of our framework's other features prior to modifying some application. This modding capability can then be considered as distinct from the ability of a developer who created an application on our framework to later modify that same application again. When clicked, the modding button 310 will take the user to the development interface web page 209 as mentioned in FIG. 2, which will be discussed in more detail later as will the general process of application modification. The process of end-user modification of applications will be discussed in more detail later.

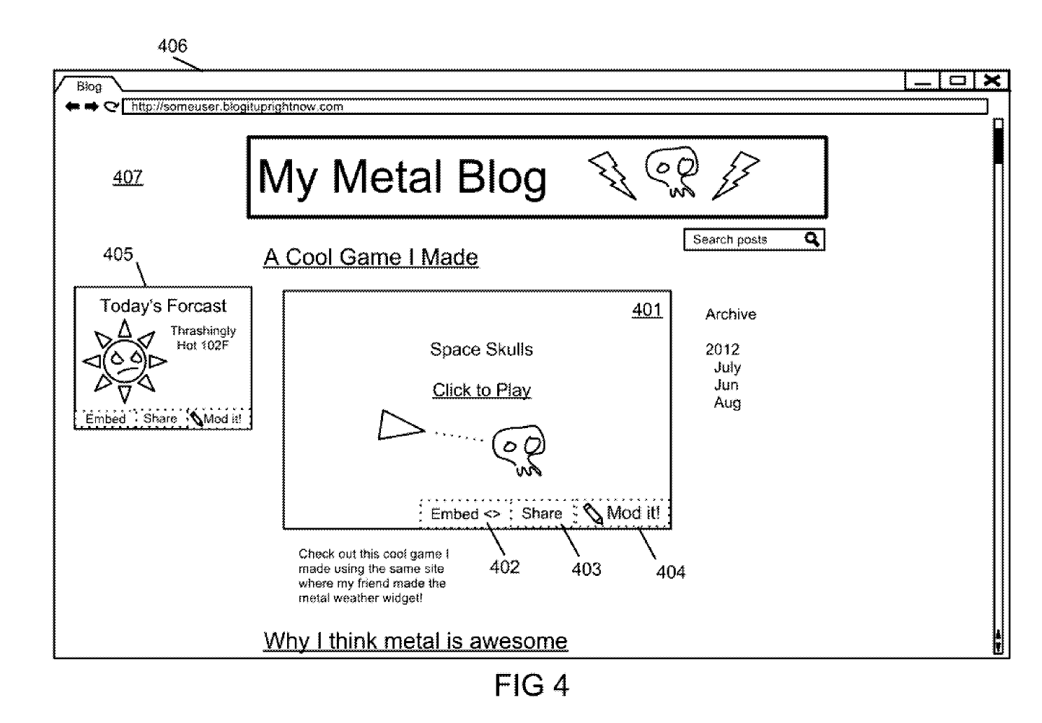

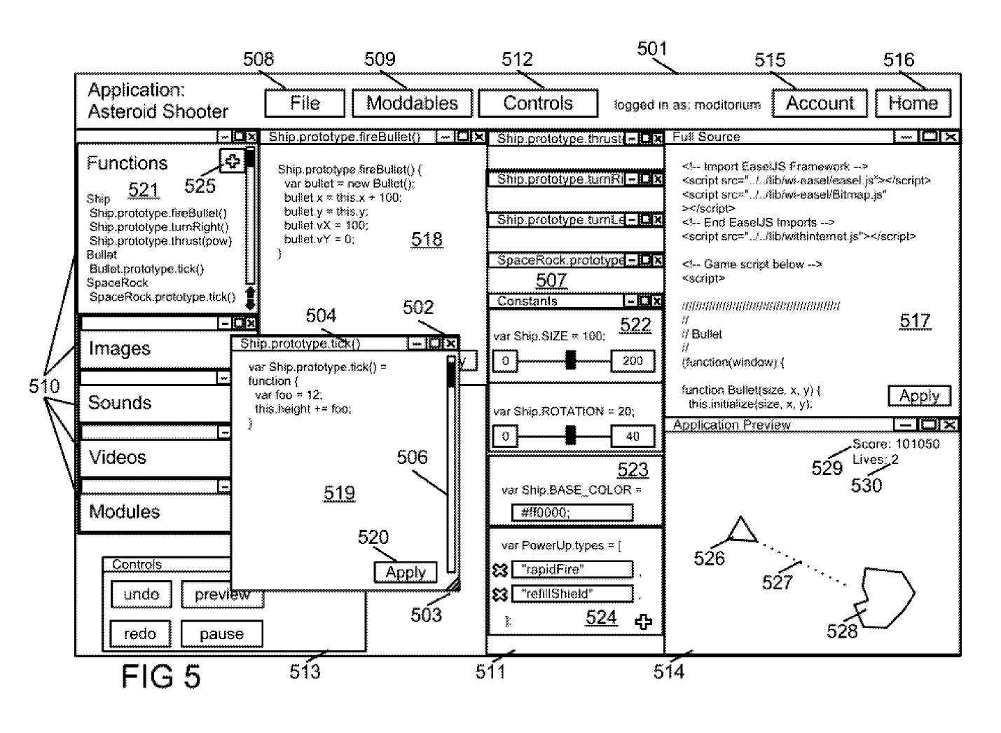

It may be advantageous for the Mod It button 310 to not navigate to a new page 209 but rather alter the page around it 407 (FIG. 4) to reconfigure the environment to one in which the user would make the modifications. This would create a more seamless experience for the user. In this case, the application iFrame 302 would be relocated and would become the preview iFrame 514 (FIG. 5). Any other interface elements in the application page 301 that were also in the editing interface 501 could be kept or moved, but for the most part the other elements of the application page 301 would be hidden by setting their display attribute to none. If this produces a performance issue or difficulty of some kind, these elements could also be removed. Then the elements of the editing interface 501 would be requested from the URL via JavaScript and arranged. Since the application code in the iFrame 302 would be minified for the sake of bandwidth and download speed, the code in its editable form, as last saved by the application developer with his formatting, would also need to be pulled from a web service.

Around the user application iFrame 302 there could be, for example, elements that have become standard for websites that host user-generated content such as YouTube. One such element is a field in which a user can add a comment 306 (presumably a comment about the web application) that will then be displayed in a list of comments by all users 307. It might be required that a user be logged into her account to comment. As is standard, the owner of the application may be able to moderate the comments by deleting ones he deems offensive for some reason. Also, other users may be allowed to vote on the value of the comments and the most valuable comments can be displayed at the top with the rest following chronologically.

Another element is a button to subscribe to the user who created the application 305, thus receiving notices when they modify the application or create new applications. There could also be the option to subscribe to comments submitted by users about the application. If modification of applications by end users is allowed, there may also be an option to subscribe to the application itself and thus receive notices when a child application is created. There will also be a button to share 311 the application which would open an interface (such as the one offered by AddThis http://www.addthis.com/) allowing users to post a link to the application along with other supplemental information on a variety of social networks such as Facebook, Google+, or reddit.

There can be a way to rate the application one to five stars 309. This information can then be used later to fuel a recommendation engine. The rating system, instead of stars, could be any number of ways to assign a value from something binary such as “Like” or “Don't Like” or a numerical rating between two values such as one and ten, or a list of adjectives such as “poor” all the way up to “amazing”. The rating system may also have multiple dimensions such as “fun” or “productive” that can be given different ratings. If modification of applications by end users is allowed, one of the dimensions might be how easy the application is to modify.

There will also be a button that instructs the user as to how they can embed the application in another web page 312. This will open an interface which provides the user with the text of the iFrame HTML element that is to be placed in the external web page. There can also be form elements that allow the user to customize how the iFrame is formatted in terms of size, border and other style concerns. These would alter the content of the iFrame tag that can then be pasted into the source of a web page.

The creator of the application will be able to write a text description of the application that will be displayed next to it 308. As is standard, the top of the page can be used to display a logo for our framework 313 that, when clicked, would go to our framework's main page, and banner advertisements 304.

A list of text-based tags 314 can also displayed on the web page for a user application 301. Tags are words or phrases that help categorize and identify content and are standard across blogs and image sharing websites. The creator of an application can list the tags that apply to his application and have them appear in a list 314 next to the application. As is standard, these tags will be hyperlinks that, when clicked, would show a list of applications that have that same, or similar, tags. It may be useful to allow users to vote down or up certain tags or to add or remove them as the creator of the application is not always motivated to correctly tag the application.

Also on the page there will be a pane displaying related applications 303 represented by thumbnails that the application creator can choose. The thumbnails might be based on a screenshot of the application or image that the developer uploads. These related applications may be generated based on searching the descriptions of other applications for keywords in the main application's description, or using a similar technique on any other application metadata such as tags or what users have rated it highly. If modification of applications by end users is allowed, the related applications pane 303 could display the parent application and some selected child and sibling applications. These could be selected based on their rating with a bias for new applications so that they are exposed to users and can be rated fairly. If the user is logged into his account these recommendations can be biased to match the ratings they have made previously when logged in using standard recommendation engine techniques.

The page will also include a search tool 315 that will allow users to search for applications, other users, or moddable assets such as images, sounds and videos. For users the search would use common algorithms or third party tools to find the entered text in the user's username or profile page. For applications and moddable assets it would search the text of their descriptions and tags. We use the term moddable in a broad sense to include, for example, the quality of something that describes its ability to be modified using our framework. We use the term assets broadly to include, for example, any files or portions of files that our framework presents as units that make up an application. For example, individual client side text files 213, functions parsed from JavaScript code, individual media files 212, or even entire applications themselves are all assets.

Nearby the application iFrame will be a button to flag the application as inappropriate 316. Clicking this button 316 will expose an interface in which the user is asked to categorize why the content is inappropriate from a list of choices that mirror our framework's content policy. These may include items like “sexual content”, “hate speech”, “spam” or anything that is against the policies of our framework that are designed to stay compliant with various laws and to keep our framework's content valuable to users. Once completed, the form may send a notice to our framework administrators or certain employees tasked with determining if the content is actually in violation and removing it from the site. There is also the option to crowd source moderation of flagged content by creating a page which allows responsible users of the site to review flagged content and vote to say if it is properly flagged. Once a majority of votes agree with the flagging, the content would then be removed automatically. One of the choices for why content was flagged that may be presented to users would be “Copyright Violation” which would then show a notice telling them to click the DMCA link at the bottom of the page. DMCA procedures will be covered in more detail later.

Near the top of the page there will be text displaying the username of the user if he is logged in 317. The username itself will be a link that leads to the user's dashboard or profile page. If the user is not logged in, this will be replaced by links saying “log in” and “sign up” which will expose a interfaces to log into a user account and register for a user account, respectively. As is common, each interface element will have a tool tip, text that is displayed when the user hovers the mouse or input device over that element that describes what it does in more detail. Some elements be able to be triggered by hotkeys instead of just clicks.

The layout of the elements in the page is mostly arbitrary. What's shown mimics expected user interface standards as established by YouTube and other sites. However, in an effort to differentiate our framework it may be advantageous to make the user interface more distinct. Various elements may be placed in different locations, or the flow of how elements are exposed may be changed. For example, the option to embed a web page 312 may be in the interface that is exposed when the share button 311 is clicked. The interface may also change depending on the device it is being rendered upon and there may be a separate layout for mobile devices of various types. It may also be the case that the layout is optimized so that it is relatively unchanged between desktop and mobile devices because it is designed to work well with both. Overall the user interface will be driven heavily by customer feedback and is likely to change dramatically over time and across different contexts.

### User Applications Embedded in Other Web Pages

FIG. 4 shows a web browser 406 displaying a personal blog web page 407. A game 401 and a weather widget 405, both created and hosted on our framework, are embedded within the blog page 407. The blog page is an example of the surrounding web page 217 for a published application web page 215. As has become standard with content like YouTube videos, both the game 401 and weather widget 405 could be embedded into the blog page 407 using an iFrame tag. For the game, the owner of the blog 407 would typically create a new post and paste in the iFrame tag provided by the embedding interface 312. The weather widget 405 would be embedded in the same way but most likely in the blog's 407 layout editor as it is not tied to a particular blog post, but rather lives outside the posts. The particulars of this blog example are somewhat immaterial to the fact that all web pages of any kind, the blog 407 being only one example, can contain other embedded web pages 126 as described in FIG. 1. In this case, those embedded web pages are the published application pages 215 for two user applications as mentioned in FIG. 2.

The published user application web page 215 may be supplemented by HTML, JavaScript and images that add interface elements in and around the application as published by the user. For example, when the mouse is held over the embedded game 401, there may appear previously hidden buttons representing an embed tool 402, and a sharing interface 403.

If end-user modification of user applications is supported, one of the buttons 404 would enable and encourage users to modify the game. When this button is clicked, the browser 406, would be navigated to a new page, perhaps in a new window or tab, showing the development interface web page 209 where the unpublished application web page 211 would contain a copy of the game 401. This modification process will be described in more detail later. The development interface web page could also be opened in an expanded iFrame with the blog page 407 itself. Other supplemental elements might include ads that are shown while the application is loading, or that appear based on set trigger events in the application such as between the levels of a game. The application loading time and trigger events could also be used to show helpful interface elements for encouraging end users to modify the application or to display related applications in a way that the user could navigate to our framework web page for that user application 301 by clicking.

Modern web browsers implement a same origin policy, http://en.wikipedia.org/wiki/Same_orgin_policy, that tries to ensure that there should be no security concerns for a web page that embeds another web page in an iFrame. This prevents JavaScript code in the published user application web page 215 from modifying the elements of the web page it is embedded within because the two web pages are not hosted under the same domain. This policy is also enforced when a user application 302 is embedded in our framework itself, provided the user application page is hosted on a different subdomain from the surrounding interface.

For example, if our framework web page for a user application 301 is hosted on modit.net, then the user application web page embedded inside an iFrame 302 could be hosted at userapps.modit.net and the same origin policy would prevent the user application from using JavaScript to modify the elements of our framework web page 301. For user applications that are embedded in other user applications, our framework could detect this nesting and ensure that the parent application in which the other application is embedded, is hosted on a different domain, such as userapps2.modit.net. The difference in domain would only have to exist at the parent/child level, as siblings are then protected from each other by their inability to communicate through their parent via JavaScript.

The fact that users can create arbitrary web applications that can be embedded in our framework's web pages and those of other web sites still means that those web applications could contain malicious content, even if it cannot affect the surround page. For example, the user application could contain a hyperlink meant to trick the user into thinking it will open a new window with a new email message. Instead it might point them to a page that looks like the login page for his webmail client, but is really designed to capture his username and password and send it to a malicious server that will then hack into his webmail account. Any site that contains user generated content that can involve hyperlinks faces this same concern and most do nothing about it aside from perhaps allowing users to flag malicious content. One option that could be implemented is to utilize Google's safe browsering API http://developers.google.com/safe-browsing which “enables applications to check URLs against Google's constantly updated lists of suspected phishing and malware pages”. Thus user applications could be scanned for URLs that have been determined to be malicious by Google and, if any such URLs are found, they could be removed or the application itself could be removed and punitive action could be taken against the user who created it.

Multiple user applications embedded in a web page, such as the game 401 and weather widget 405 may have some need to communicate with each other, just as our framework's web page for a user application 301 may want to communicate with the published user application web page 302. However, the browser's same origin policy prevents JavaScript from being executed between two embedded web pages or from an embedded web page to the surrounding page unless they are all hosted on the same domain and use the same ports and protocols. Still, communication is possible using the HTML5 standard's postMessage API, https://developer.mozilla.org/en/DOM/window.postMessage, which allows web pages and embedded web pages to post messages to each other and thus communicate. Anything that an embedded web page might want to do to the surrounding web page using JavaScript could then be implemented by the surrounding web page and triggered in reaction to a postMessage call from the embedded web page. In this way the same origin policy still protects web pages from malicious JavaScript from other domains, but allows embedded pages from those other domains to interact with any postMessage based API that the surrounding page, or other embedded web pages, wish to expose and implement.

For example, there are ways to place the content of web pages within other web pages without using an iFrame. These should be considered alternatives to and within the same concept as embedding web pages using iFrames, such as with the game 401, weather widget 405, user application in our framework's web page 302, the published 215 and unpublished 211 application pages in FIG. 2, and the embedded web pages 126 in the generic web application 150. There exist projects such as Google Caja http://code.google.com/p/google-caja/ which is an open-source project that processes JavaScript in such a way that it can be safely put inline into a web page's source code, not inside an iFrame, so that the normal security concerns do not arise. This also allows for many of such embedded objects to exist inline and share JavaScript objects with each other. Most of the reasons for using something like Caja are tied to older browsers and iFrames will likely be sufficient and a more simple choice. It is also possible to embed the content of a page using the HTML object tag as detailed in this post: http://stackoverflow.com/questions/924946/use-of-iFrame-or-object-tag-to-embed-web-pages-in-another. As the answers to this post describe, it may be better to just use an iFrame as it is designed to have the embedded web page behave as if it is the top-level page in a browser and embedding a page with the object tag is more of an abuse of the purpose of that tag.

### Editing Client Side JavaScript

FIG. 5 shows our framework's interface 501 for creating and editing client side text files 213. This is a more detailed view of the development interface web page 209 in a state which is focused on editing client-side code, such as JavaScript, as opposed to other elements of the user application including, for example, media. First we'll focus on the generalities of the interface and then on the editing of client side code.

The user interface example shown in FIG. 5 follows a standard desktop paradigm where, within the page there can be many smaller subwindows 519. These subwindow are equipped with the standard controls that accompany such objects in desktop applications as a title bar at the top that allows the subwindow to be dragged 504, buttons to close, minimize, or maximize the subwindow 502, scroll bars to pan over the content of the subwindow if it cannot all be seen at once 506, and a draggable grip that can be used to resize the subwindow 503. As is standard with such subwindows, clicking them gives input focus and pulls them on top of any surrounding subwindows they may overlap with.

Following the paradigm of integrated development environment (IDE) applications such as Microsoft Visual Studio and graphics applications such as Adobe's Photoshop, Illustrator, and Flash, these subwindows can also be docked with other subwindows by dragging the title bar 504 of one subwindow onto the top bar of another subwindow. When docked, the subwindows will stack themselves vertically 507 or horizontally and collapsing one subwindow will make more space for other uncollapsed subwindows. Dragging the bottom or top edges (or left and right edges for horizontal docking) can change the size of a specific subwindow that's part of a docked group. Subwindows can be undocked by dragging their title bar 504 away from the docked group, at which point they are free floating again.

As is standard in desktop applications, a right-click from the mouse, or a click combined with a modifier key such as the alt or ctrl keys can bring up a context menu that contains a clickable list of actions that can be performed with or on the clicked interface element. For example, the context menu for the title bar 504 of a subwindow might give the user a list of choices such as “undock”, “close”, “minimize”, “maximise”.

The interface elements are easily created using HTML and JavaScript and many libraries exist that provide simple user interface elements for web applications that mimic desktop application paradigms such as qooxdoo http://qooxdoo.org/, Yahoo's YUI http://yuilibrary.com/, Sencha's Ext JS http://www.sencha.com/products/exjs/, or jQuery UI http://jqueryui.com/. Generally the subwindows themselves can be div elements which have built in scrolling capabilities. By registering functions to listen for various mouse events on the elements inside the div, one can, for instance, cause a left mouse down click on the title bar element 504 to then call a function that makes the entire subwindow change its position when the onmousemove event fires, until such a time that the left mouse button is released.

It is also possible that the subwindows could be implemented as new browser windows which would then automatically have a title bar 504, scroll bars 506 and closing 502 and resizing 503 controls. This would likely be viewed by users as less than ideal because each browser window is then at the same level as other open applications and this would be more confusing than having all of the interface within one top-level window. It also might not work at all outside of desktop environments. If the user is on a desktop environment that supports such windows, there may be another button added to the resizing and closing controls 502 on each subwindow that would turn that subwindow into a top level window as this might be desirable for certain larger interfaces or users with multiple monitors.

While this user interface paradigm is intuitive for desktop applications because it is widely used and mimics the way various application windows work within desktop operating systems such as Microsoft Windows 7, Mac OSX, and many of the popular window managers available for Linux, it may not be ideal for mobile and touchscreen-based devices. Several design considerations must be made to create a similarly intuitive user experience on such machines.

First, screen size and display space become significant design limitations. Mobile devices not only limit screen real estate explicitly due to their smaller size, but also force the use of larger UI controls since the precision offered by a mouse in a desktop application is not achievable with fingers on a touch screen. The ability to zoom in can mitigate this but is hardly user friendly and thus smaller interface elements such as the subwindow controls 504, 502, and 503 become tedious to use with a touch screen. To further complicate layout considerations, screen sizes can vary nearly an order of magnitude from the smallest smartphone to the largest tablet, and most devices can be oriented in both landscape and portrait modes with a wide range of aspect ratios.

Finally, UI elements such as context menus that are specific to a mouse or mouse and keyboard combination must be rethought for a touchscreen interface.

To address these issues, responsive design techniques are used to analyze the viewing environment and adapt the interface accordingly. These adaptations are built into the desktop application such that the same HTML, CSS, and Javascript is presented to all devices, or alternatively, a separate mobile site could be served to HTTP requests originating from a predefined list of mobile devices, as gathered from the header of the request. In the latter case, many of the responsive design techniques would still be employed to make less drastic adaptations corresponding to the differences between various mobile devices.

Screen size issues are largely handled by a combination of CSS techniques. A flexible grid of HTML elements can be specified by using relative units in the CSS stylesheets. This includes specifying the width, height, top, left, bottom, right, margin, padding, and border properties in either ‘%’ or ‘em’ units or setting them to ‘auto’. The use of relative units rather than specific values allows the layout of an application to adapt to fit various screen sizes. After choosing some reference size for an element or the window, all other proportions can be computed using the simple formula: target % context=result, where target is the desired size relative to the reference size, context is the size of the element's containing element relative to the reference size, “%” is the modulus operator, and result is the resulting value to be entered into the CSS stylesheet. The CSS min-width, max-width, min-height and max-height properties are specified in absolute units such as pixels to set bounds on the sizes of elements, a technique particularly useful with various combinations of the overflow property. CSS media queries are used to set more drastic conditional CSS rule changes depending on the client's viewing media and the size of the viewing region. Alternatively, Javascript or a combination of CSS media queries and Javascript can be used to determine the size of the screen and the type of input supported, and to make layout and event listener adjustments accordingly.

Additionally, mobile-first design principles can be used to remove unnecessary chrome from the interface, replace smaller UI elements with large, context-specific controls, and ensure all user inputs have analogous touchscreen mechanisms. The subwindow headers 504 and subwindow controls 502 are removed from the subwindows, and the controls 502 are made larger and placed in the context menu for each window. In lieu of a header, a touch and drag anywhere on an out of focus subwindow moves it to a new location. For easier alignment and thus more efficient space management, the dragging of subwindows 519 could snap to positions on a grid. Instead of a right mouse click, the context menu for a subwindow is accessed by the first touch with no drag, or alternatively, a touch and slight hold. A larger resize grip 503 appears when a subwindow is in context for dragging. Resize operations could also snap the subwindow's bounds to positions on a grid for easier alignment with other subwindows, again ensuring less wasted space and removing the tedium of finely tuning the subwindow size with touch controls. To access the contents of the subwindow, focus is given with an additional touch or an initial double touch. Giving focus to a text editor subwindow on a device without a physical keyboard dispalays the device's digital touchscreen keyboard for input.

One useful library for creating interfaces is backbone.js http://backbonejs.org/. This library allows for the automation of the updating of the view component of the MVC paradigm, http://en.wikipedia.org/wiki/Model%E2%80%93view%E2%80%93controller, based on changes to the model. It removes much of the boilerplate code that updates the view every time something is changed by wrapping the model in functions that alert the view to update when the model is changed.

The interface can include a “file” button 508 that, when clicked, will open an interface by which the user can perform the standard file actions such as save, save as, create a new blank application, or close the interface. This menu will also allow the user to publish her application publicly or privately to some set of individuals as described later.

There can also be a “moddables” button 509 that will open a panel containing the various categories of application elements that can be modified, such as functions, constants, images, sounds, video, modules and the full source code. When one of the elements in the list of categories is clicked, the subwindow for that element category will be opened 521, perhaps into a dock with the other subwindows of its type 510. As with the other subwindows, the elements of this dock can be dragged out of the dock and left free floating or docked again elsewhere as shown with the constants moddables subwindow 511. The moddable category lists can be organized in various ways. For example, the list of functions 521 can be categorized by module, or into arbitrary categories that the developer establishes by tagging each function with some interface in the function editor windows 518 519 that then stores those tags as metadata in the database. For example, it may be more useful to look at all functions tagged as “critical” than to see which functions are associated with the “Controller” module. This tagging could also be made more simple and just allow a developer to tag some moddable elements in a category as “featured” and then each moddable category list window, like for functions 521, would have a button to toggle showing all functions, or just the featured functions.

A “controls” button 512 will, when clicked, open an interface 513 that allows the user to undo or redo her last action, preview the application with her current changes in a subwindow 514 or control certain aspects of the application state, such as pausing or resuming the application. Undo and redo are implemented by maintaining a stack with copies of the previous state of all moddable elements and then walking back and forward through that stack as is the standard undo/redo behavior for applications. It may also be advantageous to display this undo/redo stack as a list of text items describing each change that can then be clicked to go to the state just before or after that change was made. Clicking the preview button will commit all changes made to the moddable elements to the unpublished application and display embed it in an iFrame in the preview subwindow 514, opening the subwindow if it is not already open.

The controls subwindow will display certain application state controls if the application supports them. For example, the controls panel could send a specific message to the unpublished application using postMessage that began with text like “WI_PAUSE”. If the application supported this API and had pause functionality, it would respond with its message confirming that the pause button would be displayed and, when clicked, would send a message that would cause the application to implement its pause functionality.

Another useful state action could be called “WI_SAVE_STATE”. With this action the application would respond with text that encoded the state of the application in such a way that when that text was returned, the state could be loaded and the application would return to the exact saved state. For example, a developer might want to play the “Asteroid Shooter” game until the player's score 529, number of lives 530, ship 526, bullets 527 and an enemy asteroid 528 are all in a certain state. The developer could then make a modification, and have the game return to that same state rather than the state the game defaults to when initially loaded. If an application implements saving and loading state, this could be the default action when the preview is updated—that the state is saved, the preview is updated, and the state is loaded, returning the visual game elements 526 527 528 529 530, and perhaps other less visually obvious elements to the same state as they were before the modification. Then a separate “reset state” button might be presented to start the application from the beginning. It may also be advantageous to allow users to edit the text that makes up the saved states, which would be formatted by the application creator, but likely would be in JSON format, so that the application could be easily be put into states that are difficult to reach or rare during normal use. The saving and loading of state could be facilitated by seeding our framework with example applications that conform to the Model-view-controller, http://en.wikipedia.org/wiki/Model%E2%80%93view%E2%80%93controller, paradigm in that elements that make up the state of the application would be all part of some module, or have functions applied to them such as “WI.addToModel(ship)” that would place the data for the state in a single programmatic location where it could be easily serialized.

The “account” button 515 will open an interface, subwindow, or a new web page in another window or tab, that allows the user to manage her account and social connections as described later. The “home” button 516 will take the user to the front page of our framework. When the user is about to be navigated away from the application development interface and changes have been made that are not saved, the interface will prompt the user to confirm that they want to lose those changes by using the window.onbeforeunload event.

A minimal interface for a developer to modify the client-side text files 214 of an application is a text editor which exposes those text files 517. The source files for an application may be in a single text file, or several that refer to each other as described in 112. If they are in separate files, a “files” moddable category can exist listing the files that can then be clicked and opened in a text editor subwindow 517. Client side text files that reference other files also operate equivalently when those references are replaced with the contents of those files. For instance, a script tag referencing some JavaScript file by its src attribute can be replaced by the text of that JavaScript file placed between the opening and closing script tag with no src attribute. In this way it is also possible to provide a full source view that merges the separate files into a single file with the same functionality. Users may also desire the option to have the separate files show those references but have the option to expand those references by clicking the file URL so that the content of that file would then replace the reference as previously described, but only for that reference and only on user action. Alternatively, clicking those reference URLs, or choosing an item from a context menu attached to those reference URLs, could open those files in a separate editor subwindow.

The text editor subwindow could be placed into an HTML textarea tag which allows for the editing of multi-line text. However, it could be advantageous to provide a richer interface with some of the common code editing features that software developers have come to rely upon. CodeMirror, http://codemirror.net/, is an open source, open licensed JavaScript-based text editor that comes with many of these features, such as syntax-highlighting, line numbers, find and replace, and auto-complete, either built in or through extensions created by users. An instance of the codemirror editor can be created inside any HTML element or it can augment a textarea element to become a codemirror instance. The codemirror instance then exposes events that can be listened to by JavaScript code in order to react to the fact that the text inside was edited and in what way it was edited. There exist other similar libraries such as the Ace editor, http://ace.ajax.org/. There also exist recent adaptations of codemirror such as CodeMirror2, https://github.com/adobe/CodeMirror2, that allow for inline codemirrors to be placed inside other codemirrors. This would allow for interesting interfaces that, for example, allow a function call somewhere in the code to be clicked to open that function for editing inline rather than in another editor subwindow.

When the code in the editor 517 is changed, those changes, either to some file that is the entire text of the application, or one of many files that make up the client-side text files 213, can then be saved to the server side for developer applications 207 as part of the unpublished application that can then be loaded into the preview subwindow 514.

There will exist other views of the client side text files 213 of an application other than at the file or full source level such as editors that only show the text of a single JavaScript function 518, 519. These, and the full source or file editors 517, will all parse their contents from a centralized client source model that will contain the entire text in the form that is saved to the server side for developer applications 207. The editors are then showing their state, which can be applied to change the central client source model in a number of ways.

Users may find it convenient to only update the central client source model when an “apply” button 520 is clicked. In this case, updating the preview using the controls interface 513 may automatically apply all changes in any open editors, or may overwrite those changes, or warn the user that they will be overwritten if they are not applied. Users also might find it better to have the central client source model update at a regular interval, say 50 milliseconds. In the case that it is computationally intensive to update the central source model, the updating could be throttled to take place whenever any change is made to any editor so long as no update has been made in the last interval. Then pending updates would occur after the interval had passed, or in the case that some change was made after the interval had passed. This same throttling could be applied to the editor subwindows updating based on changes to the client source model, such as the function editor window 519 adapting to changes to that function made in another editor, or the functions list 521 adapting to the addition of a new function in some editor subwindow.

There exist various open source JavaScript parsers that are themselves written in JavaScript and thus able to be used as part of the client-side code editing interface 501. JSHint, http://www.jshint.com/, is a tool designed to give advice on JavaScript code quality. In order to accomplish this it contains a pratt parser parser http://en.wikipedia.org/wiki/Pratt_parser that exposes the starting and ending lines and characters of all functions in the JavaScript which it is given as input. There are other open source JavaScript parsers written in JavaScript that produce a full Abstract Syntax Tree, http://en.wikipedia.org/wiki/Abstact_syntax_tax, such as esprima http://code.google.com/p/esprima/ and ZeParser, https://github.com/qfox/ZeParser. The abstract syntax tree can provide a more precise segregation of the JavaScript source into components that can be exposed individually.

When the central client source model is updated, the various views of the client side text files for the application 213 must also be updated. This involves parsing the text of the central client source model to pull out, for example, a list of all JavaScript functions 521 in such a way that the starting and ending lines and characters of the functions in the client source model are known. This way, when one of them is clicked, the text of that function is opened in its subwindow 518, 519. Furthermore, when they are edited in the subwindow 519, just as in the full source window 517, it is known what part of the client source model should be replaced with their content. Knowing the start and end lines and characters of the function also allows the function editing subwindows 518, 519 to be updated when some other view updates the central client source model as that model can then be reparsed and the text of the functions that are found within it will replace those same functions that are open in the editors 518, 519.

If some change to any editor window affects its contents in such a way that when those changes are pushed to the central client source model, that central source model is in a state that is not parsable, i.e., that is not proper JavaScript syntax, then other windows that populate their content by parsing the central source model will not attempt to repopulate their content. However, to the extent that an editor window has previously determined the start line and start character and end line and end character of some moddable, it can still update its display of that moddable without reparsing the source, by inserting any text that was added between that moddable's start and end points, in the appropriate location, or deleting any text that was deleted between its start and end points.

If some change to any editor window affects its contents in such a way that they can no longer be parsed from the client source model and the client source model is proper JavaScript, then the editor window could replace its contents with an error notice telling the user what has occurred and return to a proper editor state if some other change returns the element that was being edited. For instance, a function that is open in some function editor 519 could be deleted entirely in the full source editor 517, and the function editor would display a notice to the user about this.

The function editor subwindows 518, 519 provide a way for developers to alter the source code of an application at a conceptual level that is separate from the code on the whole or how it is split into files. This is useful because the developer often can change a function without understanding the impact of the change on the rest of the code and thus would like to focus on the code at the conceptual level. When the content of a function is parsed from the client source model a regular expression can be used to parse the declaration of the function to put in the window's title bar 504 so as to identify the function being edited for organizational purposes, especially when the window is minimized. The top title bar 504 can also contain an arrow that would open a drop-down with a list of all parsed functions, like 512, so that which function that window is editing can be changed.

Another view in which editor windows can operate is at the module level. Modules are used in JavaScript to provide object-oriented functionality. Since JavaScript is not an object-oriented language per se, there exist several ways to define a JavaScript module such that it can behave like a class that can be instantiated and has other object-oriented properties like the ability to inherit from other classes. This post details some of the various approaches, ending in the revealing module pattern: http://www.klauskomenda.com/code/JaveScript-programming-patterns/#module. Another option is the self-executing-anonymous-function pattern as detailed in this post: http://enterprisejquery.com/2010/10/how-good-c-habits-can-encourage-bad-JavaScript-habits-part-1/. These patterns enclose the code for a module within a block delimited either by parentheses or curly brackets. Thus that code can be parsed and displayed as a single unit along within an editor subwindow easily using a JavaScript parser and regular expressions. One can also define modules such that all of the module code is not contained in containing blocks, but rather there is a definition for the class and then separate function blocks that define functions on that module's prototype attribute. In this case the module editor window would pull in the constructor and separate function definitions on the prototype into one window. It may be advantageous when doing this to alter the central source model and overall source view to put these functions in one continuous set of lines of code to avoid complications with displaying them in that way but having to track where inserted lines actually go in the code. There may be other ways to define modules but the JavaScript parsers, by nature, give a complete view of the code structure such that any convention that users decide is common should be able to be parsed and supported.

Another moddable unit of JavaScript code that could be edited independently is the constant. In some languages it is possible to declare a variable as constant in a way that at compile or run time it is enforced that the value of that variable cannot be changed. JavaScript does not have such capabilities, but it is still considered a best practice when writing code to pull out so-called “magic numbers” into constants. Any time a specific value is assigned to a variable in code in any language it is considered desirable to define a constant alongside many other constants and then assign the value of that constant to the variable. This makes it easier to find one place in the code to adjust arbitrary values and by that adjustment to change the behavior of the code. It also encourages the developer to reuse these constants where appropriate which means all variables set to that value can have their value changed by making one edit instead of many. In JavaScript the convention is to write the names of these constant variables in all caps with underscores between words, such as “TIME_UNTIL_REFRESH”. Variable declarations of this type can then easily be parsed from JavaScript source code using regular expressions and be populated in a list 511.

The list of moddable constants 511 will display the code for the constants that were parsed out due to being formatted in all caps and underscores. Some constants may just be in a code editor as used for the function editing windows 518, 519, but often our framework will be able to present the users with an interface that will be more intuitive and foolproof for someone who is unfamiliar with JavaScript syntax. In general, these interfaces would leverage traditional form controls found in desktop and web applications as those should be familiar to many users. For a numeric variable, this interface might be a slider with text fields to define the values of the end points of the slider 522. For a hexadecimal color string, this would be a text field where only the color string itself can be edited, and when that field is clicked, a standard rbga color picker is opened 523. For an array of strings this might be an editable text field for each string in the array, as well as a way to delete and add new items 524. A general paradigm of showing the content of the source code, and how it is being altered, but not forcing the user to understand the syntax to alter it, is an elegant way to empower users unfamiliar with syntax to be able to alter that code while still learning the syntax by immersion. In these form-based constant editing controls, there would be a button or context menu to edit the raw text of the constant declaration or to change the name of the constant.

In general, any unit of text can be a moddable element that could be exposed for editing. All that is needed is a function that can extract that unit of text, or set of disjoint units of text, and some interface that allows the developer to make changes to that unit of text that are then reflected in the client source model. The interface for these changes can be a text editor or form controls or some other kind of interface, so long as the interface converts user input to changes in the text that obey the syntax rules for that type of text, be it code or markup or something else. For instance, our framework may expose tools that allow a user to edit HTML elements in her application with wysiwyg controls, as found in a myriad of web page design progams such as Adobe Dreamweaver. These might include something as simple as being able to resize the HTML elements by dragging their corners, which would then alter the attributes of that HTML tag, or the CSS definition that defines the style for that tag. The open-source project mercury, https://github.com/jejacks0n/mercury, could be used for this purpose. As another example, a web application that is some type of game may define each level with arrays of integers that determine the position of, say, enemies and coins in a grid. If this variety of game became popular, our framework could provide an interface that would allow users to drag the images of coins and enemies onto a visual grid that would then alter the text-based array to match those positions.

As described, to see a change in the preview window 514 based on a code edit, that preview window would have to be reloaded with the updated text from the client source model. Even if the application supports saving its state and reloading it after a change is made, this saving and reloading might be less fluid of an editing process than is ideal. For certain variables and functions, however, changes could be made in real time and witnessed in the preview window 514 immediately.

For example, say a game (We sometimes use the word game to refer to a web application in the form of a game. We use the term game broadly to include, for example, any application that one or more users may consider to be a game in terms of their use of that application which may include artistic, competitive or amusement purposes.) has some main character, who is represented by some variable defined like “var hero=new Character( )” that is being redrawn by some function hero.redraw that is constantly called in loop at a regular time interval. If code that is external to the game called “Character.SIZE=100;” this would immediately be reflected by the call to the redraw function on the next interval if it referenced that constant. In general, variables, objects and their attributes, and functions can be assigned new values that will be reflected as soon as the application in question calls a function that uses those values. In this case, the modification tools would not be updating the text of the client source model and reloading the preview, but rather altering the JavaScript objects and functions in memory. This may be done by a postMessage api that allows one-way communication where our framework interface 501 could send a string to be executed by the application as JavaScript using the eval command. This api could be inserted into all preview windows. Editor windows such as those for functions 518, 519 or the full source 517, or constants 522, 523, 524 could then have an interface element that allowed them to be put into “real-time mode”. Since not all moddable elements in an application would work properly in this way, the application developer could tag specific moddable elements as “real-time” and only those moddable elements would display the option to use real-time mode.

Of course, the developers would be motivated to make more and more moddable elements function in this way in order to get the benefit of real-time feedback to their changes. This would especially be the case if end user modification of applications is allowed as that kind of structure would inspire more modification of the developer's application. The real-time modification may be structured such that it only affects the preview subwindow 514 and not the client source model until some interface element is interacted with, such as the apply button 520. At this point, the normal client source model modification would be made and would be accompanied by a refresh of the preview 514.

If end-users are allowed to modify the interface of the application editor 501 then it is somewhat risky to allow them to send code to be evaluated by the preview subwindow 514 as arbitrary code could be passed. Note, however, that this code could only affect the preview window itself 514 and not the client source model. Furthermore, rather than code to be evaluated, the passed instructions could list a function to call, or attribute to alter, and what to pass the function or do to the attribute. Then our framework could analyze the client source model to ensure that those alterations are not changing anything apart from the application code, such as code inserted by our framework interface into the preview subwindow 514 or the core JavaScript language functions.

The parsing of the abstract syntax tree also allows for some limited support of the refactoring functionality found in many integrated development environments. For many languages these environments provide tools to rename a function not only in its declaration, but also in all places where it is called, so that one edit can be made that will change how the function is named but not change the functionality of the code.

Another similar functionality is finding all references of a function—developers see the declaration of a function, or a function call, and can request a list of all calls to the function and its declaration. Finding all references provides valuable context as to how the function is used that might be more informative than the function's name or comments. Unfortunately JavaScript does not allow static parsing to provide these refactoring tools in an ideal form. Because of a lack of type safety, if two modules or classes have functions with the same name, there is no way to be sure which module's function is being called elsewhere in the code because nothing about the language enforces variables to be instances of a particular module for their entire lifetime. Modified versions of these tools could be provided and would be of value, the main difference in the modified versions being that they would require some feedback from the user in order to remove any ambiguity as to which module's function is being renamed. Often this feedback could be skipped as the user would know that his reason for changing the name of a function on a certain module should also apply to any other function with that name on other modules. It could also be detected that only one module declares a function of that particular name, in which case the tool would operate as expected in other type-safe languages. These refactoring tools can also be applied to module names and attributes.

The ability to find all references, however limited, could be used to create companion windows that accompany the function editor windows 518, 519 which would show up when the function editor window was in focus and display the lines on which that function is called, and perhaps any functions that it calls. This would be advantageous because it would provide a constant context for each function that would enrich the user's understanding of how that function fits into the code as a whole. If end user modification of applications is supported, this could greatly increase the rate at which a user could understand an application they have just begun editing and thus the rate at which they could leverage that understanding to make more powerful and interesting modifications to the application.

The moddable functions window 521 can contain a button to add a new function 525. When clicked, this will present the user with an interface that allows her to choose one of the existing functions to mimic, and then to name the new function. When the user confirms these settings, our framework will add the code for a new function with the given name just above the existing function in the client source model and open that function in an editor window 519. Thus the user is able to create a new function with whatever name she chose that will be in the same scope as some existing function without understanding the structure of the full source code. The user needs to understand that, at the level of a function, she wants a new function that operates in a similar way to an existing one without unnecessarily thinking about the overall architecture of the application. The code inside the selected function may remain or may be deleted. It may be better to keep that code as it is easy for the user to delete it and they will often want the new function to operate similarly to the selected function. A button to add a new constant or module based on an existing constant or module will operate in the same way and be part of the respective moddable subwindows for modules and constants.

The layouts, the positions and states of the various windows in the editing interface 501, would be constantly stored in the user application metadata so that when a user closes an editing session and then returns to edit that application again, the interface will have the same windows editing the same content as when they left. If end user modification of applications is supported, then when an application is cloned and opened for editing by another user, the editing interface 501 could be situated in the same layout as the original developers. Alternatively, the original developer could also define and save in metadata a specific layout that he feels would be idea for another user wanting to modify the application. This might have certain moddable elements opened for editing already that the developer feels are the most interesting, powerful, or fun to change. The developer could even define several different layouts that would be presented to any user later modifying the application along with descriptive names so that the later user could select the layout that the original developer felt was most ideal for the type of modification the later user wants to make.

Our framework will strive to support as many common integrated development environment features as possible to the code editor interface in order to foster use among existing developers who should be able to provide the most high quality and enriching content to our framework. It will also strive to have the code editor interface be as customizable as possible. However, since some existing developers may be set in their ways and too comfortable in their existing editing environment for anything else to ever compare, it may be advantageous to provide an interface by which developers can use their preferred editor to edit the code of an application. This could be a web service that allows authenticated users to pull client side text files 213 from the server side for developer applications 207 for editing and then to send those edits back to be saved on the server side 207. Many IDEs already have features, either built-in, or via a plug-in, that operate in this manner with version control systems. Once the web services are set up, the user's account page could provide access to a public and private key pair that could be used for authentication with the web service to limit access just as is done with the user's browser session when signed in. Then our framework could offer plug-ins for popular IDEs or crowdsource the development of such middleware to the developers who are interested in it. The important thing is that our framework could open access to the code in a way that it could be requested, edited, and updated.

### Capturing, Editing, and Creating Images

A major component of many applications, especially games, is images, which are stored on our framework as part of the media files for applications 212. We use the term images broadly to include, for example, any file that depicts or records a visual perception or any visual representation of that file, for example, a two-dimensional static photo or drawing or any file of one of the image formats supported by web standards. Videos and video files are visual but change with time, although some image file formats, such as GIF http://en.wikipedia.org/wiki/Graphics_Interchange_Format, support animations. Images can be imported into our framework from a user's file system 129 backed by a hard disk or solid-state drive, or fetched from a URL where the image is already hosted on some web server, or captured from a hardware device 128, like a camera, attached to her computing system. The HTML5 standard has APIs for accessing devices such as cameras on desktop and mobile devices but not all browsers, desktop or mobile devices, currently support them. If a browser does not support image capture or access to the disk, this gap can be bridged by non-web-standards compliant techniques such as using Adobe Flash in the browser, or a native application wrapper for mobile devices. It may even be advantageous to have a lightweight mobile app that is designed to capture media, like images, audio, and video and place that media in a user's library for later use on our framework.

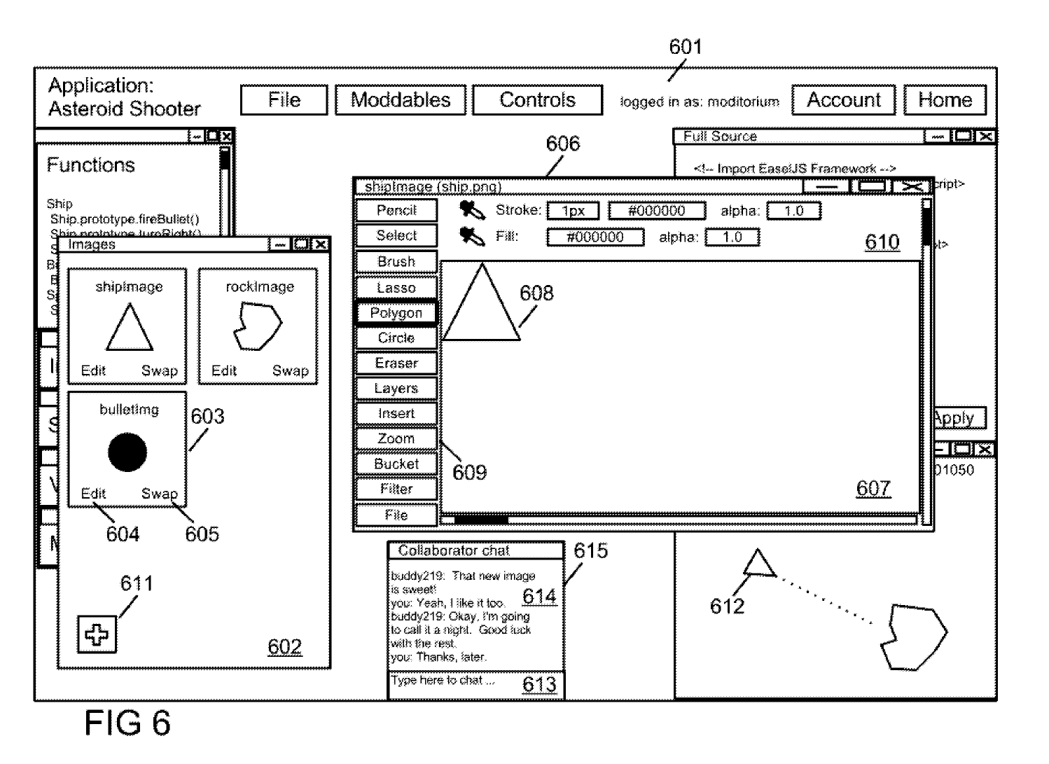

FIG. 6 shows a more detailed view of the development interface web page 209 in a state which is focused on editing images 601. Our framework will parse the client side text files 213 for references to images, either with inline content represented by data URLs 111, or as references to external URLs 112. These are easily parsed using regular expressions that look for the data URL format, HTML image tags, and image file names with extensions denoting that they are in one of the file formats supported by web standards. These images will then be listed in the images moddables window 602 shown undocked in FIG. 6, and previously in FIG. 5 as one of the docked and collapsed moddables windows 510. Each image will be represented by a interface 603 that features a thumbnail of the image in question, supplemental information, and controls to edit the image 604, or swap it for another image 605. The supplemental information may include items such as the image filename or the image dimensions in pixels. The image thumbnail will be saved as a separate file that is resized by the server side for user applications 207 using standard libraries, stored with the media files for applications 212, and linked to the full sized image by metadata in the data store 220.

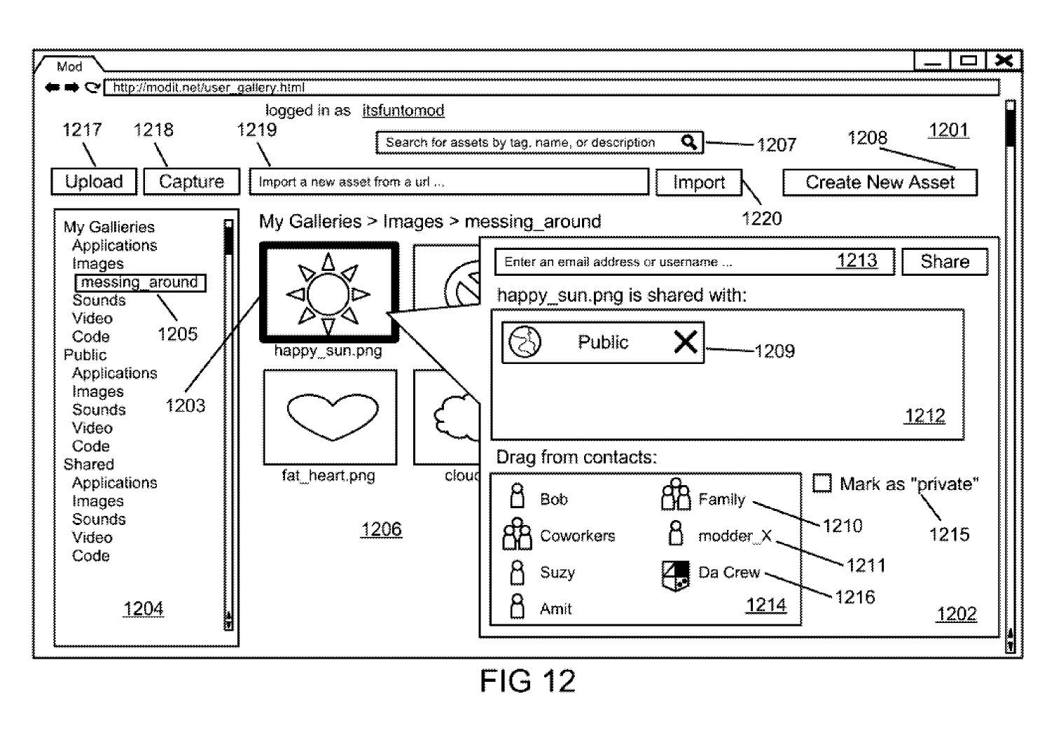

When the swap control 605 is clicked, an interface is opened that is part of the interface shown in FIG. 12, excluding the sharing interface 1202 which would not be initially shown. Using this interface the user can upload 1217 an image from her file system, capture 1218 a new image from a device, import 1220 an image from a URL 1219, or select an image from a gallery 1206 of thumbnails 1203. When any of these actions is performed, the client source model is altered so that references to the URL of the swapped image are replaced by the URL of the new image which is stored as one of the media files for applications 212 on the server side for developer applications 207.

The gallery of image thumbnails 1206 is a grid of image thumbnails with an interface to navigate between various categories 1204 for which our framework has a library of images that can be used, such as “animals”, “weapons”, or “faces”. These categories can mirror the tags on the image assets that are used for searching and recommendation. One of the categories will contain all images uploaded or edited by the user, which can be organized into folders to prevent clutter. Images uploaded by other users that are public or shared with the user will also be shown, categorized by their tags and prioritized by ratings. The gallery 1206 can be searched 1207 as previously described based on the tags and descriptions of the image assets that are public or have been shared with the user.

The images could also all be grouped into a tree structure of folders and browsed with the standard interfaces used in file dialogs. These folders could create a hierarchy such as “claymores” under “swords” under “weapons”. It may be more desirable to display related tags when any one tag is being browsed. Then if many of the assets tagged with “weapon” are also tagged with “sword”, then when viewing assets tagged with “weapon”, the “sword” tag would be shown as a link that, when clicked, searched for assets tagged with “sword”. It might also be desirable to show related assets as examples of related tags, or to use a recommendation engine to present the tags, and perhaps their assets, that users end up clicking when they initially search for some text string.

When the edit control 604 is clicked, the image will be opened in an image editor subwindow 606 which will be discussed in detail shortly. Our framework contains full-featured image editing functionality based primarily on web standards. This is a powerful feature as it means that a user wanting to make a casual change to an application by altering an image need not already own, or search for, download and install, some other image editing software. Furthermore, they do not need to download the images to their local machine to edit them, and then upload those images back to our framework to see the results of their edits in the preview window 514. The ability to edit and create something as fundamental to applications as images creates a very low barrier to entry for almost anyone to alter the visual aspects of an application. This is especially the case if end user modification of applications is supported since the context of an existing application can be fundamentally changed by altering its visual aspect without knowing anything about how the logic and code of the application work.

The HTML5 standard supports a variety of image file formats, but conversion is possible between all of them with standard open source libraries. Thus they can all be considered to be in a format that specifies a two dimensional array of pixels within the rgba color space http://en.wikipedia.org/wiki/RGBA_color_space which breaks colors into their red, green, and blue components and a level of alpha (transparency). The HTML5 standard defines a canvas element that allows for dynamic display of rgba bitmaps and defines functions for drawing two-dimensional shapes and for writing to and reading from the individual rgba pixels that are being displayed. The canvas element is one of the most fundamental leaps forward for the HTML standard as it allows graphics in web applications to be drawn and rendered in effectively the same manner as they have been for decades in desktop applications.

Since the canvas can have the pixels it displays altered by JavaScript code, and those pixels can also be read by JavaScript code, and the canvas element's context2d API provides standard drawing tools for paths and basic shapes, creating an image editor based on the canvas element and JavaScript is not very different from the creation of the myriad image editors that are based on other languages and graphics libraries. The common tools seen across these applications can be created using essentially the same techniques that were used to create basic applications like Microsoft Paint, commercial photo editing suites like Adobe's Photoshop, or drawing tools like Adobe Illustrator, or open source image editors like The Gimp. The tools in these pieces of software share common paradigms that are mimicked in many other similar pieces of software and it is not necessary to spend much time describing those features nor does their implementation using JavaScript and the canvas element need to be fundamentally different. The image editor subwindow 606 features an editing stage 607 that is backed by one or more canvas elements. On this stage the image to be 608 edited is placed in the upper-left hand corner. On the left hand side there is a toolbar that, when clicked, selects a tool or opens an interface for performing some function on the image. Above the stage 607 there is a properties bar 610 that shows the editable properties of the currently selected tool.

Many of the toolbar buttons 609, when clicked, select a new tool and thus alter what happens when mouse events are detected on the stage 607. For example, the polygon tool button is highlighted, showing that it is the active tool. If a mouse click is detected on the stage 607, that will begin the drawing of one side of the polygon, with each subsequent click becoming the next corner of the polygon until a double click is used to close the polygon. The polygon itself could be a bitmap object, in which case there is no information stored about it save the pixels that represent it on the canvas. It could also be a vector object, in which case our framework stores the geometric information needed to draw the object, such as the coordinates of its corners, the thickness of its lines, the rgba line color and rgba fill color.

A helpful library for drawing on the canvas and grouping and transforming drawn objects is Ease1JS http://www.createjs.com/#!/Ease1JS. It has useful classes that can be used to wrap around pixel data and test for mouse clicks on the object, scale and rotate the object, group it with other objects in a parent-child hierarchy to which linear transformations can be performed, and many other things that come in handy when writing an image editor. Bitmap objects may be kept on separate canvas elements so that they can be dragged by the mouse more easily, while vector objects are already stored as separate logical entities and can be drawn in a certain order. The front-to-back order of the elements can be changed with a context menu from a right-click, or a hotkey, as is standard.

The properties bar 610 can also be used to change the properties of a selected object. If the select tool were selected from the toolbar 609, and then a vector polygon were selected with the mouse by clicking somewhere on it, the properties of that polygon would populate the properties bar 610 and, for example, changing the fill color in the properties bar 610 would alter the fill color of the polygon after it had been drawn.

Some of the tools that could be included in the toolbar 609 include: A brush tool with a customizable radius and color that paints bitmap pixels when dragged; a pencil tool that draws vector or bitmap freehand lines when dragged; a select tool that allows objects to be clicked or selected as part of a region and then dragged about the stage 607 or scaled or rotated via the standard handles; a lasso tool that allows regions of the stage 607 to be selected as a rectangle, freehand shape, or polygon and then cut or cropped; a tool for drawing bitmap or vector polygons; a tool for drawing bitmap or vector circles; an eraser that, when dragged, erases bitmap pixels in a custom-sized square area or the nodes of a vector object in that area; a layers button that opens an interface for ordering, creating and deleting new layers that can be interacted with individually; a tool for inserting new images that will pop up a dialog similar to the interface in FIG. 12 that was exposed by the swap control 605 where that image can be uploaded 1217, captured 1218, imported from a URL 1219, or selected from a gallery 1206; a clone tool that allows the user to specify a reference point and then have subsequent clicks and drags duplicate the pixels relative to that reference point; a zoom tool that zooms in or out on the stage 607 to provide more precision or a wider view; a bucket tool that will fill an area of contiguous pixels with the current fill color where adjacent pixels are contiguous if they are within a certain tolerance of the fix pixel clicked in the rgba color space; and a file tool that opens an interface for saving the edited image or resizing the stage. When appropriate, the mouse cursor can be altered to reflect not only which tool is selected, but visually represent some of its settings to allow for more precise editing. For example, when the brush tool is selected, the CSS style for the canvas element backing the stage 607 can be set so that no mouse cursor appears. Then the editor can draw its cursor at the location of the mouse that is a circle of the same radius as the current brush stroke settings so the user knows exactly where the brush will lay down pixels when dragged. None of these tools are difficult to implement and can be built following the standard desktop paradigms used in other programs. However, some may be more complex than others. The tools included in our framework will be driven by user feedback and ease of implementation and may include many that are not listed here.

As is standard with image editing software, the layers tool will allow the user to segregate all objects into layers where the bottom most layer is drawn first and obscured by layers above it. It can be explicitly shown which layer is currently active, in which case the selected tool will only operate on that layer. Another option is to have some tools, like the brush, always act on the top layer, whereas other tools, like the selection tool, will operate on lower layers if they are not obscured by something on the top layer.

Another standard feature the image editor interface 606 will provide is the ability to apply filters to bitmaps, or to convert vector content to a bitmap which can then be filtered. Filters are functions applied to groups of input pixels that output altered pixels. Examples include blurring, sharpening, ripple effects, pixelation, embossing, and the emulation of various physical art techniques such as watercolor or mosaic. As this article points out: http://www.html5rocks.com/en/tutorials/canvas/imagefilters/, since pixel data can be read in from the canvas and then writtten to the canvas, any filter that exists in some photo editing software can be ported to JavaScript and applied to images in the browser. Pixastic, http://www.pixastic.com/, is an open-source JavaScript library that implements many of the well known filters. The image editor 606 will allow users to apply these filters to the entire stage 607, or just to a specific bitmap layer, vector object, or selected collections of either. Again, it may be necessary to discard the vector information for vector objects in order to filter them, but it might be advantageous to retain that information and apply the filter again when that vector object is altered.

When the edited image 608 is saved it is stored on the server side for user applications 207 and its URL is substituted for the URL of the previous version of the image in the client source model. This substitution then automatically alters the appearance of that image in the application 612 as shown in the preview 514 to match the edited image 608. This substituted URL can have a parameter added to the end, e.g. http://abc.com/image.png!time=1929110101, that is based on the server's system time to make sure the browser will not display a cached version of the unedited image. The edited image is also tagged with metadata so as to appear in the section of the editing user's gallery that is reserved for images they have edited. Our framework may also store not only the resulting image file, but also the full object data behind its state while in the image editor. This way, when subsequent edits are made on the image, the vector objects will still be separate entities and the various layers will still exist so that information that was present during the previous edit will not be lost. This is a standard thing to do in image editing programs such as Adobe Photoshop which can save images as Photoshop Document files with the .psd extension as well as rendering those files into more standard image formats like jpeg or png. This object data can be stored as a serialization of the objects held in memory while editing is taking place. This could be as simple as converting them to JSON and writing it to a compressed file that is stored with the other media files for applications 212 and is tied to the image file using metadata in the data store for developer applications 220.

It may also be advantageous to encode edited images into data URIs, http://en.wikipedia.org/wiki/Data_URI_scheme, which could then be substituted into the preview 514 without a need to send the new image to the server side 207 or for the preview 514 to request the image from the server side 207. This would allow the preview to be updated locally with no time used for transferring data over the network. Then, when the edits to the application were saved, and/or published, the data URIs could be sent to the server side 207 to be saved as separate image files and the urls of those hosted files would be substituted into the text files as described above. In addition, it may be advantageous to use data URIs for hosted applications after they are saved and/or published. This would allow applications to be pulled from the server side 207 in a single request 108 and response 110, or perhaps a few separate requests and responses for files that involve data URIs and those that do not. This reduces the time to load an application by removing the amount of time to generate many separate requests 108. In this case it may be advantageous to provide a wrapper for the application that shows the progress of this single request or multiple requests. These techniques involving data URIs can also be applied to other media elements such as audio and video elements.

When applications contain elements that initiate requests for other resources 112, such as media files whose source is a URL that is external to the web page 121, it is common for the application to be in a “loading” state until all of the media files have been downloaded so that nothing fails in the application due to those files missing. Our framework could provide an API by which applications can load their media files. This would involve the application calling a function on this library, for example WI.addImage, which would take the URL for the image and a name for the image. This would be called for each media file in the application ? to register those images to be loaded when WI.loadImages is called with a parameter that is the function to call once all of the images are done loading. Our framework's API would then load each image and attach a function to each image's onload event that would check if all images had been loaded. It would also attach a reference to each image to a WI.images object with the name that was passed to the call to WI.addImage. This way the developer can later use the image in his code as WI.images[‘somename’] and this name can be displayed in the images moddables subwindow 602 thumbnail 603. The same process can exist for files for other media types such as sounds and video. This is an example of our framework providing certain tools that developers commonly need, but not requiring the use of those tools.

In general, our framework will strive to provide such options but not require them as it is important that application developers be free to interact with the actual text in the files 213 that define the behavior and appearance of their application. Any restriction to interacting with some intermediate layer that makes alterations to those text files in limited ways may prevent developers from harnessing the full capabilities of web standards code and markup. The moddable images subwindow 602 will also contain an add image button 611. Clicking this button will open the interface described for image swapping 605 to allow the user to capture, upload, or select an image from the galleries. He will also be prompted to give the image a programmatic name. Our framework will then find the first call to WI.addImage and insert a new line with another call to WI.addImage whose parameters will be the given name and a URL for the image. This gives the user a nice way to add a new image, without editing code, that is then automatically loaded and can be referenced in code by the given name. If the application does not contain any calls to WI.addImage or WI.loadImages, our framework can show the user a notice and point them to documentation that tells them how to use the media loader functions.

When images are first edited, drawn, or imported into our framework, they may not be the right size or orientation for their use in the application. For example, a user may want to replace the ship image with a picture of her face, but the ship image may be smaller and facing to the right while her face is oriented vertically. Then when the face is swapped in for the ship image into the game, it would not be oriented in the correct direction for the way the ship flies and fires its weapons, and may be too large to make the game fun. Because of this it may be useful to add a context menu or controls to the moddable image thumbnails 603 that let the user alter the size and orientation of the images without opening the full image editor. These modifications could overwrite the existing image, or the full-size source image may be saved alongside the scaled and or rotated image so that it can be later edited without a loss of resolution similarly to how the source files for vector and layer information are kept alongside their resulting image files.

If the application uses some common library, such as Ease1JS to manage its graphics, our framework may be able to programmatically determine the current location of the image in the preview subwindow 514 for which the edit control 604 is clicked. In this case, the image editor subwindow 610 could be opened such that the stage 607 background is transparent and the image being edited 608 is positioned on top of its location in the preview subwindow 514. This interface feature would allow the user to see more clearly how his edited image will fit into his application.

There are certain special uses for image files that our framework might want to handle slightly differently from plain images. For example, it is common to use sprite sheets in games. Sprite sheets are single images that contain multiple, non-intersecting smaller images that are then referenced by their coordinates in the larger image. This allows all the images to be downloaded in one request as opposed to many. It is also often used to store the frames of some animation or set of animations sequentially in scan order in a grid. Sprite sheets can be edited just like any other image in the image editor window 610, but there may be certain common operations for which our framework would want to provide specific tools for sprite sheets. Our framework may provide an interface or library for defining sprite sheets in terms of an image and a number of rows and columns or a set of coordinates for each frame. Then the image editor interface 610 could include controls to view and edit each of the frames individually, or to apply some edit to multiple frames.

Another special use of images is in keyframe-based animations such as those created in Adobe Flash and other similar products like Mugeda, https://www.mugeda.com/. These are sets of images or vector-based drawings that are tied to the notion of a timeline. The visual objects have a certain state in one or more keyframes that occur sequentially along the timeline. When the animation is played, each object's state is updated for each keyframe sequentially at the speed defined by an adjustable frame rate. The power of such animations comes from the ability to tween between these states. If the same object is present in two non-adjacent keyframes with different states, a tween can be established to smoothly transition between those states without manually defining the states of the object in the intermediate frames. For example, in one frame a circle may be centered at the point 0, 0 in cartesian coordinates and have a radius of 100 pixels. Ten frames later it may be centered at 100, 100 and have a radius of 50 pixels. A tween would linearly interpolate the intermediate frames so that the circle's position would steadily increase in both the x and y directions from 0, 0 to 100, 100 while its radius steadily decreased from 100 to 50 pixels. This interpolation is often done using Catmull-Rom splines http://en.wikipedia.org/wiki/Cubic_Hermite_spline#Catmull.E2.80.93Rom_spline. It may be advantageous for our framework to provide tools and libraries that support keyframe based animations. These interfaces would likely mimic the existing tools already mentioned and could leverage open source libraries such as Tween.js, https://github.com/sole/tween.js/. They could also be implemented with the help of CSS3's @keyframes rules, but these currently have poor cross-browser support. The Scalable Vector Graphics (SVG) specifications, http://en.wikipedia.org/wiki/Scalable_Vector_Graphics, could also be particularly useful for keyframe-based animations, amongst other things. The SVG markup is supported by all major modern web browsers and can be considered part of web standards markup as it is defined by the W3C. It can be edited as text in the same way as standard HTML but it may be advantageous for our framework to provide visually-based tools for editing SVG objects using open-source libraries such as svg-edit, http://code.google.com/p/svg-edit/.

### Modding

Our framework may allow end users of applications to modify those applications. Modifiable applications would expose a control to the end user that would allow him to begin modifying the application such as the button in the embedded application 404 and the button on our framework web page for user applications 310. When a user initiates the modification process, a clone of the original application is made in the data store for developer applications 220. This clone is a copy of the files 212, 213, 214, 218 that make up the original application and the records in the data store 220 for that original application. Some metadata in the data store 220 will not be copied if it is specific to the user that originally created the application or if it needs to be updated to indicate that the new application is unique, such as the name of the application or the description.

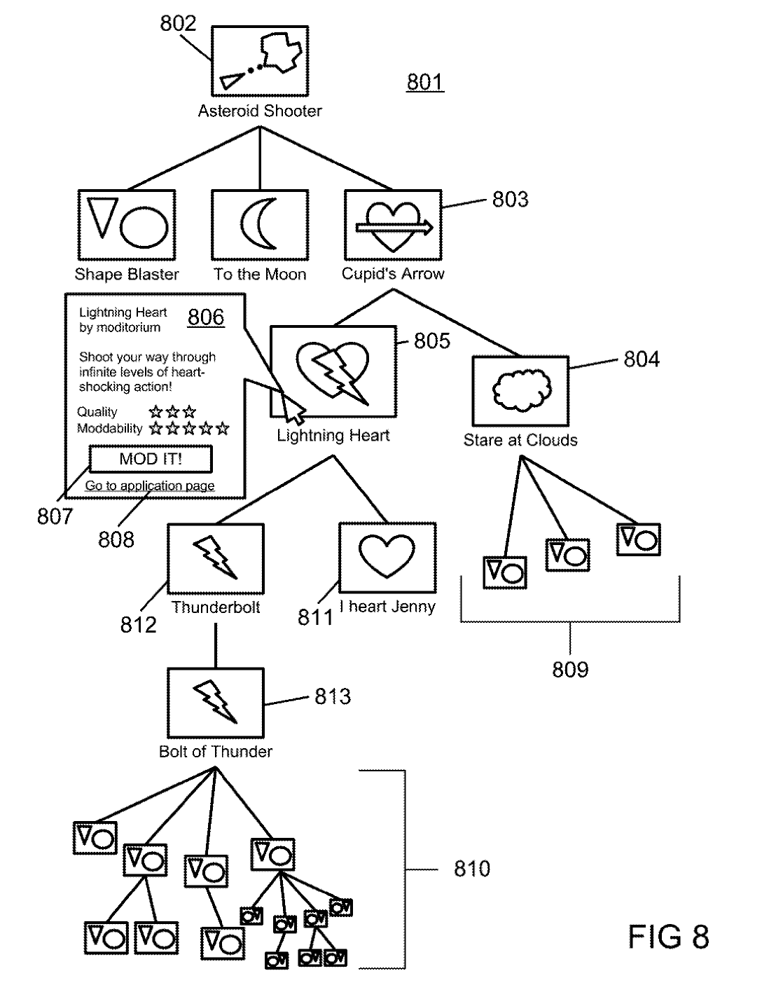

Records will also be added to the data store 220 that keep track of the hierarchy of applications and their modified derivatives in the application descendant's family tree 801 shown in FIG. 8. We will refer to this tree both in terms of a user interface for browsing the family tree for an application, and in terms of a data structure that is maintained when applications are cloned and that is used in determining the related applications 303 to display and in applying the trickle-up revenue sharing model detailed later.

Once the application has been cloned, the clone is opened in the development interface web page 209. At this point the application clone works just like any other saved application as if the end user had created it himself and was making changes or updating it. He can make whatever changes he wants, and publish the new related application to be hosted on its own application web page 301 and possibly embedded in other web pages 407. If the user has an account and is logged in, the cloned application will be linked to his user account in our framework data store 219 and data store for developer applications 220. In this context we say that the user owns the new, cloned, child application just as the developer who created the parent application (whether through cloning some other application or not) owns that parent application. We use the term owns broadly to mean, for example, the permissions to alter the application and save a new version that replaces the old hosted application, or to alter certain metadata associated with the application. If the user does not have an account, or is not logged in, our framework can create a temporary, unique, but anonymous user to which the application is linked. Our framework will then set a session cookie 130 that can be read later to identify that user if he is working on the same device and allow him to return to editing his application. Applications published by a user with no account must be published publicly since the anonymous user does not have any social network data on our framework with which to limit the sharing of the application. Anonymous users closing the development interface web page 209 will be shown a warning before the web page closes, using the onbeforeunload event, that they should make an account or else they might not be able to return to editing the application. If a user with a session cookie tying him to an anonymous user account creates a new account on our framework the anonymous account will be converted into a full account by assigning a user name and password. This way any data tied to the anonymous account as well as its permissions to edit applications created under that anonymous account will become part of the full user account.

Allowing end user modification of applications is a powerful concept, as shown by the proliferation of open source software. However, the ability to leverage the open source nature of an application is normally limited to experienced software developers who not only understand how to modify the application's source code, but also how to access that source code, how to publish the application and, if the applications is web-based, how to purchase and configure hosting space for that application.

In contrast, a user of our framework can modify any application created on our framework by clicking the modification button, and making changes; any changes he makes can be instantly published and hosted using a few clicks. Having an existing application to start from is a big advantage over writing applications from scratch. Not only is there existing source code that would let someone unfamiliar with web standards syntax and libraries to work by example, but at a coarser level there is example architecture to be leveraged. Many people who would consider themselves web developers but not software developers, in the sense that they make simple web pages and not large scale applications, have used JavaScript syntax before but would have no idea how to write, for example, a game. However, those web developers don't have to understand the structure of a game to start modifying the look and gameplay in a way that creates a completely different and unrecognizable game. In the process, he will likely come to understand how games work in general, but would still often prefer to start with some existing game as scaffolding so that the basic code that is present in all games doesn't have to be tediously rewritten. For this reason our framework will include templates for various types of applications and games even if end user modification of applications is not supported. These will be offered to users as a starting point and will be cloned and opened for editing just as existing user applications are when modified by an end user.

Another powerful aspect of end user modification of applications is that it allows existing content to be adapted for a new context and thus a new market. An application that is popular with teachers can be shared with a teacher that is also a baseball fan. That teacher could modify the application, perhaps even just by editing a few images, to make it appeal to baseball fans and then share it with her friends who happen to be baseball fans. Thus modifiable applications can be not just viral, but adaptively viral—constantly being mutated into new, related content that can be shared virally in a way the original could not. This is a valuable proposition for many existing application developers who often have a core concept that, once implemented, is put out into the market and must be constantly adapted by them for what the market wants. A modifiable application can instead be released with a core concept and then modified by the end users to become many different applications that satisfy the needs of their end users in a way no single application ever could.

Just as the application web page 301 can display the application's modified derivatives (its children), the original application it came from (its parent), and other derivatives of the parent (its siblings) it could also have a button to display the entire family tree 801 of an application. Each application would be denoted by an image and name 802 just like in the related applications pane 303. Children 804, 805 would be displayed below their parent application 803, connected to them by a line, just as in a standard family tree. This would allow users to see where an application came from, and what else it has been modified into, in case one of the application's relatives is more appealing for their needs than the application they happened to be looking at, or gives them an idea for a modification they'd like to make.

The displayed application family tree 801 for an application would extend fully up to the root application 802 that may have been made by a user from scratch, or provided by our framework. It would also extend downward to all the children of that root, sometimes zooming out on subtrees that are either too large to display 810 or perhaps a recommendation engine has determined to be less interesting 809 based on their ratings and number of views by users. When a zoomed-out subtree 810 is clicked, it can become larger, making the rest of the tree smaller, or placed off screen where it could be scrolled to. If the thumbnail 805 for a particular application is clicked on or moused over, that thumbnail can become larger and display an interface 806 that provides supplemental information, such as the creator of the application, a short description, and its various ratings. The interface will also show a button 807 that, when clicked, will take the user to the development interface 501 for that application, and a link 808 which will take the user to our framework's page for that application 301.

In general, the more simple an application is, the easier it is to modify into what you want. For example, if the game Pac-Man were a modifiable application, it would not be difficult to change its context by editing the images for Pac-Man, the ghosts, the pellets, and the bonus food items. However, if a more complex game such as StarCraft were a modifiable application, to change its context would be a much larger undertaking due to the sheer amount of media that would have to be changed. A user can thus walk up and down the tree to find the version of an application that is the best to start from because it is already closer to what they want, or is more simple and thus would require removing or changing less things.

When a user publishes a modified application they can submit not only a description to be displayed 308 on the application web page but also notes on what modifications they made to the parent application. This will allow other users to look at the family tree 801 for some application they want to modify, find an application that was modified in the way they want, and read the notes to learn how they might make a similar modification. These notes could be displayed under a special developer's menu on the application web page 301.

### Server Side Code

Our framework may offer users the ability to write code for web services 214 that would then be published to 223 and run on an application container server 221. In addition to the previously mentioned third-party vendor options for application containers, and the use of CloudFoundry as an application container managed by our framework, another option is AppJet, https://github.com/dvbportal/appjet. AppJet is an open source project that provides an application container for JavaScript code that can be run by any server running an updated version of the Java Virtual Machine as a single .jar file that will execute JavaScript code on the server side. It is highly configurable, allowing the application containers to be run with custom root directories and ports. It can expose a debug log for debugging of server side code and has built-in database storage with a customizable limit of up to 50 mebibytes.

An application container based on AppJet would have several advantages. One is that application developers could use JavaScript for both their client side and server side code. This means that the objects used on the client side could be sent to and retrieved from the server side code with no need for conversion. The AppJet database also stores JavaScript objects natively so that the same JavaScript objects can be used across the client, server, and datastore layers without conversion. AppJet is also open source under one of the most permissive licenses available, the Apache 2.0 license. This means that any limitations found with AppJet can be remedied by customizing it for the needs of our framework.

Since AppJet runs JavaScript, the interface as described for the editing of client-side source code 501 could also be used in exactly the same way for web service code. A new moddable panel could be added to the list 510 exposed by the moddables button 509 that would show functions, modules, files, and the full source for the web service JavaScript. These would be kept in a new server source model that would operate just as the client source model in terms of the different subwindow views such as function editing or constant editing, and would be stored on the server side for developer applications 207. The top bar 504 of the subwindows for server-side code may be colored differently or otherwise distinguished visually, perhaps with an icon, to prevent confusion with the client side code subwindows. Once a user application includes web service JavaScript, it would be provisioned on a virtual machine, such as an Amazon EC2 instance, that would run the AppJet .jar file, thus becoming an application container 221 under a custom URL that would be exposed to the user so that it could be called by their client-side code. There could also be multiple AppJet instances running on a single machine or virtual machine and throttled to prevent any one instance from affecting the performance of the others. It is also possible to have one AppJet instance running multiple apps on the same machine or virtual machine using the appjet-clone project, http://appspot.jgate.de/src?app=appjet-clone or the appjet platform clone http://blog.herby.sk/blosxom/Programming/AppJet%20platform%20clone.

Our framework may also provide the developer with an API like WI.callWebService(postData) that would automatically send the postData object to the proper URL for the provisioned web service. The server side JavaScript files, when edited, would be stored on the server side for developer applications 207 and the JavaScript file being run by the AppJet instance would be updated 223 on the file system of the application container 221. AppJet automatically notices changes to the JavaScript code so the altering of that file by our framework would immediately alter the behavior of the web service. This would be done whenever the preview needed to be updated for unpublished applications, or at the moment of publish for published applications. If end user modification of applications is supported, cloning an application would also clone the application container 221 along with the datastore on its file system and the web service code 214.

As discussed, one of the advantages of using server side JavaScript is that JavaScript objects can be used across all layers of the application. This is particularly valuable because the server side code often needs to have modules with the exact same code as the client side code. For example, in a multiplayer game involving space battle, the client side needs modules that store the state of each player's ship so that when a player moves his ship that state can be displayed locally but also sent to the server. The server also needs a module describing the state of a ship and how things like the state of the other players' ships and weapons might alter it so it can then update the state of all ships in all connected clients. Our framework could support users marking certain modules and functions as both client and server side, perhaps with a context menu on the editor subwindows for those moddables. In this case the window would be visually distinguished from both the client and server editor subwindows and metadata would be stored telling our framework to push changes made to that code element to both the client and server source models. This would allow users to edit the code that is repeated on the server and client side in one place and always be sure that they are the same.

Despite the advantages of server side JavaScript, users may still desire application containers that support other languages. In this case the previously mentioned third-party vendor options for application containers, or CloudFoundry, could be used. The process of provisioning application containers for each application would depend on the specific implementation choice made but the available options have no shortage of documentation defining how new application containers 221 can be provisioned. So the process of storing the edited code 214 and updating 223 the application container 221 to run the new code would be essentially the same. The user interface for editing the server side code would still be very close to the one described for client side code 501.

One major difference is that languages other than JavaScript would have to be handled individually in terms of parsing out code units such as modules, functions, and constants for isolation in editor subwindows 518, 519, 523. Every language is different and the code units that are useful to isolate may differ between languages. Regardless of these differences, every language can be parsed by code and in fact is parsed when it is run. There may not be existing or open source parsers for every language, or those available parsers might not be in JavaScript and thus difficult to run within our framework client editor interface 501. It still may be simple to parse certain code units with regular expressions, particularly in the more rigidly formatted languages. There is also the option of running a non-JavaScript-based parser on the server side of our framework 207, that would send the editor interface 501 metadata along with the code which would specify the line and character start and end locations of code units such as functions in some particular language.

Even if it is intractable to parse any useful code units out of some server-side language, the full source 517 or file-level views could be exposed trivially. Codemirror has built-in support for dozens of languages, so the editing experience for users in these editor subwindows would be similar for almost any language and would allow for full control over the server-side code and thus the behavior of the application's web services. For languages that could be parsed and support type safety, our framework would be able to implement more advanced refactoring features such as “find all references” and “rename function” that would work even when functions on multiple modules have the same name. Which languages are supported by the application container server 221 would be driven by user requests and ease of support.

One common aspect of software development is the ability to write to a log file using function calls within code. In JavaScript run in a browser this can be done with the console.log function which will write text to the browser's JavaScript console along with the file and line number on which console.log was called. For server side code 214 run in an application container 221 our framework would expose a subwindow in the editor interface 501 that would show the user any server-side logging. AppJet has an interface that exposes this for server-side JavaScript which could easily be altered to meet the needs of our framework users, or exposed as is. For other languages and application container software the implementation would differ. In general, if the code running in the application container can write to a log file on the disk, that log file could be read by code on the application container server that would then expose a web service that would respond to requests with the contents of the physical log file. The editor client interface 501 could then call this web service and expose the contents of the log file to the user in a subwindow.

If AppJet is used, its native data storage might not be sufficient for some applications. In this case the data store for developer applications might contain data stores that the applications themselves can write to and read from, either with client or server side code. Apache's CouchDB project, https://github.com/apache/couchdb, would be well suited for this task. CouchDB is a schema-free data store based on the storage of “documents” that are JSON objects. It supports many useful replication features and is designed to operate in a distributed manner. CouchDB exposes a RESTful, http://en.wikipedia.org/wiki/Representational_state_transfer, interface so both server side and client side code in any language can read and write to the database with nothing other than HTTP requests. It supports a simple reader access and update validation model that can be extended by our framework to limit access to the data stored by user applications to those applications and/or the users that have permission to see or alter those applications.

Our framework could expose a JavaScript library that makes RESTful calls to CouchDB instances on the data store for developer applications 220. Thus a user application that wants to store data could do so using a JavaScript call like WI.putData(‘key’, ‘value’) and later retrieve that stored value using a call like WI.getData(‘key’). This provides user applications with the ability to store data on the server side for developer applications 207 without writing any server-side code 214. This would be useful for any application that wants to maintain a notion of state across multiple clients.

Certain application developers might not be satisfied with a key-value style datastore and would want a relational database in which to store data for their application. The data store for developer applications could offer this using a service such as Amazon's RDS. Each user application could be provisioned using one or more databases on one or more Amazon RDS instances in which it could write its schema, tables, and records. Amazon RDS servers, like other Amazon web services products, are fully scriptable using command line tools and often offer RESTful interfaces, and thus the server side for developer applications can easily create, destroy, clone and manage datastores for developer applications using any number of existing libraries in various languages that interface with Amazon RDS.

Our framework may also offer some specific web services that would fulfill common needs for user applications without the user having to write and maintain server-side code 214. These web services would be hosted on the server side for developer applications 207 perhaps in their application containers 221 and would be backed by some data store as part of the data store for developer applications 220.

One web service that might be useful is a high score service for games. User applications would be able to access this service using calls like WI.storeScore(‘someUser’, 100020) that would send the user name and score to the web service along with an identifier indicating which user application was storing the score. The application would request a list of some number of the highest scores like WI.getHighScores(20) or the highest scores for some particular user like WI.getUserScores(‘someUser’, 20) and the requests would also be sent with an application identifier allowing the web service to look up the stored scores for that application and return them to the application to display.

Another web service that might be desirable for user applications is a matching system for multiplayer games. A matching lobby object could be created like ‘var matcher=new WI.Matcher(settingsObject)’ which would send an application identifier to the matcher web service along with a settings object which would define how matches are made. The settings object might contain data such as various player attributes and tolerances on how far apart those attributes can be between two players that are matched together. A call like

WI.startMatch(‘someUser’, attibutesObject, matchCallback) would send an application identifier, along with a user name and an object containing a list of attributes for a player to the matching web service. For example, one attribute might be a rating of the player's ability and the settings would define that two matched players must have ratings that differ by no more than a certain number. The web service code would continually be applying these rules and then returning a match when one was found. When the web service returns a match the client library would call the matchCallback function it was passed which would be defined by the user application to do what it wished with the information on which users had been matched and why.

Another useful web service could be called a state-chat server. Just as a basic chat server allows users to send text to a central server that is then broadcast to all clients, this would allow user applications to send application states to a server that could then be broadcast to all instances of that user application. For example, a multiplayer chess game could use the matcher web service to match two users playing different instances of the game in their respective web browsers. When each player made a move, their instance of the application would make calls like WI.sendState(‘matchNumber’, stateObject) that would send an application identifier to the web service along with a unique number for the match and an object containing the state to be broadcast. The state object would contain information on the user that made the move and the move itself. When it is not a user's turn to move, his application will be continually calling WI.getState(‘matchNumber’) which could return nothing if no new state had been sent to the web service for that application and match number since the last call, but would eventually return a new state that contained the details of the other player's move. The application would then display this move and allow the player to make his move, or end the game, depending on the state of the chess board. In this way a multiplayer game can be made without writing any server-side code at all. Certain types of games may still require a server-side component that can apply centralized logic to the state being sent by each client. However, clients could sendState with options that tell the state-chat web service to average the state of certain objects across all clients, or that define other simple mathematical rules that could be applied without writing custom server-side code. This web service would be possible to use without the matcher web service if the application allowed end users to specify a unique match name on their own that could then be given to a friend or posted somewhere in order to allow others to join that same match. It may also be possible to leverage the third-party service firebase, http://www.firebase.com/, which provides a state-chat web service for applications.

Implementing achievements for applications could also be facilitated by a web service. Achievements are specific actions or states of the application that the user has achieved, such as reaching a certain level in a game, or sharing a social application with ten other people. Applications use these milestones to encourage specific behavior and often display the milestones on a user's profile page as text or image-based badges to motivate users through pride and model ideal behavior to other users. A web service could be provided that allows developers to have their applications add achievements to our framework profile page for a user. Each application could also be given a set number of achievement points to distribute amongst the achievements in their application. When a user obtained an achievement, his achievement point total for the application, and his global total, would both be incremented by the amount of points assigned to that achievement. This produces a meta-game in which users compete with each other to increase their individual application and global achievement scores by using more applications. Our framework itself would also provide achievements for certain actions performed outside of applications in order to motivate users to take those specific actions.

Other helpful web services that could be exposed to developers through a client-side API include: allowing an application to query specific data about the user's account; interfacing into common third-party APIs such as the one provided by Facebook for accessing user data; or a messaging service that allows developers to facilitate communication between users who are both using the same application.

Web services such as the ones mentioned above could also be written by users as server-side only user applications. These could then be considered assets in the application revenue trickle-up model and could be used by other users in exchange for portions of application revenue. It is also possible for user applications to make requests to web services that are not hosted by our framework but owned by other users. Our framework could still expose a market for these where users might offer the web services for free or some cost that could be tied into the revenue trickle up model or be cash-based with our framework perhaps taking what amounts to a broker fee from the transactions. Of course, developers could also access third-party web services that they pay for or that are provided for free. These are JavaScript calls that send and receive data to and from URLs, so unless our framework has some reason to block requests to a particular domain or URL, these would be trivially supported.

As previously stated, our framework may limit the usage of server-side resources by user application web service code based on factors such as network traffic, data storage size or computational cycles. Our framework may also put limits on the web services it offers users such as the matcher service or state-chat service. These limits could be lifted if the creators of the applications wished to pay our framework fees that would likely follow a tiered structure and be driven by the costs associated with supporting the storage, bandwidth and computation in question. Of course our framework will reserve the right to shut down user applications that are performing malicious acts such as sending spam and the application containers 221 will be architected so that malicious or faulty code for one application cannot affect the operation of other user applications.

### Applications in Our Framework

As discussed earlier, user applications 401, 405 can be embedded in web pages in such a way that they can communicate with the surrounding web page 407 and each other using the postMessage API. This allows embedded applications to be functional parts of a more complex application so long as the embedding web page 407 and embedded applications 401 405 are designed such that they expose an API that defines their behavior in response to postMessage messages. In order to illustrate the power of embedded user applications, our framework itself may utilize them heavily.

For example, the logo 313 shown on the web page for a user application 301 could be an embedded application that reacts to mouse events or changes over time or to various actions such as using or sharing the embedded application. If end user modification of applications is supported by our framework then it could be advertised to users that each week the most interesting modification of the logo application will be featured as its replacement for the following week. Other common site components such as a “contact us” form that sends an email to the managers of our framework based on a form that is filled out with a choice of feedback category and a text field in which to write feedback could be user applications. This would highlight to users that they could embed that same application in their web site.

It may be advantageous to make the editor windows and other controls found on the client editor interface 501 embedded applications. This would particularly be the case if end-user modification of applications is supported as it would allow new editor interfaces and tools to be crowdsourced by our framework users. All an editor window needs to do is display some interface that sends events that update the client source model, and to respond to events from the client source model by altering its interface if necessary. In the case that the editor subwindows are not embedded applications, this communication would happen using JavaScript but would still rely on the client source model exposing a specific API for the editor subwindow objects to call. This same API could be implemented using the postMessage API.

The main interface 501 would act as a clearinghouse for creating embedded iFrame application subwindows, or “subapplications”. As an example of how this would be applied to all subwindows and tools we will now discuss the flow of parsing the list of functions 521 and changing one of the functions in the list with an editor 519 using the subapplication paradigm. The functions list subapplication 521 could be created by main interface elements such as the moddables menu button 509 as previously discussed. Once created, the functions list subwindow 521 would request the full client source model, which it would parse to produce the list of functions. The functions list subwindow would also register with the main interface 501 to establish its existence and that it should be sent the updated client source model when the model is changed. When a user clicks on a function name in the functions list 521, the functions list would tell the main interface 501, using the postMessage API, to spawn a new function editor subapplication 519 by providing the URL that should be embedded in the subapplication iFrame, or perhaps some other application ID code. The functions list 521 would also tell the main interface 519 to pass the appropriate function code to the function editor subapplication, to register it for changes to those characters and lines in the client source model, and some supplemental information such as the subapplication dimensions and location. The new function editor subapplication 519 would be given a unique identifier which the functions list 521 and main interface 501 could then use to specifically target that subapplication.

In this paradigm, the windowing controls 504, 502, 506, 503 could be inside the subapplication iFrame, but it is likely better to have the main interface 501 create all new subapplications iFrames inside the same window controls 504, 502, 506, 503 so that they can be manipulated in the same way and made to interact in a user-friendly manner. The subapplications could have the option of using a postMessage API to tell the main interface to remove the window controls 504, 502, 506, 503. It would likely be advantageous to have the main interface 501 be agnostic to the existence of any specific subapplications, thus responding to requests to spawn new subapplications and notifying any subapplications of changes to the client source model or media files for which they have registered.

The same postMessage API that the main interface 501 uses to communicate with the subapplications 519 embedded within it, could be used by web pages 407 to communicate with embedded applications 401 405. This is a powerful concept as it means that tools such as the image editor subapplication 606 would not need to be altered in order for a web page to embed that tool 606 and be able to send it images to edit, and retrieve the edited result. This same process could be employed by user applications created on and hosted by our framework.

For example, when modified by an end-user, if that is supported, some game may want to provide a character-editor subapplication that facilitates the customization of the game's main character by the selection of various faces and outfits. Then when the user saves and publishes his new, modified application, it has the custom character they desire as the main character. However, another game developer may not want every user that customizes a character to create a new application. A multi-player game developer may want his game to exist as a single application in which many users can play with each other using their custom characters. This multiplayer game could then embed the character-editor subapplication within the game itself, not only when it is opened for modification. This would allow the multiplayer game developer to let many players create their custom characters and, instead of altering the multiplayer game's code, save that character data in the games's data store 220 tied to the user's account, or in the user's local web storage 131. Thus the character-editor subapplication can be used by an end-user within the editor interface 501 to create a new game, or within a game itself to create a persistent or temporary customization of that same game, but linked to that user.

Since each subapplication iFrame would generate a separate HTTP request 108 and response 110 if it were instantiated by the main interface 501 with a src attribute set to the subapplication's URL, it may be advantageous for the server side 207 to bundle all subapplication content with the initial request for the main interface page 501. This would involve the server side 207 using the metadata references 222 in the data store 220 to determine which subapplications were packaged with the application in question and placing the content of their client-side text files, perhaps individually minified, into a JavaScript object placed in the main interface page 501. For each subapplication element in the object, the main interface 501 would create an iFrame element with no initial src attribute and then set its shtml attribute to the client-side text file 213 content that makes up the subapplication. This way each iFrame would not need to generate requests for their JavaScript code 116 and HTML text 109 and the initial load time of the development interface 501 as a whole may be greatly improved.

The fact that postMessage is even involved could even be obscured somewhat by wrapping the calls to postMessage in JavaScript functions to obscure the implementation of the communication and allow developers to focus on the behavior level of the API. For example, an editor subwindow that would, when not embedded, call model.sendSourceChangeEvent(someEvent) would not need to change that call at all when embedded, provided that the embedded subwindow object had a model object for which sendSourceChangeEvent calls postMessage in the proper way to communicate that even to the client source model.

As mentioned previously, the original developer of an application can set the initial state of the development interface 501 when that application is edited by themselves, or by an end-user if end-user application modification is supported. We say in this context that the original developer owns the application. When an end-user modifies and publishes an application, she is now the owner for that new, distinct application that was cloned from the parent application. Thus a developer could create new editor interfaces that would then be packaged with her application to facilitate modification by end users in specific ways that would be powerful for that application. For example, editors that parse a specific JavaScript object defining the levels of a game and provide a grid-based visual editor for those levels and then writes to that same JavaScript object format.

An alternate architecture for user-modifiable tools in the editor interface 501 is to have each tool be in an iFrame that is hosted on the same domain as the rest of the editor interface 501. However, this interface itself would be embedded in an iFrame within a different domain that would hold all the interface and code for user account information and authentication. Thus the embedded tools iFrames would be able to talk to each other and the main editor interface using JavaScript calls, but the user account information would be protected from these calls by the same origin policy and would only expose a protected API to the tools and editor interface using postMessage.

### User Accounts/Privacy/Sharing

Our framework allows a user to create an account using a standard login UI containing at least a valid email address and password such that the user can login to her account to operate our framework under an authenticated session. Alternatively, the user can use an account that she owns on sites like Twitter, Facebook, or Google to login, or any OpenID provider, accomplished by using the provided APIs. The user may not need to login to use or modify our framework's public applications, however, an authorized login may be required to save any assets to an account, or to publish any created or modified assets.

If a user who is not logged in creates or modifies content on our framework, a cookie 130 may be set that allows our framework to recognize that user on that device in order to give her access to her saved work. If a user on some device with such a cookie then creates an account, the cookie-based account's information can be imported into the new, fully-functional user account. Once logged in, the user can save assets to her account including applications, directories, files, code constructs such as modules, functions, objects, arrays, and primitives, and media such as images, audio, and video using the UI described elsewhere. All of an account's information and associated assets are sent to our framework's servers using HTTP requests, stored, and can only be accessed by users with appropriate permissions. This is accomplished on the server by checking each incoming HTTP request against a list of users authorized to read the requested data or against a list of users authorized to write data to the requested account depending on the type of request. Only admins and the user who owns the account are initially authorized to access data associated with the account.

An account view can display all data associated with a user account and provides the UI necessary to manage that data. Once logged in, the user is provided a clickable or touchable UI element to access her account view. Account data is retrieved from our framework's servers using an HTTP request upon opening the corresponding view or sub-view. The data is stored in a model object on the client, and event listeners are attached to the model's properties such that any changes to the account data made by the user are sent to the servers for update.

It is from the account view that the user is able to build a list of contacts, organize them into groups, and subscribe to their public activity feeds. Contact management includes: the ability to add a contact using a standard web form to take email address input and optionally name input, the ability to add a contact who has an account on our framework using a standard web form to take name input and searching for the name amongst a list of accounts, the ability to add a contact by importing the relevant information from Facebook, Google, or other social networks that allow import by using the provided APIs, the ability to add a named group of contacts using a standard web form to take title input, the ability to assign one or more contacts to a group using a standard web form to take a comma-delimited list of email addresses or names as input, the ability to toggle the selection state of a contact using a clickable or touchable UI element, the ability to select one or more contacts using event listeners to map mouse or touch drag events to the contacts displayed under the rectangular area encompassing the drag, the ability to assign selected contacts to a group using a clickable or touchable UI element or event listeners to map mouse or touch drag and drop events to the group displayed under the drop events, the ability to remove selected contacts using a clickable or touchable UI element, the ability to follow and unfollow selected contacts or groups of contacts with accounts on our framework using a clickable or touchable UI element to toggle, the ability to follow and unfollow an asset using a standard web form to take the asset name as input, a clickable or touchable UI element to toggle, and a server push technology such as long-polling or webSockets to deliver a notification in real time when a derivative asset is made, and the ability to follow and unfollow an asset label using a standard web form to take the label name as input, a clickable or touchable UI element to toggle, and a server push technology such as long-polling or webSockets to deliver a notification in real time when an asset with that label is published to the public group.

Additionally, the account view allows a user to manage her galleries of assets and publish them to other users. FIG. 12 shows the user galleries page 1201 with a sharing interface 1202 open for a selected asset 1203. A directory tree structure 1204 is displayed with the standard clickable or touchable UI elements for expanding and collapsing directories. The assets held in selected directories 1205 are displayed as icons 1203 in a gallery to the right 1206. The user can organize assets into projects and sub-directories by selecting and dragging assets from the gallery 1206 and within the directory tree 1204 using mouse or touch drag and drop event listeners. The user can search 1207 for an asset by name, rename an asset, delete an asset, or tag an asset with one or more labels through a context menu. The user can also upload 1217 one or more assets from their local file system 129, import an asset from a given URL 1219, or capture a chosen media type using her system's hardware devices 128. The user can also open an editor subwindow of the appropriate type using a context menu on the asset icon 1203 to modify and re-save an existing asset, or click a button 1208 to open a menu to create a new asset by choosing an appropriate editor. Asset editors are described elsewhere.

To share assets with others, a sharing interface 1202 is provided. A list of individuals and groups with which the asset is currently shared is shown 1212. Users or groups in the list can be removed from the list, or added by entering the name of the group or user, or an email address 1213, or by dragging groups 1210, individual users 1211, and clubs 1216 from a list of contacts 1214. Clubs 1216 will be described later. When an asset is not published to the special “public” group 1209, the specified groups and/or individuals are added to the list of users with read access to the asset, they are notified either in their account feed or by email, and the asset is displayed as a shared asset in their account view should they have an account. When an asset is published to the public group 1209, which is the default, the public super-group replaces the list of users with read access to the asset, any users following the publishing user are notified either in their account feed or by email, and the asset is flagged as discoverable on our framework's front page, as described elsewhere. A server push technology—either webSockets or long-polling depending on availability—is used to deliver the feed notifications in real time. If end-user modification of assets and applications is supported, users with read access to an asset can make copies or derivative assets from the original and save them to their accounts should they have accounts, but publishing does not add to the list of users with write access to the asset, and thus these users cannot overwrite the original. For assets already published to the public group, a user can re-share the asset such that her followers receive notification of the asset as well. Furthermore, public assets can be shared to other networks using the social bookmarking service AddThis, or alternatively ShareThis or Add to Any as described in association with the share button 311.

The sharing interface 1202 may provide the option to mark assets, which include entire applications, as “private” 1215. If a user marks an asset as private, our framework will not allow that asset to be re-shared by users with which it was originally shared. If end-user modification of applications and assets is supported, private assets will not be able to be modified and published by the users with which they are shared except to users with which that asset had already been shared. If some application is not private, but some number of assets used in the application are private, those assets will need to be removed as part of any modification before that modified application can be shared with users with which it is not already shared.

For example, a user may create an application that includes a photo of him and his children and share it with his close friends and family. The application creator may not care if his friends and family then modify the application and share it with the world, but he marks the photo of him and his children as private so that any derivative applications are forced to not include that photo. Due to the nature of web applications, this kind of private protection is not perfect. For instance, any image that can be displayed on a screen can be captured by a screen shot, or by a photo of the displaying device. Because of this, when a user marks an asset as private, he may be shown a warning that the privacy only applies to what our framework allows and can be circumvented with some amount of effort. Our framework may also make this explicit by not disallowing resharing or modification, but merely explicitly warning the users with which the asset was shared that the original creator intended that asset to be private.

Assets and applications may be shared with individuals 1211, and groups 1210, which are collections of individuals created by a specific user. It is likely that it will be most advantageous to never expose the groups one user defines to another user. So no user with whom content is shared because he is part of a group would know the name of that group or what other users are members of that group. Another sharing structure, clubs 1216 may be supported by our framework.

Clubs are a type of group designed to formalize how things are shared within that group and to make those rules transparent. We use the term club broadly to include, for example, any self-governing set of users of our framework where that set is identified uniquely within our framework and membership in that set is public to, and consistent between, its members. For example, a specific club named “Team Awesome” would be the only club within our framework with that name and would have some set of user accounts that are tied to that club at our framework level. This is in contrast to groups of users created by individual users in order to organize their contacts.

A club 1216 can be started by any user, at which point that founding user is the only member and the sole administrator of the club 1216. The administrator can add or remove club members, and can also set sharing rules which are then applied to any content that is shared with the club 1216. For example, the club rules may dictate that any application or other assets shared with the club 1216 should be shared privately be default. Then, if some member shares an asset with the club 1216, it will automatically be marked as private 1215 by default and the user would have to explicitly mark it as non-private. As described above, this means that by default assets shared with the club 1216 could not be reshared outside of the club 1216, and, if end-user modification of applications is supported, any modified versions of those assets could only be shared within the club. Once shared with the club, administrators would be the only ones with permission to mark certain assets, including whole applications, as non-private so that they could be shared outside the club. For instance, a group of dozens of individuals may form a club in order to collaborate on some application that is private, but at some point determine that it is in a state which can be shared publicly. At this point the administrator could remove the private setting from that application and any members within the club would be able to share it with anyone they so chose.

Club administrators may also be able to mark other club members as administrators. These administrators may have parallel authority or they may be able to unanimously choose a voting structure. Under a voting structure, actions such as adding new members or changing privacy settings for the club or specific assets shared with the club would require a unanimous vote by all administrators, or a plurality of administrators, depending on the settings. A deadline may be put on such votes such that any administrator that does not respond to the email or notifications from our framework about the vote will have their vote removed from consideration after some period of time. Any actions such as adding new members or changing privacy settings would most likely be made transparent to all members using notices in our framework or email alerts as one goal of the club structure is transparency. However, a setting may be offered to keep certain actions private to the administrators that vote on said actions.

### Collaboration

In order to facilitate collaboration within the community of developers, our framework will feature its own chat, or instant messaging, system. This can easily be implemented using any number of third-party vendor tools or open source projects for adding chat to a web application. A simple Google search will turn up dozens of options such as the Meebo Bar, https://www.meebo.com/websites/, AJAX Chat https://blueimp.net/ajax/ or the choices here: http://sixrevisions.com/tools/10-free-website-chat-widgets-to-make-your-site-interactive/. These allow the user to open a small window 615 in which they can type text-based messages into a text field 613 that are then added to the end of a conversation that is typically displayed above that text field 614. Any other user that is a member of the conversation can see all messages 614 as they are added to it. Depending on the implementation, the chat application can also allow open up a voice or video connection between the users.

Users can see a list of which of their friends are currently logged into the site and click a button next to that friend's username in order to start a chat conversation with just the two of them in it. Members of the conversation can then add more members in the same manner, by typing in their username or clicking a chat button in a list of online users or on a user's profile page.

It is also useful to have conversations that stay open at all times and are attached to a topic. These are typically called chat rooms. Each application will have a chat room in which users can discuss the application and how to best modify it, or seek help from other users in creating media or modifying code for that application. There can also be an option to see the aggregated chat no only for that application, but all of its derivatives. There may also be chat rooms on more general topics like “Using the Image Editor” or “Javascript Pitfalls”.

Our framework will also allow users to send asynchronous messages to each other within the site. Each user will have a mailbox and be alerted within the interface if he has new or unread messages. They can also set preferences on user account page to be sent by an email when messages are sent to them.

It is often advantageous for more than one user to work on an application. This can happen by way of one user publishing an application privately to one or more other users on her team, then those users modifying it and republishing to the team. In order to facilitate a more fluid collaboration process, the user whose account created and thus owns an application will be able to open up the application for modification by other users. This then doesn't create separate applications at each stage so much as there is a single, unpublished application that all of the authorized users are able to modify. In this context we say that the owner of the application has permission to modify it and that the owner has given permission to the other uses to modify the application. Within this unpublished application there could be a chat conversation 615. Software development is often a collaborative process and many standard aspects of a revision control system http://en.wikipedia.org/wiki/Revision_control can be implemented to allow multiple people to work on the same project without making conflicting changes. The various moddable elements would each have an icon or item in a context menu that would allow a developer to get a “lock” on that element so that only she can modify it. This would be displayed to the other developers to let them know that that a specific other developer is modifying that element and others should avoid it for now, or at least chat with that developer to prevent lost work. Once the developer with the lock has saved her changes, the lock would be lifted and another developer could do the same. For text files, there are standard ways to allow developers to work at the same time. When one developer makes a change, the others are alerted and are allowed to merge in that change. This involves changing the edited lines, removing lines that were deleted, and inserting new lines. When the same line was altered by two developers, they are shown both versions of those lines and allowed to edit them to create a functional combination of the two desired changes. This process of merging is typically applied to entire files, but within our framework could be applied to other units within files such as individual JavaScript functions. It may also be applied to any number of selected lines of text using a context menu that will allow a user to merge the selected lines of text with any lines of text stored in his clipboard after a standard copy operation. The open-source project Etherpad, http://code.google.com/p/etherpad/, could also be used to provide real-time editing of source code involving multiple, simultaneous contributors. Simultaneous editing of source code by multiple contributors may also be implemented by extending the concept of the source model that is kept in memory to maintain a central server-side source model that broadcasts changes to the client-sides of each user using web sockets or long polling.

The owner of the application can give collaborative access to other users in a variety of separate ways or a combination of them. These different permissions could include the ability to only edit certain moddable elements or classes of moddable elements or the ability to add new users to the list of collaborators and specify what permissions they have.

Our framework would also contain discussion forums. These are advantageous to have alongside real-time chat because they persist and allow later users to view past conversations and see if their question has been answered before. Discussion forums are a standard feature of web communities and there exist many different software solutions for adding them to a web application. The forums have threads and sub-forums organized around topics similar to the chat rooms, such as: “Help me make my application” or “Feature Requests”. Users are then allowed to create their threads within a forum in which new posts on that topic are listed in a conversation. The software also typically allows for moderators who either run our framework or users who are given permission to moderate, who can delete, edit, or move posts between categories. Users could be asked at the end of a chat to publish it publicly on the forums so that other users could benefit from what was discussed. By default a chat would be private.

Our framework can also include a market for help with developing applications. Users could post a task they want another user to accomplish for them, or help them with, and a price. This could be a price in an actual currency, such as the U.S. Dollar, or a virtual currency limited to the site.

### Business Model

In order to encourage quality user-generated content within our framework, users may be allowed to earn a portion of the revenue generated by an application. This revenue could come from ads placed around the application during use or modification, or ads placed within the application before it loads or during use, or other sources, or combinations of any of those. This model is similar to YouTube's partner program, http://www.youtube.com/yt/creators/partner.html. The ads could be simple images, Adobe Flash-based, or HTML and JavaScript based. The ad space may be purchased directly on our framework or certain ad space may use a service that rotates ads from many vendors such as Google's AdSense.

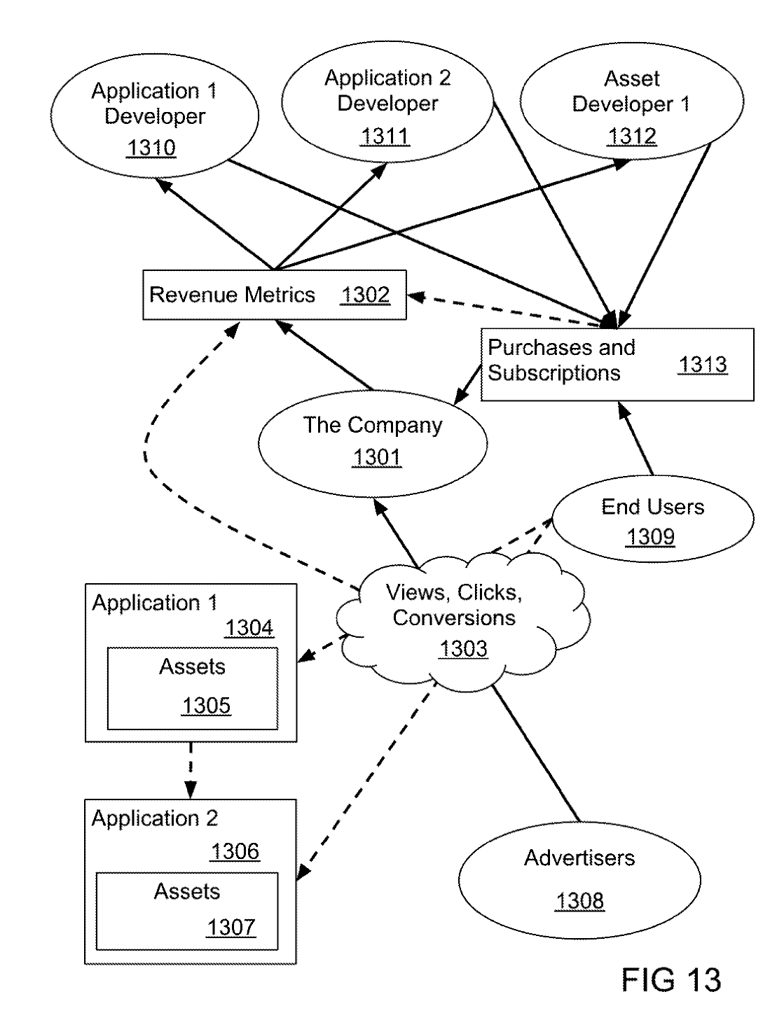

If end-user modification of applications is supported, data would be kept on which applications are modified versions of other applications in a standard descendants' tree 801. We refer back to FIG. 8 which usefully illustrates the role of the descendants' tree even though it does not explicitly show money or other value being passed. FIG. 13 illustrates the various parties involved in various potential business models with solid arrows indicating the flow of money and dashed arrows indicating the flow of information. Each node 805 of the descendants' tree, or family tree 801 would point to an application and its associated metadata, such as the user(s) that created it. If an application 803 is a modified version of some other application 802, its node is a child 803 of that parent application's node 802. For some given application 1304, advertisers 1308 would pay the company 1301, or any other form of business entity, which controls and manages our framework, based on ad views, ad clicks and/or conversions, which are sales completed through ads 1303. The company 1301 would keep a portion of the revenue from the advertisers 1308 and then a percentage of the remaining revenue would be attributed to the developer(s) 1310, 1311, 1312 who created those applications 1304, 1306 and assets 1307, 1305 based on metrics 1302 tying that revenue to the individual applications 1304, 1306 and assets 1307, 1305. The revenue metrics 1302 attribute the remaining revenue to applications 1304, 1306 and the assets inside them 1305, 1307 based on the views, clicks and sales 1303 driven by each application 1304, 1306. Portions of the revenue attributed to each application are then fed upward into the descendants tree 801 and the developer(s) 1310 that created the application 1304 from which another application 1306 was derived are rewarded for their effort with a portion of the revenue that is directly attributable to the derivative application 1306. This is a powerful model because it encourages developers 1310, 1311, 1312 to not only make high quality applications for end users 1309, but also to create applications, or even non-functional templates, that, when modified, become high quality applications for end users 1309.

In order to prevent potential abuse, and especially to allow our framework to adjust for potential abuse, the algorithm by which our framework determines how much revenue trickles up at each level of the descendants tree 801 would most likely be obscured from the user. This algorithm could take into account a “rank” for each application. This could be the greater of: some function applied to that application's direct revenue, the views of that application and others created by the same user, and one plus the same rank calculation applied to its second-highest ranked derivative application. For example, the rank of “Bolt of Thunder” 813 might be much higher than the rank of “I heart Jenny” because one of its child applications 810 might have a very high rank based on its direct views even if “Bolt of Thunder” itself has less direct views than “I heart Jenny” 811. Applications of insufficient rank would be ignored for all calculations. This prevents exploits in which users try to disrupt the fair attribution of revenue up the family tree 801 by placing derivative applications at specific points.

The algorithm could also take into account a “contribution” calculation. Take T(X) to be the total revenue directly attributed to an application, X, and all of its derivatives by the revenue metrics. Let P be a parent application 805, and C be one of its child applications 812. Then a calculation for that application C's contribution might be T(C)/T(P). That is, the portion of the revenue from the tree below the application's parent 805 for which the application 812 and its descendants 813, 810 are responsible. For the example given, the contribution of “Thunderbolt” 812 would likely be very close to 1 as presumably its descendants 813, 810 produce the majority of the revenue in the subtree under its parent 805 since the only other child is “I heart Jenny” 811. A nonlinear formula involving T(C) and T(P) might also be used, or one with a constant multiplier or constant added. A wide variety of other algorithms and elements of algorithms could be used.

To then determine how revenue should trickle up the descendants tree 801, consider the upflow $U from some application A 812 to its parent application P 805 with a grandparent G 803. Assume that all applications of insufficient rank have been removed from the tree 801. Some of A's 812 revenue, $U, will be allocated to P 805, and the rest will be added to P's 805 upflow to G 803. We then must define how much of $U goes to P 805 and the formula can be applied recursively to determine how much of what goes to P 805 goes to G 803. Some function (linear or nonlinear) of the contribution calculation (T(P)/T(G) above) of $U would be assigned to P 805 and then let the rest go to G 803.

One potential unintended exploitation of this arrangement is some user spotting a particularly nice application that he then modifies trivially but uses his superior promotion skills to get far more views, and thus revenue, for his application than for the original application. This would only be an issue if the original application is of insufficient rank to be included in the trickle-up calculation. This may not be unacceptably exploitive as, if the creator of the trivial child application is getting enough revenue from this exploit, all the creator of the original application would need to do is increase his rank to the point where his application is included in the calculation. For example, “Bolt of Thunder” 813 could be almost identical to its parent, “Thunderbolt” 812, but could receive much more direct revenue and, as shown, have many more descendants 810. However, so long as “Thunderbolt” 812 has sufficient enough rank to be part of tree 801 when the trickle-up model is applied, it 812 will receive revenue from its children 813, 810. Of course, other possible adverse exploitations will exist for any formula, but so long as the exact details of the formula are obscured and mutable, these can be accounted for as they arise. Users could also be watched for whatever behavior past analytics data has shown to be exploitive and shown false numbers to prevent them from trying to test exploits. The formula for how much revenue trickles up from one application or asset to another might be something that can be set by the creating user. This could be at the percentage level, or limited to a few optimized choices. This would allow users to control how much they encourage derivative applications by transparently altering how much revenue they will take from their derivatives.

If revenue cannot be directly attributed to an application, a proxy such as page views, or the time spent using an application could be used by the revenue metrics 1302. The revenue given to developers 1310, 1311, 1312 could be real currency or a virtual currency limited to the site or a combination of the two. This virtual currency could be tied to user accounts and displayed as a measure of status and contribution to the community. Users with certain levels of the virtual currency could be given access to certain features to which other users do not have access. The virtual currency could be used by some developer 1310 to pay 1313 some other developer 1311 to help him create his applications or in a donation system to show appreciation for anything a user might want to encourage another user to do. The company 1301 would act as a clearing house for these transactions 1313, taking in real or virtual currency from one developer 1310 and distributing it to another developer 1311, perhaps keeping a percentage off the top. Virtual currency could also allow users 1309 to purchase 1313 merchandise from third party vendors or from a store within our framework or converted to real currency in batches of a certain size. The virtual currency might also be a convenient way to test the trickle-up formula before converting it to use real money. The revenue associated with a user's account might be limited to withdrawal monthly, on some other time interval, or at any time.

The trickle-up model need not be limited to just applications and their derivatives—it can also apply to individual assets 1305, 1307. An asset might be an image, and would have its descendants tree 801 when it is edited by developers 1312. The creator of the derivative asset might have some way to state that his modification is so significant that it should not be counted as a derivative. A portion of the upflow of revenue from some application 1304, as determined by some proprietary formula, will feed into the descendants tree 801 of assets 1305 and count revenue for that asset and thus the user(s) 1312 that created it. This revenue would then trickle up through the asset descendants tree 801 just as it does for applications. Any distinct modifiable element may be considered an asset. Applications designed to be used as tools to modify other applications and bundled by the application's original developer 1310 to be automatically shown to a modifier 1311 of that application can also be considered assets 1305 of that application 1304 and their creators 1312 may be allocated a portion of the revenue attributed to that application 1304.

Another potential source of revenue from our framework would stem from charging 1313 some developer 1310 to make some moddable element of her application 1304 unmoddable. This would be a piece of metadata on the record for that moddable element in the data store that would be checked whenever an element is modified. If the element were set to be unmoddable, any changes some other developer 1311 might try to make to it would be ignored and not saved. This would be particularly attractive to developers 1310 who are brand owners or represent corporate entities who could, for example, make a compelling, high-quality game featuring their logo and in which the logo could not be altered or removed. Then derivatives of that game would provide exposure for their brand. Our framework could enforce that the logo is not only unaltered but not obscured by anything else by examining the pixels rendered to the canvas at the location of the logo periodically as the game runs. Due to the powerful nature of software design it is likely intractable to prevent all possible ways to obscure or change the look of the unmoddable elements, particularly if they are not in a static place at a fixed size. However, it would also not be possible for our framework to automatically determine that the content that is still moddable would not be used to defame the brand, thus going against the brand owner's 1310 wishes. Because of this, our framework would also offer the option to keep all derivative applications 1306 that are published private from other users until they are reviewed and given approval by the creator 1310 of the original application 1304.

Developers 1310, 1311 might also be given the option to designate a portion of an application they create 1304 or modify 1306 in which ads would be displayed and a portion of the revenue from those advertisers 1308 given to the company 1301 would be shared with the developer(s) 1310, 1311 who created 1304 and/or modified 1306 the application. This could be an area where a banner would be overlaid above the application 1304, 1306 while it is running, on top of the iFrame which contains the application 1304, 1306 so that no part of the application 1305, 1306 can obscure it. It could also involve ad space on a moddable element or asset 1305, 1307. In this case the revenue that is shared with some developer 1310 would likely only come from clicks 1303 on the ad or conversions 1303 but not from mere views 1303 so that the developer 1310 is not motivated to include the ad element and not ever show it to an end user 1309.

Our framework might also include a market where developers 1310, 1311, 1312 could buy 1313 and sell moddable assets and services between each other, with the company 1301 acting as an intermediary and keeping some percentage of each transaction 1313. For example, a developer 1310 might put an offer on the market asking for someone to create art for his application 1304. Another developer 1312 might put some sound files on the market which could then be used in an application 1304 for a fee, or for a percentage of the trickle-up revenue of that application 1304.

A developer 1310 could also put his applications 1304 and/or assets 1305 into a market which could then be browsed by advertisers 1308. This application 1304 would have specific elements or areas the developer 1310 designated as potential ad or brand placement slots. The advertisers 1308 would then be able to bid, through the company 1301, on the right to put their brand into the application 1304. This would allow for deeper integration of the branding. For example, a developer 1310 could create a game 1304 in which generic soda cans are shot off of a fence using a slingshot-type interface. That developer 1310 could then post her game 1304 in the branding market, offering to switch the images for the generic cans with those of a specific soda brand designated by the advertiser 1308 with the highest bid. The company 1301 would then take in the payment from the advertiser 1308, which may still be tied to views, clicks and/or sales 1303 and distribute it to the developer 1310.

The front page would showcase certain applications that were popular at the time, or chosen by hand or some heuristic and determined to be high quality—the contribution and rank calculations would be useful for this. The company 1301 might also allow developers 1310, 1311, 1312 to pay 1313 us for their applications 1304, 1306 and assets 1305, 1307 to be featured on the front page where this payment may take the form of an auction where developers 1319, 1311 1312 bid for the featured spots. This featuring would most likely be done transparently in that the applications 1304, 1306 and assets 1305, 1307 would be placed in a section marked as sponsored in order to make it transparent that they were not featured on merit.

The company 1301 may also charge developers 1310, 1311, 1312 on a subscription model 1313. Developers 1310, 1311, 1312 may be charged for using certain advanced features of our framework that are not made available to non-paying developers. Developers 1310, 1311, 1312 may be limited to the number of applications 1304, 1306 they can make over a certain time period unless they have purchased a subscription 1313 to increase that limit or to remove the limit entirely. These subscriptions 1313 may be sold to individual developers 1310, 1311, 1312, or to businesses as a package that extends across a certain numbers of developers 1310, 1311, 1312. The company 1301 may also charge end users 1309 to use applications 1304, 1306, or allow some developer 1310 to designate her application 1304 as requiring end users 1309 to pay the company 1301 per use or on a subscription 1313 basis or to charge end users for content through purchases 1313 from within the application. Developers 1310, 1311, 1312 may be able to publish their applications to various third-party application markets for mobile devices, browsers, or desktop applications, such as Google Play, or Apple's App Store. As part of this publishing process the company 1301 may charge a flat or tiered fee based on the number of sales, or may take a portion of each sale. Developers 1310, 1311, 1312 may also be able to offer purchases within their applications 1304 1306 for which the company 1301 would act as a clearing house and perhaps take a percentage of the transaction before passing the revenue on to the developer of that application.

Another revenue source could be selling the company's 1301 expertise in helping developers make applications. The company 1301 could also charge 1313 for hosting large applications 1304, 1306 based on the server space, bandwidth, and computation used for the server side of those applications. The company 1301 might also charge a subscription 1313 or licensing fee 1313 for businesses that want to leverage our framework's technology to make their content more moddable.

Another revenue source could be providing brand channels within the framework similar to the service offered by YouTube, http://www.youtube.com/t/advertising_brand_channels. This would effectively be an application developer 1310 paying a fee 1313 to the company 1301 to act as an advertiser 1308 for her own applications. Then the application pages 301 for her applications would carry her branding in banner ads 304 and/or in the background of the page 301. Panels such as the related applications 303 would instead be customizable to promote specific applications created by her 1310. A developer 1310 with a brand channel could specify that certain branding elements could not be removed from her applications, and/or that she 1301 needs to approve all child applications before they are published to other users and/or that all child applications must be published to her channel. These restrictions may or may not involve a fee paid to the company 1301 by the developer 1310. Revenue from brand channel fees 1313 could be fed into the trickle-up model in order to motivate other users to create applications and content that is attractive to brands wishing to draw consumers to their channels. This is interesting because it creates a sort of open market in which the public can profit from advertising ideas—an endeavor normally restricted to those working for advertising agencies. The brand channels may also be free, or the fee may take some portion of trickle-up revenue or be based on the number of views or application uses. Branding may also be inserted into the applications so that it is present when those applications are embedded in other pages. It should be noted that the members of the company 1301 are also free to act as developers 1310, 1311, 1312 and generate revenue by creating valuable applications 1304, 1306 and assets 1305, 1307 internally. The company itself 1301 may also do contract work for some external party that would want to privately or publicly leverage our framework's features in an effort to fund the development of our framework for the general public. An end user 1309 makes use of some application 1304 but does not necessarily modify that application 1304 nor did they necessarily create that application 1304. This distinction is useful in discussing who generates revenue and to whom that revenue is distributed, but any user with an account on our framework will be able to take on whatever role they choose, though certain actions on our framework may require a fee to be paid to the company 1301. Developers 1310, 1311, you 1312 and end users 1309 could be individuals or their accounts could represent a business or other corporate entity.

The potential business models described above may be used in any given combination. For example, the revenue from end users 1309 paying 1313 the company 1301 to use some application 1304 would then be considered as part of the revenue attributed by the metrics 1302 to that application 1304 and its assets 1305 for the purposes of the trickle-up model. In general, in any model where the company 1301 acts as a clearinghouse or intermediary in some transaction it will reserve the right to take a percentage of that transaction as part of the business model and use that revenue in other business models.

### Copyright Matters

Some basic legal issues arise from the ability of users to add content to our framework through uploading it or creating it within our framework. The Digital Millenium Copyright Act, or DMCA, requires that companies managing frameworks of this nature provide a contact point through which copyright owners can request that content that infringes their copyrights be taken down. This will be provided, as is standard, as a hyperlink at the bottom of each web page that links to another web page detailing the standard DMCA language and contact info for a representative of the company that handles such requests. If a piece of content is taken down, it can be replaced with something indicating that the reason is DMCA based. A violating image can be replaced with an image of similar size, generated programmatically, or one of a fixed size, that states “This content was removed by a DMCA request”. An audio file can be replaced by a short clip saying the same thing. A video file can be replaced by a short video clip with that same audio and a still of the aforementioned DMCA image. Infringing text could be replaced with that same notice in text. If an entire application needs to be removed, it can be replaced by a placeholder application with one large image with the same notice.

When some piece of content is requested for takedown, it may be mentioned by the copyright owner that any modified versions of that content might also be infringing and should be taken down. Generally the requirement for DMCA takedown requests is that each infringing piece of content is mentioned separately. While it should be possible to walk the descendants tree 801 for moddable assets and apply the takedown procedure to each child of the infringing asset, this may not conform to the legal requirement and may be presumptuous as that asset may have been modified in a way such that it no longer infringes the copyright in question.

It is now common for content creators who are conscious of copyright concerns to attach a license to their work that does not reserve all rights. The creative commons organization, http://creativecommons.org/, publishes a myriad of licenses that give various levels of freedom to the public with certain requirements and restrictions. These licenses are widely used as they allow content creators to customize their copyright and allow for certain types of reuse without having to delve in the legal details themselves, though they are also free to create their license, of course. A common requirement for these licenses is attribution—the original creator must be credited in some way. When a user uploads some piece of content, our framework can offer them the option to attach attribution to it in the form of a text description that could contain a name, a link to a website, or any other informative text. This text would then be stored in the associated metadata for the application. Each application with attribution metadata of this sort would then expose a button or hyperlink that would show a web page or popup window displaying the aggregated attribution information for all assets in the application. Thus application developers would be able to use more media without resorting to things such as watermarks on images for attribution.

While it may not be required by the law, it may be in the best interest of our framework to encourage original content creation and the license-compliant use of third-party content, thus minimizing DMCA takedown requests that might disrupt otherwise useful and entertaining content on our framework. YouTube addresses this issue by their ContentID system, http://www.youtube.com/t/contentid. Content creators are invited to provide YouTube with samples of content that YouTube then checks any uploaded content against for similarity. A simple implementation of this would be to run any hash function on the sample files which is then stored in a database. When new content is uploaded it can have the same hash function applied to it and if the hashes are identical, then the content provider that uploaded the sample can be alerted and allowed to request that the content be taken down or that they be compensated in some way. More robust methods of identification could also be used that hash different portions of the content file to check for just a portion of the sample content being uploaded into our framework.

There is potential for these copyright violations to take place within our framework. For example, user A might draw an original image and, in order to steal credit for that image, user B does not modify it within our framework, but rather downloads it and re-uploads it into our framework as if it were his own. It is in the best interest of our framework to provide tools and checks that discourage such practices, but these practices exist in the world at large and there are many ways to resolve the conflicts they create. The users of our framework are free to issue DMCA takedown requests against other users and to leverage the court system to resolve their disputes.

The relevant copyright laws will continue to evolve over time and new ones may be created, but our framework can continue to adapt to be compliant with the law. There may also be separate copyright concerns in countries outside the United States that can be addressed in similar ways.

### Audio Editing

Another major media component of many applications is audio items, which are stored on our framework as part of the media files for applications 212. We use the term audio items, or sounds, broadly to include, for example, any file that depicts or records an auditory perception or any audible representation of that file. For example, a file that can be played by software to produce a song or sound effect or any file of one of the audio formats supported by web standards. Videos and video files often contain an audio track that is synced with their visual timeline and may or may not be extractable from that visual timeline. Just as with images, audio can be imported into our framework from a user's file system 129 backed by a hard disk or solid-state drive, or fetched from a URL where the image is already hosted on some web server, or captured from a hardware device 128, like a microphone, attached to his computing system. The HTML5 standard has APIs for accessing devices such as microphones on desktop and mobile devices but not all browsers, desktop or mobile, currently support them. If a browser does not support audio capture or access to the disk, this gap can be bridged by non-web-standards compliant techniques such as using Adobe Flash in the browser, or a native application wrapper for mobile devices. Again, it may even be advantageous to have a lightweight mobile app that is designed to capture media, like images, audio, and video and place that media in a user's library for later use on our framework.

Audio-related features are a portion of the HTML5 standard that is in flux. The final standard will likely be close to the current definition of the Web Audio API, https://dvcs.w3.org/hg/audio/raw-file/tip/webaudio/specification.html. The Web Audio API is based on nodes that make up an AudioContext. Audio input enters through a AudioSourceNode that has one input and can have many outputs, and is played by a AudioDestinationNode that has one output and can have many inputs. Along the way, the audio stream can be passed through intermediary nodes that can change the gain (i.e. volume), balance, and apply various standard and customizable filters to multiple inputs and send them to multiple outputs. A more readable guide to the Web Audio API can be found at http://www.html5rocks.com/en/tutorials/webaudio/intro/.

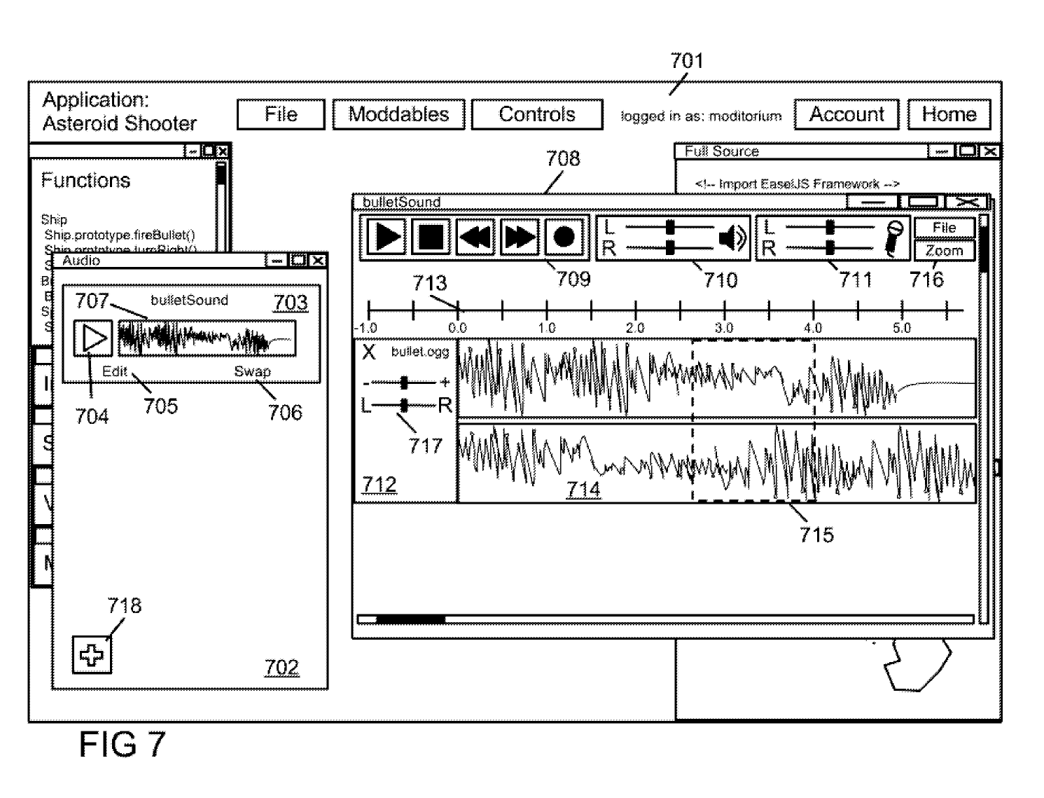

FIG. 7 shows a more detailed view of the development interface web page 209 in a state which is focused on modification of the sound of an application 701. Our framework will parse the client side text files 213 for references to audio files, either with inline content via data URL 111, or as references to an external URL 112. These are easily parsed using regular expressions that look for the data URL format, HTML audio tags, and audio file names with extensions denoting that they are in one of the file formats supported by web standards. These audio files will then be listed in the sounds moddables subwindow 702 shown undocked in FIG. 7, and previously in FIG. 5 as one of the docked and collapsed moddables subwindows 510. Each sound will be represented by an interface 703 that features a button which will play or pause the sound 704, supplemental information, and controls to swap it for another sound 706 and to edit the sound 705, if audio editing is supported. The supplemental information may include items such as the audio filename or the duration of the sound. The interface may also contain a view of the waveform of the sound 707 which might be generated by native APIs or using open-source tools on the server side 207 to generate an image that would then be saved as a separate file, stored with the media files for applications 212 and linked to the audio file by metadata in the data store 220.

When the swap control 706 is clicked, an interface is opened in which the user can upload an audio file from his file system, capture a new audio file from a device, import an audio file from a URL, or select an audio file from a gallery of audio thumbnails such as the thumbnail 703 in the audio moddables window. This interface is similar to the one described for image swapping as represented in FIG. 12 but using audio thumbnails 703 instead of image thumbnails 1203. When any of these actions is performed, the client source model is altered so that references to the URL of the swapped audio file are replaced by the URL of the new audio file which is stored as one of the media files for applications 212 on the server side for developer applications 207. The gallery of audio thumbnails is a grid of audio thumbnails with an interface to navigate between various categories. The category navigation, tagging, folders, and recommendation will work as described for the image gallery that is exposed when the image swap link 605 is clicked.

If audio editing is supported, clicking the edit link 705 on a sound moddable interface 703 will open that audio file in an audio editor subwindow 708. This editor subwindow will contain an interface with basic audio editing functionality similar to the open-source product, Audacity, http://audacity.sourceforge.net/.

There have existed many software applications focused on audio editing and a standard timeline-based interface has evolved for applications in this space. Just as with the image editor, we will not discuss this standard interface in detail, but will instead focus on how the functionality can be implemented using primarily web standards compliant code.

The standard timeline-based interface involves displaying one or more tracks 712 in rows which are all synchronized along a horizontal timeline 713. Each track has the audio it will play represented by a horizontal area under the main timeline which can be considered the track timeline 714. The track timeline, which may be split between the left and right channels if the audio is stereo, may display the waveform of the audio track as previously described. The gain or balance of each track can be controlled independently of other tracks using controls along the left 717 that also allow the user to remove that track from the list. Clicking within the track's timeline 714 allows the user to set a cursor where the playing of that track will start. Dragging within the track timeline allows the user to select a portion of the track timeline 715. Selected timeline portions 715 can then be altered using a context menu or other interface of buttons from which various commands and filters can be selected. At the top of the interface lies the standard play/pause, stop, fast-forward, rewind, record interface 709 that will control the main timeline 713 and thus mix all tracks at once. There are also global controls for the left and right channel volume 710 and input level 711. There will also be buttons for zooming in and out on the timeline and performing file operations such as saving and opening 716.

The Web Audio API allows for this kind of audio editor to be implemented in a reasonably straightforward manner. Each track's input file can be loaded into an AudioBufferSourceNode that eventually outputs to a single AudioDestinationNode. The global output control 710 can be implemented as single AudioGainNode that the output from each track feeds through immediately before the AudioDestinationNode. Individual track balance and gain controls 717 can be implemented using AudioChannelSplitter and AudioGainNodes prior to the track being mixed into the global effects and AudioDestinationNode.

When a section of a track timeline 714 is selected 715, various operations can be performed upon that section 715. For example, it could be removed, or time-shifted in some way. The AudioBufferSourceNode provides a noteGrainOn function that feeds the input audio data to the outputs and takes parameters to set the following properties: a delay in seconds to wait before outputting audio data; an offset in seconds that is the location within in audio data at which output begins; and a duration in seconds that defines how much of the audio data, after the offset, should be played. Combinations of calls to noteGrainOn can thus simulate the removal, duplication, or time-shifting of any selected section 715 of audio track 712 without actually altering the input data in memory. The editor would have an audio node model in memory that holds the node structure needed to represent the changes made to the timelines for each track. For example, let's imagine that a user cut the portion of the original audio clip from 1.0 seconds to 2.0 seconds and inserted it at the original clip's 4.0 second mark by dragging it to that location. Then noteGrainOn could be called for the clip with no delay, no offset, and a duration of 1.0 seconds to cover the interval of the post-edit clip from 0.0 to 1.0 seconds. It would also be called with a delay of 1.0 seconds, an offset of 2.0 seconds, and a duration of 2.0 seconds to cover the interval of the post-edit clip from 1.0 seconds to 3.0 seconds. It would be called again with a delay of 3.0 seconds, and offset of 1.0 seconds, and a duration of 1.0 seconds to cover the post-edit interval from 3.0 seconds to 4.0 seconds which is the interval from 1.0 seconds to 2.0 seconds in the original source clip.

An interface could also be provided to apply various filtering nodes defined by the Web Audio API to selected track timeline sections 715 or whole tracks 712. One such node is the AudioPannerNode which can define a directional audio source and listener in three-dimensional space accounting for velocity and doppler shift. Another is the BiquadFilterNode which can apply traditional audio filters such as “low pass” or “high pass” to the input data. Yet another is the ConvolverNode interface which allows for the application of linear convolution effects such as the simulation of acoustic spaces like an amphitheater or cathedral. The ability to apply these filters could be exposed in a context menu shown when right-clicking on the selection, or in a button interface. Once a filter is chosen, the user can be presented with a standard form to alter the attributes and provide input to the methods for that particular node type as defined in the Web Audio API specification. Then the audio node model would be updated to include the necessary nodes set up as defined by the user through the form interface. When necessary, one track in the audio node model might be split into multiple AudioBufferSourceNodes to simplify the timing of changes to the intermediary nodes.

When a recording is made outside of the ideal silence of a studio setting there is often background noise that reduces the quality of the resulting audio file. Audio editing software, such as Audacity, often includes a noise removal tool. This type of tool typically allows the user to select a portion of the audio file that would ideally be silent if there were no noise. Fourier analysis is used to create a fingerprint for the noise built out of a spectrum of pure tones. Then each short segment of the audio file is examined with Fourier analysis and compared to the noise fingerprint. Those pure tones in each segment that are not significantly louder than in the noise fingerprint are reduced in volume, thus removing the noise and preserving the audio that was on top of it. This process is called noise gating http://en.wikipedia.org/wiki/Noise_gate. The Fourier analysis of audio data can be performed using the Web Audio API's RealtimeAnalyserNode and JavaScriptAudioNodes can be used to apply AudioProcessingEvents to the raw audio data.

In order to save the audio data in the form that it can be played by the audio editor subwindow 708 it must be retrieved in the form that reaches the AudioDestinationNode. As discussed, the Web Audio API is still in development and at the current time lacks a clear API for saving the audio stream that reaches the AudioDestinationNode to a file or datauri. Given the stated goal of the API being able to produce musical applications, https://dvcs.w3.org/hg/audio/raw-file/tip/webaudio/specification.html#musical-applications, we can presume that some clear way to export the final audio stream into a file will be provided eventually. For now, saving the final audio stream to a file can be accomplished by placing a JavaScriptAudioNode directly between the AudioDestinationNode and each of its inputs. The JavaScriptAudioNode then processes AudioProcessingEvent by using the getChannelData function on its inputBuffer to get the raw PCM data for each channel, which it then writes to that same channel of the AudioProcessingEvent's outputBuffer. Thus the audio data is not altered in any way along its path to the AudioDestinationNode. In addition, the JavaScriptAudioNode would copy the channel data from the AudioProcessingEvent's inputBuffer into a new ArrayBuffer for each channel. The raw PCM data for each channel can be sent to the server side for developer applications 207 and converted to any number of desired audio file formats using standard open source audio processing tools such as LAME, http://lame.sourceforge.net/links.php, and ffmpeg, http://ffmpeg.org/. The audio files would then be stored with the application media files 212. A drawback of this approach is that the entire audio clip to be saved would have to be played in order for the data to pass through the JavaScriptAudioNode. An AudioGainNode can be placed between the JavaScriptAudioNode and the AudioDestinationNode to reduce the volume to zero so that the user does not have to listen to the clip, but the user would still have to wait for the clip to play before it could be sent to the server to generate a new audio file. It may be feasible to adjust the playbackRate attribute of the AudioBufferSourceNodes, adjusting the parameters of their calls to noteGrainOn accordingly, in order to speed up the playback and thus the process of saving. This increase in rate would then be communicated to the server along with the PCM channel data so that the server-side audio libraries could reverse the rate increase before saving the new audio file. The raw PCM data could also be processed into the WAV file format on the client side using the techniques exhibited by the riffwave.js project, http://www.codebase.es/riffwave/.

Just as with the image editor subwindow, the audio node model could be saved in a serialized format with the client side text files and tied with metadata in the data store 220 to the rendered audio file that is stored with the media files 212. This would allow further editing of the audio file by the same user, or, if end user modification of applications and assets is supported, other users, using the original tracks, inputs, and timeline effects instead of the single audio track that was rendered from them.

Since not all browsers on all devices may support all audio file formats, it may be necessary to keep several copies of each audio file in different formats in the application media files 212. Metadata in the data store 220 would tie these together as the same file and the server side for developer applications could propagate any changes to one file format to the other formats by converting the altered file format. Then the client sides 202, 203 would detect which format was best supported by the device and browser in which it is running and request only that file type.

If the Web Audio API is not supported by some device, or is lacking some feature that is desired, it should be possible to write a web service using the well established open source audio processing software and techniques as described previously. So long as audio data can be accessed and sent to the server side for developer applications, that data, along with encoded user actions, can be processed by a web service that would then respond with the altered audio file. This may limit the features that could be offered, such as filters, but simple editing could still be supported by sending the web service the source audio clips and various time interval information defining what portions of those clips should be combined in what order to make the edited file. This approach, using ffmpeg, is discussed in more detail with respect to video editing later and can be applied in the same manner to audio files, using that same library. Javascript libraries such as audiolib.js, https://github.com/jussi-kalliokoski/audiolib.js/, may also be useful for bolstering the Web Audio API or lack thereof on the client side.

Our framework will offer a library for loading sounds just as it does for loading images. This would expose WI.addSound and WI.loadSounds functions that mirror the WI.addImage and WI.loadImages functions described earlier. As with the image loading, this would allow for an “add sound” button 718 that would open a sound gallery interface similar to the interface opened by the swap link 706 which is similar to FIG. 12 and allows for the capture, upload, creations or selection of a new audio file from the gallery. This interface will interact with the client source model and the WI.addSound and WI.loadSounds calls just as “add image” button interacts with the WI.addImage and WI.loadImages once a sound has been selected.

### Discovery

In various places where our framework displays content such as user applications or moddable assets like images, sounds, and code elements, a recommendation engine may be used to optimize which content is presented to the user. This could be used to highlight the best applications on the front page of our framework, or to choose which parts of the application family tree 801 are zoomed in or out, or to choose which moddable elements are featured in each moddables pane 510, or to select which related applications 303 to display on our framework application web page 301.

The examples given above are meant to illustrate the broad use cases for the filtering of content. Many more will likely present themselves within our framework. Platforms for user-generated content such as YouTube or even industry-generated content such as Netflix face a problem of scale in which the sum of their users desire a massive amount of content, but any individual user would never tolerate having to manually search through that content for what they personally want.

There are a plethora of solutions focused on searching content, many of which can be used by a web application internally, such as Google's enterprise search products http://www.google.com/enterprise/search/index.html. Our framework can implement one of these many search solutions to allow users to search 315 for applications, users and moddable assets based on their tags, description, or textual content. The media galleries exposed when a swap control 605 is clicked could expose this same search functionality limited to a specific type of moddable asset. Individual editor subwindows 519 or moddable lists 521 could also expose a search tool that would limit the list to assets within that application whose tags, description, name, or textual content match the entered text. For example, the function moddable list subwindow 521 would allow users to type in “fire” and see a list of functions within that application whose names, tags, code, or comments contain “fire”. These search tools could have the now-standard auto-complete functionality that allows the user to type only the beginning of a search term and see a list of possible search terms they might want to use.

Searching assumes that the user knows enough about what she wants that she can express her desire in text, and that the content she's looking for has associated text that can be matched to her query. It is the job of the recommendation engine to present content to a user based on both explicit data, such as application ratings 309 entered by users on our framework application web page 301, and implicit data, such as what content users select when searching for certain keywords or what applications are used by the same user.

If nothing is known about a user, a simple recommendation engine might just show them the most popular applications ranked by, say, average user rating, or total time of use. Even if the user is not logged in, some things may be known such as her location based on IP address, or her operating system and browser. This information could be used to limit the popularity ranking to behavior exhibited only by those specific demographics. Once a user has an account, any indication of preference, such as repeated use of an application, or rating an application, can be used in a simple Bayesian inference (http://en.wikipedia.org/wiki/Bayesian_inference) engine. This effectively adjusts its estimate of the probability that a particular user will like something by weighting more heavily the ratings of other users who typically rate applications in the same way as that user.

Our framework can leverage advancements made as part of Netflix's famous one million dollar challenge to improve their recommendation engine for movies. A paper, http://public.research.att.com/˜volinsky/netflix/sigkddexp.pdf, describing the techniques used by the winning team details that their engine used the kth-nearest-neighbor algorithm, http://en.wikipedia.org/wiki/K-nearest_neighbor_algorithm, to account for local patterns, latent factor analysis, http://en.wikipedia.org/wiki/Factor_analysis, to account for global patterns, and a “binary view” which doesn't incorporate the actual user ratings, but rather what types of items were rated at all, modeled by a conditional restricted Boltzmann machine http://www.cs.toronto.edu/˜hinton/absps/uai_crbms.pdf. The teams attempting the challenge were given historical data for a number of users and their ratings and asked to predict future ratings from those users for a number of movies not included in the historical data. The paper points out that teams were only given explicit data, but that myriad implicit data, such as viewing habits, could also be captured by systems such a Netflix. They see the “binary view” technique as a proxy for some of this implicit data and their success in combining it with explicit ratings as an implication that implicit data can be a powerful tool for recommendation engines.

Another source of implicit data is the social graph created by a user's ability to list other users as “friends” and to put them in specific named groups with which content can be shared. The recommendation engine may take these connections into account to classify users and weight other implicit and explicit data based on those classifications. Our framework's recommendation engine may use a combination of the techniques listed above, or perhaps others found in the massive amounts of available research literature on the subject. Our framework may also use a third-party recommendation engine such as Oracle's Real-Time Decisions, http://www.oracle.com/us/solutions/ent-performance-bi/real-time-decisions-066561.html, or a socially focused engine like Whit.li, https://www.whit.li/.

Other sources of recommendation data might come from the nature of the application family tree 801. For example, it may be advantageous to recommend to users the first common ancestor of their most highly-rated applications, or its most popular descendants. This application was the source for many things the user enjoys, so they may enjoy modifying it or some of its other siblings.

### Gnosis Mode

If end user modification of applications is supported by our framework, one challenge will be that users seeking to modify an application's behavior will need to witness the current behavior, have an idea of how they wish to change that behavior, and then figure out how to implement that change. Implementing the change involves discovering which portion of the application's source code controls that part of the application's behavior. Comments and other forms of documentation such as well-chosen names for modules and functions can aid in this discovery, but it would be more desirable to visually tie the behavior of an application to the code that controls that behavior. Our framework may include the option to display what functions are being called in a way that is tied visually to the displayed application objects on which those applications are called. We'll call this option “gnosis mode”.

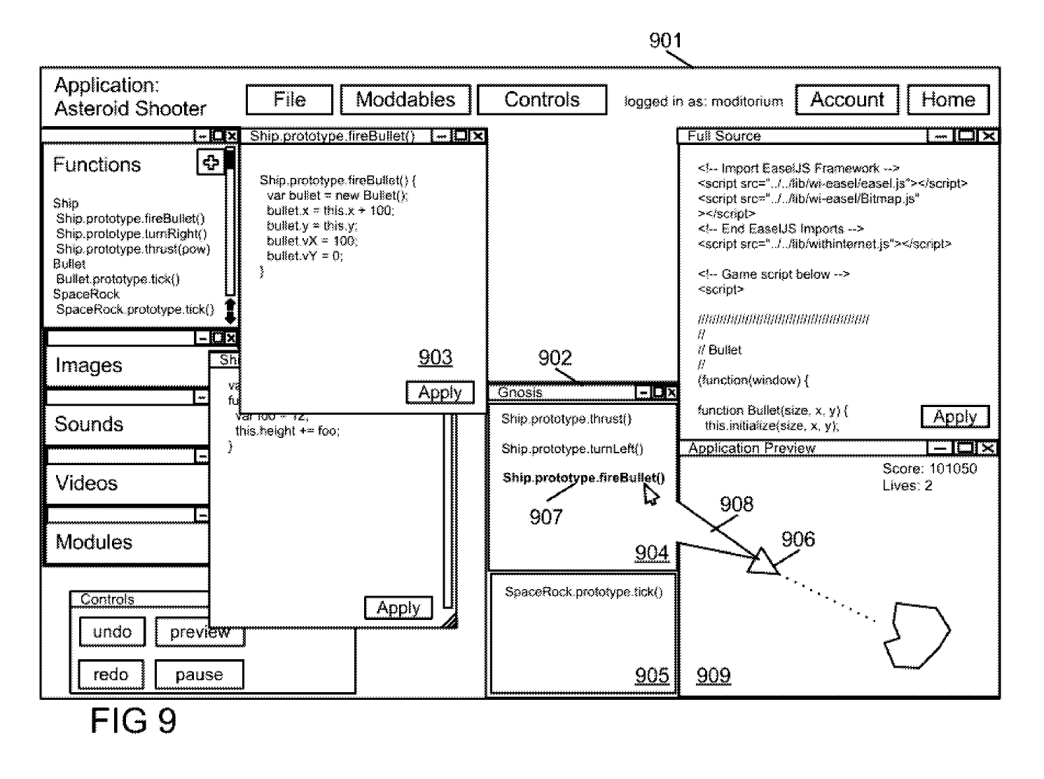

FIG. 9 shows the application editing interface 901 in a state that includes a gnosis subwindow 902. In a general sense, gnosis mode involves the display of which functions are being called by which object during the real-time use of the application. This requires that each time a function is called, it also calls some function to display its name. In JavaScript, the syntax “for(var x in obj)” iterates through all attributes of the objects obj and places their names, in turn, into the variable x. Those objects can then be checked to see if they are functions using “typeof obj[x]=‘function’”. Then each function, f, on an object can be replaced by a function, g, that first calls a function to display the f's name, and then uses f's “apply” function to call f with whatever arguments were passed to g. This effectively inserts the call to the name-displaying function into every function on the object which those objects are in memory and the application is running Our framework could then provide an API for developers such as “WI.exposeGnosis(obj)” which would apply this to the given object. This function could also be called on all objects automatically by our framework. Another method would be to take the parsed list of functions and insert, as the first line of every function after its opening brace, a call to the function that displays that function's name. This line could then be removed or obscured when the function's code is displayed in an editor subwindow 903 so as to not confuse the developer with non-behavioral code.

The function calls will be displayed in a gnosis subwindow 902 which will have areas 904, 905 in which it displays the recent function calls for each object in the application. In any given area 904, all function calls made from its associated object 906 within a specific time interval, say, sixty seconds, are displayed. The order of the functions from top to bottom is determined by how many calls to that function have been made during the time interval, with the most commonly-called functions being listed at the top. Functions that have been called within certain sub-intervals of the time interval can be displayed in a different color from those that have not been called as recently. For example, a displayed function name 907 could be colored red when it is first called, and then slowly fade to green until it is called again, and changes back to red, or until the time interval elapses, and it is no longer shown. The time interval for which functions are displayed could be exposed for customization by the user. Other visual aspects of the function names, such as font size, may be used to indicate other properties. It may be determined that these visual aspects should be tied to properties in a different way than described above.

If the application supports pause functionality, with or without saving game state, the list of called functions could be maintained in the state it was in when paused. This same behavior could also be implemented by having the called functions not fade with time unless some other function has been called. Our framework could also use the canvas element's drawImage function to pull the pixel data from the canvas into images, thus storing past frames written to the canvas in such a way that they are tied to a specific time signature. These could be stored in memory, or sent to the server side for user applications 207 for temporary storage. This storage may have other applications, but if it is only done when gnosis mode is present, it would allow our framework to provide a rewind functionality for any canvas-based application. The function calls 907 displayed in gnosis mode would be saved with time indices and displayed along side the stored canvas frames for some fixed time interval in the past. As the application was used, old frames and function call data outside of that time interval would be overwritten with the new data. Thus a user could click some rewind control, or drag a slider along a timeline, and be able to more closely inspect exactly when certain functions were called and what was displayed on the canvas at that time.

An arrow 908 from the function name display area 904 to the visual display of the object 906 in the preview window 909 can be displayed in order to be specific about which area is tied to which object. This would rely on the object having some part of its state indicate its position, such as attributes like x and y to denote its position in the Cartesian coordinate system of the preview window 909. These arrows can be hidden unless the area 904 is clicked on or moused over to avoid clutter. If the position of the displayed object 906 cannot be determined from its properties, the visual link may still be exposed by changing how the object looks. For example, an object that has properties defining the color and weight of its border can thus have its border altered by changing those properties with JavaScript so that the border color of the displayed object 906 matches the background color of its function display area 904. Our framework can also support an API by which JavaScript objects can pass a reference to a function to a library function such as WI.addGnosisCallback(functionReference) and that referenced function will be called on that object when it needs to be visually tied to its function display area. Thus an application developer can make all objects implement such a function and whatever that function changes visually about the objects will take place when, say, the respective function display area 904 is moused over.

Instead of displaying the lists of functions 904, 905 for each object in a subwindow 902, it may be more advantageous to display them overlaid on top of the preview subwindow 909 near each object to which they apply 906. This could be done with code injected into the application that would display inside the preview iFrame 909, or may be on an HTML element that is external to the preview iFrame 909 but with a z-index that causes it to display on top of the preview iFrame 909.

Since an important purpose of gnosis mode is to tie behavior to the code that can be changed to alter that behavior, the displayed function names 907 can be clicked to open a function editor subwindow 903 for that function. In order to reduce clutter, it may be advisable to have the function display areas 904 act as subwindows and be movable, collapsible, dockable, and closable. The user would open the gnosis mode subwindow 902 from a context menu on the preview subwindow 909. It may also be advantageous to show a more prominent button or pop-up notice to promote gnosis mode which would then open the gnosis subwindow 902 when clicked.

### Function Modding

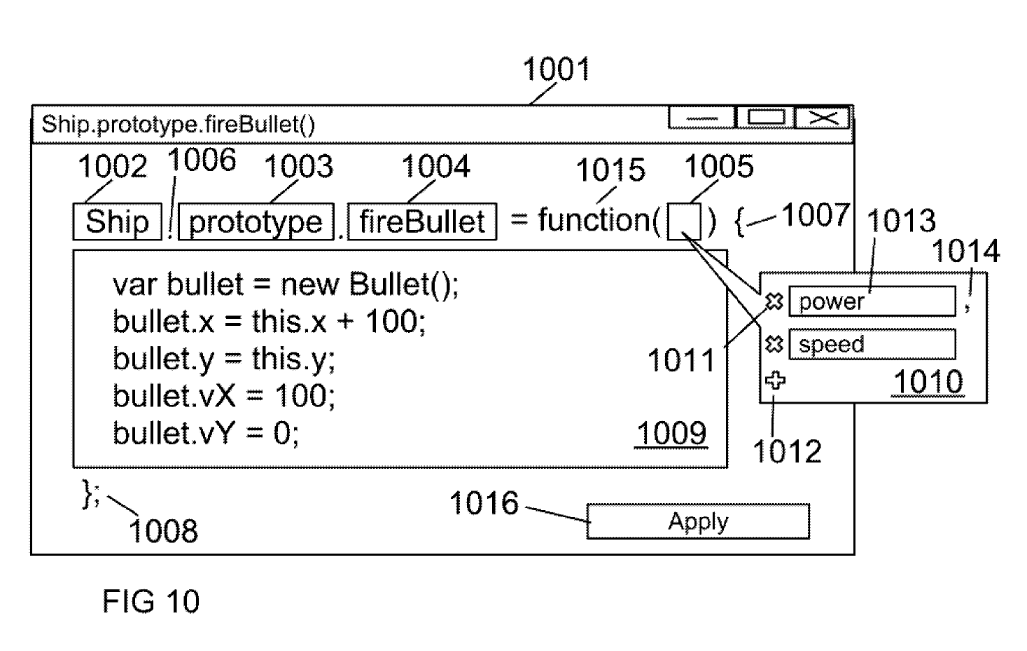

FIG. 10 shows an alternate interface 1001 for the function editor subwindows 518, 519 discussed earlier. The goal of the interface is to remove or reduce the ability for inexperienced developers to make common syntax errors while still displaying proper syntax and providing the flexibility to alter the function in any way possible. It can be frustrating, especially for inexperienced developers, to have written code that contains the logic desired, but in a slightly incorrect format that then cannot be parsed and run. One approach used to mitigate this is to underline or otherwise highlight syntax mistakes as is done with spelling errors in word processing software. This technique will be employed by our framework using the aforementioned JSHint library which, when run on a portion of JavaScript code, returns a list of errors and the locations of those errors and can be customized to ignore or include certain rules that more enforce coding style than syntax rules. This type of highlighting can still be confusing to a developer though. Various programming interfaces, such as MIT's Scratch, http://scratch.mit.edu/, try to prevent syntax errors by removing the elements that a developer might not want to edit, such as the opening 1007 and closing 1008 braces, altogether. These interfaces then turn elements of code, like functions or “if” blocks, into puzzle pieces that only fit with the puzzle pieces for certain other code elements. The customizable parts of these code elements are then exposed through form controls. This approach, however, does nothing to show the user how raw, text-based code might actually be written.

In JavaScript, and many other languages, a function is defined by elements that give it a name 1002, 1003, 1004, elements that define its inputs 1005, a function keyword 1015, elements that define the boundaries 1007, 1008 of the function's internal code, and the internal code itself 1009. When editing full source code, it is necessary to edit all of these elements freely. For example, it is necessary to be able to type a closing brace followed by a semicolon 1008 in order to denote that any text following those characters is no longer part of the function whose internal code lies between those characters and the most recently unmatched opening brace 1007. However, the function editing subwindows 1001 are designed to allow developers to edit at the level of a single function. When changing an individual function, it is not necessary to change the opening 1007 or closing 1008 braces. Nor would one wish to rearrange the elements that name the function 1002, 1003, 1004, or the periods that delineate their namespacing 1006, or the fact that they are followed by the function keyword 1015 and a list of arguments enclosed in parentheses 1005. The relative position of these elements is dictated by the syntax rules of the language. Some allowances for style can be made, such as placing the opening brace 1007 on the line after the arguments list 1005, but any actual reordering of the elements will produce an error.

n the alternate function modding interface 1001, the internal function code would be displayed and edited in a codemirror instance 1009 as previously discussed. The name of the function would be split into separate editable fields 1002, 1003, 1004, one for each namespace component delineated by periods 1006 that cannot be edited. These name components could have custom editing features, such as the ability to detect if the first component 1002 is referring to a module as parsed from the full source, and if so, providing a list of other modules to choose from in addition to the ability to type a new module name. Beginning the first field with a capital letter indicating, by convention, that it is referring to a module, if the typed name does not refer to any known module, the interface could warn the user that they likely have a typo. The final namespace field 1004 could be properly called function's name. What comes before it is more about a hierarchical scope in which the function lives. Since two functions are not allowed to have the same name within the same scope, edits to this field 1004 can also be validated by checking against the list of parsed functions. If one is found with the same overall name and scope, a warning could be displayed, with the option to start editing the existing function with that name.

As in many languages, the list 1005 of inputs, or arguments, to a function is placed after the function name, enclosed in parentheses. This list 1005 is shown as empty in the figure, which indicates that the function takes no arguments. When the editable list 1005 is clicked inside, it can expand to fit new argument names that are typed inside along with the commas that separate them. It may also expose an interface 1010 where separate editable fields for each argument name 1013 are exposed, with a button to add a new argument 1012, or delete existing arguments 1011, but not allowing the user to edit the commas 1014 that must come between those arguments. The enclosing parentheses around the argument list 1005 would not be editable. The opening 1007 and closing 1008 braces, function keyword and equal sign 1015, and semicolon would also not be editable.

As previously mentioned, the internal function code will be presented in a codemirror editor 1009. The other editable fields 1002, 1003, 1004, 1005, 1013 could be standard HTML input tags. Any syntax highlighting needed could be implemented as a simple style on the input tags since their content would only ever be highlighted on color since no input tag can contain multiple different types of words with respect to syntax. The syntax elements that cannot be edited 1006 1007 1008 1009 1014 1015 but are displayed amongst and around the editable fields to provide context can be held in HTML span elements. CSS then allows all the elements to be positioned in a way that follows standard coding conventions. If the code of the function, as written in the full source, is written in a style that would not lay out well, such as putting the first line of the internal function code 1009 on the same line as the opening brace 1007, the code can be parsed using one of the aforementioned JavaScript parsers and formatted to meet the standards of the interface. Another option are the various “beautifiers” that are designed to be run on JavaScript code in order to automatically enforce customizable style rules. When changes are made to the editable interface elements 1002, 1003, 1004, 1005, 1013, 1009, their content is concatenated with the uneditable displayed syntax 1006, 1007, 1008, 1014, 1015 in the order that is displayed, to produce the full code for the function that is then updated in the source model.

A similar interface to 1001 could be used for modules, which also have specific syntax surrounding an internal block of code. Inasmuch as those modules contain functions, each function could have the alternate interface 1001 embedded inside the module alternate interface. If server-side code is supported by our framework, the alternate function interface could be naturally adapted to other languages that are supported on the server side by following the same paradigm of editable fields for elements that can be changed, and uneditable syntax elements displayed in their proper places amongst and around those fields.

As with the earlier interface for function editor subwindows 519, changes made in the alternate interface 1001 could be pushed to the client source model instantly, or at a regular interval, or only when the apply button 1016 is pressed.

### Video

As with audio files, there is currently poor cross-browser support for the video file formats described by the HTML5 video specification, .mp4, .ogg/.ogv, and .webm. We use the term video broadly to include, for example, any file that depicts or records a visual perception that changes consistently along a timeline and may or may not have audio associated with that timeline or any visual representation of that file with or without the audible component. For example, a short clip from a television show or a home movie taken with the camera on a smart phone or any file of one of the video formats supported by web standards. This is distinct from images and images files which support animations such as the GIF format http://en.wikipedia.org/wiki/Graphics_Interchange_Format, support animations. As previously stated, video uploaded or captured to our framework may need to be converted into all three file types in order to ensure that each browser and device combination would support at least one of the types. These different copies of the same video file would be stored on the server side for developer applications 207 along with the other media files 212 and tied to each other through metadata in the data store 220. Then each video tag can have multiple source tags automatically inserted into it, each referring to a different file type with the same video content so that the browser can request and play the type that it supports on that device. This page goes into more detail on the current state of HTML5 video file type support: http://www.html5rocks.com/en/tutorials/video/basics/#toc-formats.

Video files can be imported into our framework from a user's file system 129 backed by a hard disk or solid-state drive, or fetched from a URL where the image is already hosted on some web server, or captured from a hardware device 128, like a camera, attached to their computing system. The HTML5 standard has APIs for accessing devices such as cameras on desktop and mobile devices but not all browsers, desktop or mobile, currently support them. If a browser does not support image capture or access to the disk, this gap can be bridged by non-web-standards compliant techniques such as using Adobe Flash in the browser, or a native application wrapper for mobile devices. If a user tries to upload a video to our framework that is not of a file type supported by web standards, it can be converted by the server side for developer applications 220 into a supported format. Video conversion can be performed used standard server-side libraries as we will discuss later. Uploaded video files would be stored in a user's video gallery, with tagged categories and perhaps hierarchical folders as described for the image and audio galleries and with the same upload, capture, import and search capabilities. As with images and audio, our framework would also let users browse for categorically tagged videos provided by our framework or shared by other users.

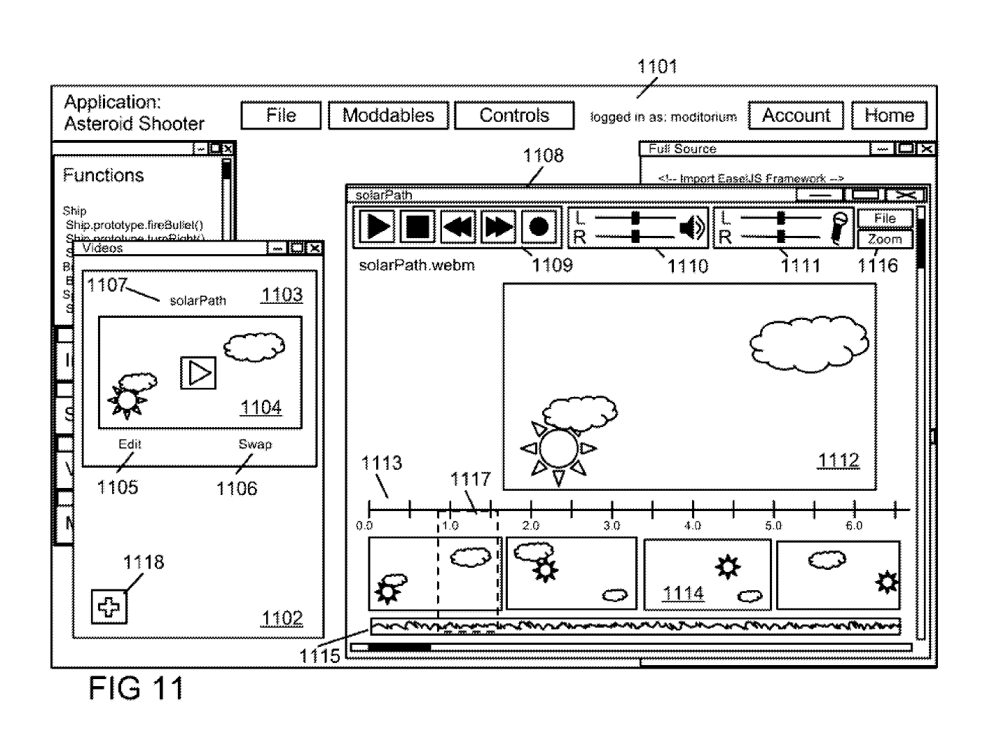

FIG. 11 shows a more detailed view of the development interface web page 209 in a state which is focused on modification of the video of an application 1101. Our framework will parse the client side text files 213 for references to video files, either with inline content using data URL 111, or as references to an external URL 112. These are easily parsed using regular expressions that look for the data URL format, HTML video tags, and video file names with extensions denoting that they are in one of the file formats supported by web standards. These video files will then be listed in the video moddables subwindow 1102 shown undocked in FIG. 11, and previously in FIG. 5 as one of the docked and collapsed moddables subwindows 510. Each video will be represented by an interface 1104 that will show a still from the video with the standard play button on top which will play the video in place when clicked. The interface will also contain supplemental information, and controls to swap it for another video 1106 and to edit the video 1105, if video editing is supported. The supplemental information may include items such as the video filename or the duration of the video. The still of the video 1104 could also be moused over in order to cycle through several stills throughout the video which would replace the single still, without playing the audio, as a sort of preview. This can be performed using the currentTime attribute of the MediaElementAPI http://www.w3.org/TR/html5/media-elements.html#htmlmediaelement.

When the swap control 1106 is clicked, an interface is opened in which the user can upload a video file from his file system, capture a new video file from a device, upload a video file from a URL, or select a video file from a gallery of video thumbnails such as the thumbnail 1104 in the video moddables window and with a similar overall interface to the image gallery as shown in FIG. 12. When any of these actions is performed, the client source model is altered so that references to the URL of the swapped video file are replaced by the URL of the new video file which is stored as one of the media files for applications 212 on the server side for developer applications 207. The gallery of video thumbnails is a grid of video thumbnails with an interface to navigate between various tag categories. The category navigation, tagging, folders, and recommendation will work as described for the image gallery that is exposed when the image swap link 605 is clicked.

If video editing is supported, clicking the edit link 1105 on a video moddable interface 1103 will open that video file in a video editor subwindow 1108. This editor subwindow will contain an interface with basic video editing functionality similar to YouTube's in-browser video editor http://www.youtube.com/editor/ or Apple's non-browser-based iMovie http://www.apple.com/ilife/imovie/. These pieces of software provide timeline based editing of videos where portions of the video can be removed, inserted in other places, or have various filters and effects applied to them. They also expose the ability to edit the audio portion of the video, or add new audio to the video.

The HTML5 standard does not provide APIs designed to edit video from within the browser. Because of this, the video editor interface 1108 will follow a general paradigm of using the HTMLMediaElement API to preview the results of any edits made on the client side, while using standard video libraries on the server side for developer applications 207 to make those edits to the video source file, thus producing a new, edited, video file.

The video editor subwindow will feature standard controls 1109 to play, stop, fast-forward, and rewind the video preview 1112, as well as to record new video or audio. There will also be controls to change the volume of the video's audio track 1110 and the volume at which sound is recorded 1111. There will also be buttons 1116 to zoom in on the audio/video tracks and to perform file operations such as saving the video file, or saving the video's audio track 1115 to a separate audio file.

As with the audio editor, there will be a timeline 1113, where clicking on the timeline can skip the video preview 1112 to that time index, and dragging along the timeline can create a selected area 1117 which can then be manipulated by the various editing actions. The timeline 1113 is supplemented by thumbnail stills 1114 showing the state of the video as it progresses along the timeline 1113. These can be created by using the canvas tag's drawImage method which can pull image data from a video element and draw it to the canvas element. Thus each thumbnail still 1114 would be a separate canvas element that would have the still generated by setting the currentTime of the video element to the proper part of the timeline for that thumbnail and then using drawImage to pull the image data of that time index into the canvas thumbnail 1114. The audio track beneath the video thumbnails would be generated as discussed in the audio editor interface 708.

On the client side, the HTMLMediaElement API allows for full manipulation of the time index of a video. There are functions corresponding to the standard controls 1108 for play and pause. There is also a playbackRate attribute that can be read or written to in order to alter the rate at which the video is played. There is a volume attribute that can be read and written to in order to control the video's volume 1110. There is also the aforementioned currentTime attribute that can be read or written to in order to use the timeline 1113 to jump to a specific time index of the video 1112. The currentTime attribute can also be used to preview edits based on the timeline. For example, let's imagine that a user cut the portion of the original video clip from 1.0 seconds to 2.0 seconds and inserted it at the 4.0 second mark by dragging it to that location. This edit would be stored in memory on the client side, and when the preview 1112 was played, the interface 1108 would listen for a timeUpdate event showing that the currentTime was past 1.0 seconds, and upon that event, set currentTime to 2.0 seconds to skip over the removed clip. Then it would listen again for a timeUpdate event with a currentTime of greater than 4.0 seconds, at which point it would set currentTime to 1.0 seconds, listen for a time update past 2.0 seconds, and set currentTime to 4.0 seconds in order to represent the moved clip.

When the edits to the video file are saved by the user, this client-side in-memory model of edits could then be sent to a web service on the server side for developer applications 207 that would convert the data into calls to the library ffmpeg. The -ss and -t command line options allow specific clips of a video file to be selected based on their time index. These can then be concatenated using the concat: interface as described here http://ffmpeg.org/faq.html#HOW-can-I-join-video-files_{—}003f. Thus the original video file can be processed, perhaps using several intermediary files, in accordance with the same timeline based edits that were shown in the client side preview, and saved to the server side 207. Then, as with image and audio files, the URL to the newly edited video file would be substituted for the original video file in the client side model and the new video file would be saved to the user's video gallery. If the source video file type cannot be processed by ffmpeg, it can be converted to a format which can, and then converted back one all the edits are complete. FFmpeg itself can be used for this and the aforementioned necessary video conversions, along with ffmpeg2theora and HandbrakeCLI as detailed here: http://diveintohtml5.info/video.html#webm-cli. The web service for processing video may make calls to dedicated video processing servers that are kept online for that purpose or spawned when needed, using Amazon EC2 on demand instances.

The various filters that can be applied by the ffmpeg library are detailed in this guide: http://ffmpeg.org/trac/ffmpeg/wiki/FilteringGuide. When a user selects 1117 a portion of the video timeline, he can bring up a context menu, using a right mouse click for example, which will offer a list of filters that could be applied to that portion of the video. As the filtering guide shows, these can then be applied to the time indexed video clips that we spoke of earlier. There are several options for previewing these filters on the client side. One is to use SVG filters, http://en.wikipedia.org/wiki/SVG_filter_effects, where those filters line up with the ones that could be applied server side. These can be applied to any DOM element, including the video element. Another would be to render the video, perhaps at a lower frame rate, to a canvas element using the drawImage function, then the server-side effects could be replicated with client-side code operating on those image stills, which would then be displaying instead of the video preview 1112 for the filtered portion of the video. In this case, performance concerns make it advisable to use drawImage to pull the video image data into an intermediary, hidden, canvas element that is then processed and drawn to another canvas element as detailed here: http://www.html5rocks.com/en/tutorials/video/basics/#toc-fun-canvas. Another option would be to leverage the use of a plug-in, such as Adobe's Flash, to process and filter the video on the client side.

The video's audio timeline 1115 could be edited by the user with the previously mentioned audio editor interface 708, which could be displayed in another window, or within the video editor interface 1108. For client-side audio editing, a MediaElementAudioSourceNode can be created from any HTMLMediaElement, such as a video element, and this node could be used as the other nodes discussed in association with the audio editor interface 708. There could also be controls exposed to the user allowing him to add new audio tracks to the video file. On the client side, they could be played along side the video file, or mixed into the video file's audio using a MediaElementAudioSourceNode. On the server side, ffmpeg has command line options to combine audio and video files.

Just as with images and audio files, the videos moddables window 1102 would contain an add video button 1118. This would work in the same way as the add image 611 and add audio 718 buttons, prompting the user to upload, capture, or select a video from a gallery, and inserting calls to a function like WI.addVideo(‘solarPath.webm’, ‘solarPath’) that then allow the video to be referenced by a user-supplied programmatic name like WI.videos.solarPath.

### Full Screen or Domain-Based Apps

Some applications may want to run at a larger size than that of the default iFrame embedded in an external site 401, the application's web page 302 on our framework, or as a preview 514 in the application editor interface. This can be accomplished by allowing for various sizes of the iFrame to exist and be defined by the application developer in metadata stored in the data store for developer applications. Then, when an application is embedded, the iFrame can be sized to fit the developer's expectations, and the surrounding page elements can be rearranged to fit that size. For example, if an application wanted to be wider than the iFrame 302 as shown on its web page on our framework 301, the related applications panel 303 and or the application description 308 could be moved down to accommodate that width.

Some applications may also want to run in fullscreen mode, that is, taking up the full user display without the browser and operating system chrome showing around them. The w3c has a fullscreen API specification (http://dvcs.w3.org/hg/fullscreen/raw-file/tip/Overview.html#api) that allows any element to be made fullscreen. This is currently not supported by the Internet Explorer and Opera browsers, but presumably will be in the future. In browsers which support the fullscreen API, our framework can expose a button to users that, then clicked, calls the appropriate requestFullScreen function for that browser on the iFrame containing the application. A notice is then shown to the user requesting fullscreen access. Our framework would then display a simple interface informing the user that the esc key exits fullscreen mode, or alternatively providing a button to also exit full screen mode, or both. Other interface elements may be overlaid on top of the fullscreen application and provide similar functionality to those that normally surround the application on its web page 301 on our framework such as viewing related applications, rating the application, or, if end-user modification of applications is supported, initiating modification of the application.

For the sake of professionalism or branding, some applications may want to be hosted on their domain, rather than on our framework's application web page 301 or embedded in some other page 407. Our framework could offer developers this option, which would likely cost them a fee, by hosting the content that would normally be placed in the embedded iFrame 401 as the default page for a unique subdomain of our framework's domain, such as myapp123.modit.net. The developer could then adjust the DNS records for any domain that they own, say somedevelopersdomain.com, to point that domain to his unique subdomain and then users navigating to somedevelopersdomain.com would see his application, hosted outside of an iFrame. When an application is hosted in this manner it may include certain interface elements that tie it back to our framework, such as the “mod it!” button 404 if end-user modification of applications is supported, or those elements may be left out as an option that might require an additional fee from the developer. If the application is made up of multiple application pages tied together by metadata in the data store 220, each of these application pages could be given default names under the domain such as somedevelopersdomain.com/page1.html or an interface can be provided to give specific page names at which each application page would be hosted under that domain.

### Other Matters

As discussed previously, non-web-standards browser add-ons 127 may be employed by our framework to overcome a lack of web-standards implementation by various browsers on various devices. It may also be advantageous to use browser add-ons to allow applications to communicate with hardware devices 128 in ways that no web standards specification currently covers. For example, there is an active community of developers using arduino, http://www.arduino.cc/, to prototype electronics or Microsoft's Kinect http://www.microsoft.com/en-us/kinectforwindows/ for voice and motion capture. Our framework may provide a browser add-on 127 for the various browsers 106 and computing environments 101 that would allow applications to communicate to arduino boards or Kinects attached to the computing environment 101 as hardware devices 128. It may also be advantageous to provide a browser add-on 127 that is itself programmable, just as with the client code or server-side code if server-side code for applications is supported. In this case, any user that has installed the programmable browser add-on could then run the application. The programmable add-on would import the application's add-on code, which would be stored alongside the other application code 213 214 on the server side 207, and run it, thus being able to reach parts of the computing environment 101 that the browser is not allowed to reach. This would obviously present certain security concerns which the user could be warned of, or which could be mitigated by a rigorous screening process similar to the one used by Apple for their app store.

Certain browser add-ons 127 that users may have installed alter the web pages that the user is viewing. For example, the Skype add-on alters phone numbers that it finds within web pages in order to make them links that will initiate a call to that number using Skype. As part of this process it often changes the fundamental structure of the page in a way that might bring the application preview 514 out of synch with the source model. In these cases the alteration can be detected by our framework as the preview subwindow's 514 source code will be different from that of the client source model even though the developer has not made any changes. In this case our framework can remove the changes that are made, or if the add-on is particularly persistent, warn the user that they should remove the add-on before continuing to use the interface.

Our framework may provide tools to facilitate developers importing existing applications into our framework. Provided the application is already web-standards-based and hosted on the web at some URL, an importer might need little else than to be pointed at that URL. The page served at that URL will contain all the contents of the application, or links to retrieve that content. Then our framework would need to request each item in turn and store copies in the appropriate places on the server side for developer applications 207, tying them together with a new record and metadata in the data stores 219 220. Any common libraries referenced by the application, such as jquery, could be pointed to canonical copies already maintained by our framework. This could be complicated by the application having a server side component, which would likely then need to be uploaded into our framework manually by the application creator. It could also be complicated by use of esoteric coding practices and non-web-standards technology. For example, if the developer did not use the convention of putting constant in all caps with underscores, like SPEED_OF_SOUND, then our framework would not be able to parse those as constants to be exposed in an editor subwindow 522.

For this reason, a more interactive importer tool may be desirable. This tool would be pointed to a URL, or given a series of files, perhaps compressed into a single archive, and would then walk the developer through the import process, asking them to make certain decisions along the way. These decisions may include choosing which version of the standard library, like j query, should be used. The importer tool would also look for certain attributes of the media and code, such as the lack of all-caps constants, for which it would suggest that the developer refactor the code to use all-caps constants, or the presence of media files, for which it would suggest using the WI.addImage API and its counterparts for audio and video files. The importer tool could also take URLs for source code repositories, such as git or svn as the input source.

A significant part of the code base of many larger applications, especially those developed by teams, are automated tests. These are pieces of code that are not part of the application itself when they are run, but rather exist to test that the application behaves as expected. One of the main benefits of tests is that a developer can change one part of the application and, so long as all of the existing tests pass, she can be confident that the change that was just made did not break the behavior of some other part of the application. Many smaller applications, for which the structure is not so complex or which are easily manually tested, exist without tests. Our framework could expose another type of moddable that would be “tests” and would appear in the list of moddables 510. There exist testing frameworks for JavaScript, such as jasmine, https://github.com/pivotal/jasmine, that could be integrated into our framework so that the tests could be not only written, but run within our framework in a way that the results could be shown to a developer after every change was made, or when a specific button is clicked. Jasmine is under the MIT license so it is able to be used freely in web applications so long as its use is mentioned. If server-side code is supported, common testing frameworks for the supported server-side languages would be available within the application containers and an interface would be provided in our framework development page 501 to edit those tests, run them in the application container, and see the results. To facilitate this, our framework would also provide the ability to make a test copy of the application's data store. If the server-side language used is able to be run natively in the browser, then the tests could be run on that server-side code locally, just as with the client-side tests. If end user modification of applications is supported, our framework might make it easy for a modifier of an application to ignore broken tests that her modifications would cause, as this may not concern them.

If end-user modification of applications is supported, there are several options of how to handle the modit family tree 801 when a developer modifies an application she owns. For the purposes of this discussion, consider a developer to own an application if she created it from scratch, or if her modification of some other application created the child application in question. If modification of an application that a developer owns creates a new child application, then various metadata such as the description, ratings, tags, and all recommendation engine input, would be reset as this would be considered to be a new application. However, if modification of an application that a developer owns does not create a new child application, then a single, popular application could be modified by its owner to be something totally different, perhaps even malicious, thus perverting the ratings, tags, and general recommendation system. In the latter case a policy could be established where changes like this could be flagged by users and the application would be taken down, perhaps accompanied by the developer being banned from our framework, depending on the severity of the violation.

In order to reduce network latency for users, and network bandwidth costs for our framework, it may be advantageous to cache certain media and text elements in web storage 131. Changes to an application that have yet to be published may not need to be pushed to the server prior to publication, and could instead be stored in web storage 131 and referred to by data URLs that reference the web storage 131. Upon publication, these items would be published to the server side 207 and the URLs would be altered to point to that new location where they will be viewable by other users. A developer may also be given the option to not publish the application, but still push all changes to the server side 207 in order to test things such as application load times.

It may be advantageous for our framework to provide pages for individual assets, such as images, sounds, videos, or pieces of code, similar to the pages for applications 301. These could be navigated to from many spots, such as the media galleries or the editing interface 501, and would allow users to share, edit, host those assets individually. For example, an artist might have no interest in making a game on our framework, but might still want to upload drawings and animations for others to use in games. If end-user modification of applications is supported, it would also be supported for the individual assets which could be opened in an editor interface 501 that was simplified automatically to reflect the fact that only one type of editor subwindow would be needed.

In order to facilitate learning of our framework's interface, an application may be provided on our framework which new users are pointed to as a tutorial. The application could, within itself, instruct the users to modify it in various ways in order to showcase the features of the editor interface 501 and provide a more interesting learning experience than could be provided by a video or walk-through. For example, a tutorial application might be a game in which the player's character cannot jump high enough to reach the goal of the first level. The user would then be prompted to alter the constant “PLAYER_JUMP_HEIGHT” in order to be able to beat the level. On the next level, the screen may be filled with enemies blocking the goal by moving in a pattern that is impregnable to the player character. The game would then prompt the user to modify the function Enemy.move( ) so that they stand still, or get out of the way.

There exist libraries for implementing physics within games and applications based on JavaScript. Box2DJS, http://box2d-js.sourceforge.net/, and box2dweb, http://code.google.com/p/box2dweb/, are based on the widely-used C++ library, Box2D http://en.wikipedia.org/wiki/Box2D. By launching our framework with a selection of existing games or game/application templates that use one of these JavaScript libraries or provide a playground that demonstrates their feature set, our framework can facilitate the use of these libraries by example. This is particularly the case if end-user modification of applications is supported.

Our framework will likely initially focus on two-dimensional applications and games, but the emerging WebGL standard, http://en.wikipedia.org/wiki/WebGL, as managed by the non-profit Khronos group allows for graphics-processor-accelerated three-dimensional graphics based purely on JavaScript with no browser add-ons. WebGL already has some support amongst the major browsers. Our framework will accommodate WebGL and three-dimensional games and applications, as well as three-dimensional models such as those defined by the Khronos group's COLLADA http://en.wikipedia.org/wiki/COLLADA which provides an intermediary format supported by many of the major three-dimensional modeling software packages such as Maya and SketchUp. Just as with the Box2D libraries, our framework can expose example templates or applications can facilitate users learning and using technologies like WebGL and standards like COLLADA.

It may be advantageous for our framework to supply users with a way to publish their applications as installable apps for mobile and desktop devices. PhoneGap is open source with a permissive license that would allow our framework to incorporate the wrappers they use to install web-standards-based applications as native apps and provide this functionality to our framework's users. This would likely be most valuable if it interfaced with the dominant application markets such as Apple's App Store, Google Play, Amazon's Android App Store, or the app store that is planned for Windows Metro.

Each of these vendors has a process for app submissions that our framework could facilitate by providing a user-friendly interface in which the developers could enter any required information or settings such that the application and data could be packaged and submitted by our framework. Our framework could then act as an intermediary, taking a portion of all app sales or other sources of revenue. Games and applications published to a third-party vendor in this way could have code inserted that promoted our framework and the end-user application modification if that is supported. For example, each app produced in this way might have a loading screen or top banner encouraging users to visit our framework or to modify the application they are using. Then clicking this would take them to our framework website in their browser, or, if they have our framework's native app installed, would feed that app a URL causing it to open the user application in question for editing.

Our framework itself could also be installed as a native app on various devices using PhoneGap. This is advantageous in that the icons for installed applications give that application continual visibility to the user of the device in question. One of the other benefits that PhoneGap provides is the ability to interface with mobile device hardware APIs that are not yet supported for applications running in the mobile device's web browser. If our framework is installed on a mobile device in this way, it can become its sort of desktop and app store, in that, once opened, it will present the user with many applications that can be downloaded and used, perhaps even natively. Our framework app could also be set to handle any URLs that point to our framework's web site, such that, if our framework app were installed on a user's device, and a user application's URL was clicked in an email, the user would be presented with the option of opening that application within our framework app instead of within the web browser. If a user navigates to a URL on our framework's website from a mobile device this is easily detected and it may be advantageous for our framework website to show that user a page encouraging them to download and install our framework app, touting whatever benefits it might provide in terms of hardware access or performance.

As has been mentioned previously, our framework may provide certain code libraries namespaced under WI, containing functions such as WI.MEDIA.addImage. As is standard practice, our framework can place all application client code into a single file which is a concatenation of any code 116 files referenced 112 by the application web page 121 and then minify that code by removing whitespace and/or obfuscating it using tools like MinifiyJS, http://www.minifyjs.com/. (Throughout this discussion, the initials WI appear with respect to code elements and in other contexts. WI refers to Withinternet, the developer of an implementation of what is described here. None of the discussion in this document however is meant to be limited to the implementation or products of Withinternet, but instead is meant to broadly cover every implementation of the concepts discussed here.)

Though this process reduces the amount of code that needs to be sent over the network, and thus bandwidth costs for our framework and load times for the users, if every library under the WI namespace is packaged with every application, this may be wasteful as that code may be large and yet most applications would only use a small portion of the libraries within it. Thus it may be advantageous to only package the libraries under the WI namespace that each application actually uses. These dependencies could be managed explicitly be application developers who would select which items under the WI namespace should be packaged with the application. However, this requires the developers, or modifiers of an application if end-user modification is supported, to explicitly include those libraries or else the use of those libraries in the application would cause a fatal error and the application would not run properly.

Our framework could support an automated dependency manager that would take care of this process for the developer. When the client source model is altered it is parsed in various ways as discussed. This parsing could include checks for any function beginning with “WI.” and include the necessary library. For example, as soon as the client source model contains a call to the function WI.GEOMETRY.euclideanDistance, this would be detected and the WI namespace would be searched for WI.GEOMETRY, which, when found, would be automatically included in the top of the client source model as script element with the src attribute set to the URL of the WI.GEOMETRY library.

Each library under the WI namespace would have metadata tying it to other libraries. Then when a reference to that library was added or removed as a dependency for some application, either explicitly or by calls in the code being added or removed, our framework would check all remaining libraries for dependencies and add or remove ones that were needed or no longer needed.

The granularity to which this principle is applied would be determined by how detailed our framework is with permissions. Libraries could be broken into sub-libraries like WI.GEOMETRY.2D or individual functions such as WI.GEOMETRY.euclideanDistance could be included or removed separately if our framework had dependency metadata at that level. Libararies available for use could be browsed in a tree structure and/or tagged in a similar manner to the one discussed for other assets like images.

As briefly mentioned, our framework could also allow users to select portions of code to define as libraries that would then be assets other users could use and modify and share. These could be given their own namespace like WI.USERLIB.someuser.libraryName. Users creating libraries would need to define any dependencies that our framework is unable to detect because they are not under a WI namespace.

The techniques described here can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described here can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described here can be implemented on a computer having a display device, e.g., a CRT (cathode ray tube) or LCD (liquid crystal display) monitor, for displaying information to the user and a keyboard and a pointing device, e.g., a mouse, trackball, touch pad, or single or multi-touch screen, by which the user can provide input to the computer (e.g., interact with a user interface element, for example, by clicking a button or making a gesture on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described here can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other implementations are also within the scope of the following claims.

1. A computer-implemented method that comprises providing a continuous framework with which users can interact, on one or more platforms that support web standards, and which supports: (a) the hosting of applications (b) the publication of hosted applications to a portal within the framework, and (c) the creation and direct editing of files, including text files, that embody those applications and conform to web standards.

2. The method of claim 1 in which the continuous framework supports (a), (b), and (c) without requiring the platforms on which the user can interact with the framework to be enhanced.

3. The method of claim 2 in which a user can edit an application owned by another user.

4. The method of claim 3 in which a user editing an application owned by another user comprises the creation of a clone of the application.

5. The method of claim 4 in which the user can embed one or more applications hosted by the framework within the framework.

6. The method of claim 5 in which the embedded application comprises application editor functions.

7. The method of claim 5 in which the framework comprises default component applications hosted by the framework and users can substitute other applications hosted by the framework for the default framework component applications.

8. The method of claim 5 in which the hosted application files comprise files that are run on a server inside an application container.

9. The method of claim 5 comprising indicating to a user who is observing the behavior of a running application which portions of code of the application are causing the observed behavior.

10. The method of claim 5 comprising controlling a sharing of revenue derived from one of the applications among two or more users who participated in editing files that embody the application.

11. The method of claim 5 in which, when a user edits parent content owned by another user to produce child content, revenue derived from the child content is shared with the owner of the parent content.

12. The method of claim 5 in which the continuous framework provides Web services comprising access to a key-value-based data store for each hosted application.

13. The method of claim 5 in which the continuous framework provides Web services comprising a state-chat server for each hosted application.

14. The method of claim 5 in which a revision control system is provided for each of the application files.

15. The method of claim 5 in which the hosted application files comprise image files.

16. The method of claim 5 in which the directly editable application files comprise image files that conform to web standards.

17. The method of claim 5 in which one or more applications hosted by the framework can be embedded in another application that conforms to web standards.

18. The method of claim 5 in which one or more applications hosted by the framework can be embedded in another application hosted by the framework.

19. The method of claim 3 in which the framework supports importing of an existing application into the framework.

20. The method of claim 19 in which the existing application is imported from a URL where the application is hosted on the web.

21. The method of claim 19 in which the existing application is imported from a source code repository URL.

22. The method of claim 19 in which the existing application is imported from files on a user's hard drive.

23. The method of claim 5 in which the framework supports direct editing of source code elements that are less than a whole file.

24. The method of claim 23 in which the elements comprise JavaScript functions.

25. The method of claim 23 in which the elements comprise JavaScript modules.

26. The method of claim 23 in which the elements comprise constants.

27. The method of claim 2 in which the user can embed one or more applications hosted by the framework within the framework.

28. The method of claim 27 in which the embedded application comprises application editor functions.

29. The method of claim 2 in which the framework comprises default component applications hosted by the framework and users can substitute other applications hosted by the framework for the default framework component applications.

30. The method of claim 2 comprising indicating to users who are observing behavior of a running application which portions of code of the application are causing the observed behavior.

31. The method of claim 2 in which a revision control system is provided for each of the application files.

32. The method of claim 2 in which the hosted application files comprise image files.

33. The method of claim 2 in which the directly editable application files comprise image files that conform to web standards.

34. The method of claim 3 comprising controlling a sharing of revenue derived from one of the applications among two or more users who participated in editing files that embody the application.

35. The method of claim 4 in which, when a user edits parent content owned by another user to produce child content, revenue derived from the child content is shared with the owner of the parent content.

36. The method of claim 1 in which a user can edit an application owned by another user.

37. The method of claim 36 in which the user can embed one or more applications hosted by the framework within the framework.

38. The method of claim 36 in which a user editing an application owned by another user comprises the creation of a clone of the application.

39. The method of claim 1 in which the text files comprise JavaScript.

40. A computer-implemented method that comprises
providing a continuous framework with which users can interact, on one or more platforms that conform to web standards, and which supports (a) the hosting of applications and (b) the creation and direct editing of files, including server-side files that embody the applications and are run inside an application container.

41. The method of claim 40 in which the files comprise client-side text files that conform to web standards.

42. The method of claim 40 in which a user can edit an application owned by another user.

43. The method of claim 42 in which a user editing an application owned by another user comprises the creation of a clone of the application.

44. The method of claim 41 in which a user can edit an application owned by another user.

45. The method of claim 44 in which a user editing an application owned by another user comprises the creation of a clone of the application.

46. A computer implemented method comprising
a continuous framework in which, when users create parent content and other users duplicate and edit that content to create derivative child content, revenue derived from the child content is shared with the creator of the parent content.

47. The method of claim 46 in which the revenue is derived from advertising.

48. The method of claim 46 in which the revenue is derived from charges to parent content creators for being able to limit the duplication and editing of their content.

49. The method of claim 46 in which sharing is based on measures of the value of the parent content and child content to the framework.

50. The method of claim 49 in which the measures comprise content views.

51. The method of claim 49 in which the measures comprise content use fees.

52. A computer implemented method comprising
hosting an online market for applications or application assets that conform to web standards, are usable within a continuous framework with which users can interact, on one or more platforms that support web standards, and permit the applications or application assets to be edited by parties other than owners of the applications or application assets.

53. A computer-implemented method comprising
as a running application exhibits behavior that a user can observe, simultaneously, in real time, displaying to the user portions of code of the application that are causing the observed behavior.

54. The method of claim 53 in which the application conforms to web standards.

55. A computer-implemented method comprising
enabling editing of source code including enabling editing of some elements of syntax of the source code, and enabling observation but not editing of some elements of the syntax of the source code, in which all of the elements of source code syntax conform to a specification for a language.

56. The method of claim 55 in which that language comprises JavaScript.

57. A computer-implemented method comprising enabling editing of source code including the insertion of functions whose programmatic scope is based on an existing function that is chosen by the user.

58. The method of claim 57 in which the inserted function has the same signature as the chosen function.

59. The method of claim 57 in which the insertion involves no more than one user action.

60. The method of claim 57 in which the source code comprises JavaScript.

61. The method of claim 58 in which the source code comprises JavaScript.

62. The method of claim 59 in which the source code comprises JavaScript.

63. A computer-implemented method that comprises
providing a continuous framework with which users can interact, on one or more platforms that support web standards, and which supports, without requiring the platforms to be enhanced: (a) the hosting of applications (b) the creation and direct editing of files, including text files, that embody those applications and conform to web standards, and (c) a user editing an application owned by another user where the editing causes creation of a clone of the application.

64. The method of claim 63 in which the user can embed one or more applications hosted by the framework within the framework.

65. The method of claim 64 in which the framework comprises default component applications hosted by the framework and users can substitute other applications hosted by the framework for the default framework component applications.
